(19) United States
(12) Patent Application Publication
(10) Pub. No.: US 2024/0322881 A1
(43) Pub. Date: Sep. 26, 2024

(54) CHANNEL STATE INFORMATION REPORTING WITH SINGLE AND JOINT TRANSMISSION RECEPTION POINT MEASUREMENTS

(71) Applicant: QUALCOMM Incorporated, San Diego, CA (US)

(72) Inventors: Mostafa KHOSHNEVISAN, San Diego, CA (US); Chenxi HAO, Beijing (CN); Xiaoxia ZHANG, San Diego, CA (US)

(21) Appl. No.: 18/574,260

(22) PCT Filed: Aug. 5, 2021
(86) PCT No.: PCT/CN2021/110838

§ 371 Date: Dec. 26, 2023

(51) Int. Cl. H04B 7/06; H04L 1/00

(52) U.S. Cl. CPC H04B 7/0626; H04L 1/0026

(57) ABSTRACT

Methods, systems, and devices for wireless communications are described. A user equipment (UE) may receive control signaling indicating a first subset of channel measurement resources (CMRs) from a first CMR group for single transmission reception point (TRP) channel measurements associated with a first TRP, a second subset of CMRs from a second CMR group for single TRP channel measurements associated with a second TRP, and one or more CMR pairs including CMRs from the first subset and second subset. The UE may monitor the first subset, the second subset, and the one or more CMR pairs to generate a set of measurements for channel state information (CSI). The UE may then transmit a CSI report based on the set of measurements and including a number of bits to indicate one or more channel resource indicators (CRIs), where the number of bits is based on a number of the CMR pairs.

### CROSS REFERENCE

The present Application is a 371 national stage filing of International PCT Application No. PCT/CN2021/110838 by KHOSHNEVISAN et al. entitled “CHANNEL STATE INFORMATION REPORTING WITH SINGLE AND JOINT TRANSMISSION RECEPTION POINT MEASUREMENTS,” filed Aug. 5, 2021, which is assigned to the assignee hereof, and which is expressly incorporated by reference in its entirety herein.

### FIELD OF TECHNOLOGY

The following relates to wireless communications, including channel state information (CSI) reporting with single and joint transmission reception point (TRP) measurements.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support channel state information (CSI) reporting with single and joint transmission reception point (TRP) measurements. Generally, the described techniques provide for a user equipment (UE) to transmit CSI reports associated with both single and joint TRP measurements. For example, the UE may receive control signaling indicating a first subset of channel measurement resources (CMRs) from a set of CMRs for single TRP measurements associated with a first TRP, a second subset of CMRs from a second set of CMRs for single TRP measurements associated with a second TRP, and one or more CMR pairs for joint TRP measurements. Here, each CMR pair may include one CMR from the first subset (e.g., associated with the first TRP) and one CMR from the second subset (e.g., associated with the second TRP). The UE may then monitor the indicated CMRs (e.g., the first subset, the second subset, and the one or more CMR pairs) to generate a set of measurements for CSI. The UE may transmit a CSI report indicating one or more channel resource indicators associated with at least one of the set of measurements. In some cases, the UE may indicate the one or more channel resource indicators within a number of bits that are based on the number of CMR pairs indicated by the control signaling. That is, a codespace associated with the number of bits (e.g., a number of possible CMRs indicated by each channel resource indicator) may be based on the number of CMR pairs, and thus the number of bits indicating the channel resource indicators may also be based on the number of CMR pairs.

In another example, the described techniques provide for the UE to transmit CSI reports associated with both single and joint TRP measurements where the UE shares a precoding matrix indicator (PMI), a rank indicator (RI), between CSI measurements associated with both single and joint TRP measurements. For example, the UE may receive control signaling indicating a pair of CMRs and that a first and second PMI a first and second RI calculated for channel measurements associated with the CMR pair may be shared for generating channel measurements (e.g., channel quality indicators (CQIs)) for each CMR within the pair of CMRs individually. The UE may monitor the pair of CMRs to generate the joint TRP CSI (e.g., including the first and second PMIs and the first and second RIs). The UE may additionally generate a first single TRP CSI associated with a first TRP that includes the first PMI and the first RI and a second single TRP CSI associated with a second TRP that includes the second PMI and the second RI. The UE may then transmit a CSI report including CQIs associated with both joint and single TRPs that are generated using shared PMIs, shared RIs, or both.

A method for wireless communication at a UE is described. The method may include receiving control signaling indicating a first subset of CMRs in a first CMR group for single TRP channel measurement associated with a first TRP, a second subset of CMRs in a second CMR group for single TRP channel measurement associated with a second TRP, and one or more CMR pairs including CMRs from each of the first CMR group and the second CMR group for joint TRP channel measurement, monitoring the first subset of CMRs, the second subset of CMRs, and the one or more CMR pairs to generate a set of multiple measurements, and transmitting a CSI report including a number of bits indicating one or more CRIs associated with at least one of the set of multiple measurements, where the number of bits is based on a number of the CMR pairs.

An apparatus for wireless communication at a UE is described. The apparatus may include a processor, memory coupled with the processor, and instructions stored in the memory. The instructions may be executable by the processor to cause the apparatus to receive control signaling indicating a first subset of CMRs in a first CMR group for single TRP channel measurement associated with a first TRP, a second subset of CMRs in a second CMR group for single TRP channel measurement associated with a second TRP, and one or more CMR pairs including CMRs from each of the first CMR group and the second CMR group for joint TRP channel measurement, monitor the first subset of CMRs, the second subset of CMRs, and the one or more CMR pairs to generate a set of multiple measurements, and transmit a CSI report including a number of bits indicating one or more CRIs associated with at least one of the set of multiple measurements, where the number of bits is based on a number of the CMR pairs.

Another apparatus for wireless communication at a UE is described. The apparatus may include means for receiving control signaling indicating a first subset of CMRs in a first CMR group for single TRP channel measurement associated with a first TRP, a second subset of CMRs in a second CMR group for single TRP channel measurement associated with a second TRP, and one or more CMR pairs including CMRs from each of the first CMR group and the second CMR group for joint TRP channel measurement, means for monitoring the first subset of CMRs, the second subset of CMRs, and the one or more CMR pairs to generate a set of multiple measurements, and means for transmitting a CSI report including a number of bits indicating one or more CRIs associated with at least one of the set of multiple measurements, where the number of bits is based on a number of the CMR pairs.

A non-transitory computer-readable medium storing code for wireless communication at a UE is described. The code may include instructions executable by a processor to receive control signaling indicating a first subset of CMRs in a first CMR group for single TRP channel measurement associated with a first TRP, a second subset of CMRs in a second CMR group for single TRP channel measurement associated with a second TRP, and one or more CMR pairs including CMRs from each of the first CMR group and the second CMR group for joint TRP channel measurement, monitor the first subset of CMRs, the second subset of CMRs, and the one or more CMR pairs to generate a set of multiple measurements, and transmit a CSI report including a number of bits indicating one or more CRIs associated with at least one of the set of multiple measurements, where the number of bits is based on a number of the CMR pairs.

In some examples of the method, apparatuses, and non-transitory computer-readable medium described herein, transmitting the CSI report may include operations, features, means, or instructions for transmitting the CSI report including the number of bits indicating a single CRI, where the number of bits based on the number of the CMR pairs.

In some examples of the method, apparatuses, and non-transitory computer-readable medium described herein, transmitting the CSI report may include operations, features, means, or instructions for transmitting the CSI report including the number of bits indicating a set of multiple CRIs, the number of bits corresponding to a first number of bits in a first CRI of the set of multiple CRIs that may be based on the number of the CMR pairs and a second number of bits in a second CRI of the set of multiple CRIs that may be based on a sum of a first number of CMRs in the first subset and a second number of CMRs in the second subset.

In some examples of the method, apparatuses, and non-transitory computer-readable medium described herein, transmitting the CSI report may include operations, features, means, or instructions for transmitting the CSI report including the number of bits indicating a set of multiple CRIs, the number of bits corresponding to a first number of bits in a first CRI of the set of multiple CRIs that may be based on the number of the CMR pairs, a second number of bits in a second CRI of the set of multiple CRIs that may be based on a first number of CMRs in the first subset, and a third number of bits in a third CRI of the set of multiple CRIs that may be based on a second number of CMRs in the second subset.

In some examples of the method, apparatuses, and non-transitory computer-readable medium described herein, transmitting the CSI report may include operations, features, means, or instructions for transmitting the CSI report including the number of bits indicating a single CRI, the number of bits based on a sum of a first number of CMRs in the first subset, a second number of CMRs in the second subset, and the number of the CMR pairs.

In some examples of the method, apparatuses, and non-transitory computer-readable medium described herein, the first subset includes a first number of unshared CMRs in the first CMR group and the second subset includes a second number of unshared CMRs in the second CMR group, where the unshared CMRs may be CMRs distinct from CMRs within the one or more CMR pairs and transmitting the CSI report further includes transmitting the CSI report including the number of bits indicating a set of multiple CRIs based on the control signaling indicating that CMR sharing may be disabled between single TRP channel measurement and joint TRP channel measurement, where the number of bits corresponds to a first number of bits in a first CRI of the set of multiple CRIs that may be based on the number of the CMR pairs, and a second number of bits in a second CRI of the set of multiple CRIs that may be based on the first number of unshared CMRs in the first subset and the second number of unshared CMRs in the second subset.

In some examples of the method, apparatuses, and non-transitory computer-readable medium described herein, the first subset includes a first number of unshared CMRs in the first CMR group and the second subset includes a second number of unshared CMRs in the second CMR group, where the unshared CMRs may be CMRs distinct from CMRs within the one or more CMR pairs and transmitting the CSI report further includes transmitting the CSI report including the number of bits indicating a set of multiple CRIs based on the control signaling indicating that CMR sharing may be disabled between single TRP channel measurement and joint TRP channel measurement, where the number of bits corresponds to a first number of bits in a first CRI of the set of multiple CRIs that may be based on the number of the CMR pairs, a second number of bits in a second CRI of the set of multiple CRIs that may be based on the first number of unshared CMRs in the first subset, and a third number of bits in a third CRI of the set of multiple CRIs that may be based on the second number of unshared CMRs in the second subset.

In some examples of the method, apparatuses, and non-transitory computer-readable medium described herein, the first subset includes a first number of unshared CMRs in the first CMR group and the second subset includes a second number of unshared CMRs in the second CMR group, where the unshared CMRs may be CMRs distinct from CMRs within the one or more CMR pairs and transmitting the CSI report further includes transmitting the CSI report including the number of bits indicating a single CRI based on the control signaling indicating that CMR sharing may be disabled between single TRP channel measurement and joint TRP channel measurement, where the number of bits may be based on a sum of the first number of unshared CMRs in the first subset, the second number of unshared CMRs in the second subset, and the number of the CMR pairs.

In some examples of the method, apparatuses, and non-transitory computer-readable medium described herein, transmitting the CSI report may include operations, features, means, or instructions for transmitting the CSI report including the number of bits indicating a set of multiple CRIs, where the number of bits corresponds to a first number of bits in a first CRI of the set of multiple CRIs that may be based on the number of the CMR pairs and a second number of bits in a second CRI of the set of multiple CRIs that may be based on a sum of a first number of CMRs in the first subset for single TRP channel measurement and a second number of CMRs in the second subset for single TRP channel measurement, where the first number of CMRs may be based on a difference between a third number of CMRs in the first CMR group and the number of the CMR pairs, and where the second number of CMRs may be based on a difference between a fourth number of CMRs in the second CMR group and the number of the CMR pairs.

In some examples of the method, apparatuses, and non-transitory computer-readable medium described herein, transmitting the CSI report may include operations, features, means, or instructions for transmitting the CSI report including the number of bits indicating a set of multiple CRIs, where the number of bits corresponds to a first number of bits in a first CRI of the set of multiple CRIs that may be based on the number of the CMR pairs, a second number of bits in a second CRI of the set of multiple CRIs that may be based on a first number of CMRs in the first subset for single TRP channel measurement, and a third number of bits in a third CRI of the set of multiple CRIs that may be based on a second number of CMRs in the second subset for single TRP channel measurement, where the first number of CMRs may be based on a difference between a third number of CMRs in the first CMR group and the number of the CMR pairs, and where the second number of CMRs may be based on a difference between a fourth number of CMRs in the second CMR group and the number of the CMR pairs.

In some examples of the method, apparatuses, and non-transitory computer-readable medium described herein, transmitting the CSI report may include operations, features, means, or instructions for transmitting the CSI report including the number of bits indicating a single CRI, where the number of bits may be based on a sum of a first number of CMRs in the first subset for single TRP channel measurement, a second number of CMRs in the second subset for single TRP channel measurement, and the number of the CMR pairs, where the first number of CMRs may be based on a difference between a third number of CMRs in the first CMR group and the number of the CMR pairs, and where the second number of CMRs may be based on a difference between a fourth number of CMRs in the second CMR group and the number of the CMR pairs.

In some examples of the method, apparatuses, and non-transitory computer-readable medium described herein, the number of bits may be based on a number of the one or more CRIs, a first number of CMRs in the first subset, a second number of CMRs in the second subset, and the number of the CMR pairs.

In some examples of the method, apparatuses, and non-transitory computer-readable medium described herein, a number of CRIs within the CSI report associated with one of the first TRP or the second TRP may be zero, one, or two.

A method for wireless communication at a UE is described. The method may include receiving control signaling indicating a pair of CMRs and that a first PMI, a second PMI, a first RI, and a second RI of joint TRP CSI calculated for the pair of CMRs is to be shared for generating a respective CQI for each CMR of the pair of CMRs, monitoring the pair of CMRs to generate the joint TRP CSI including the first PMI, the second PMI, the first RI, the second RI, and a first CQI, and transmitting a CSI report including the joint TRP CSI, a second CQI of a first CMR of the pair of CMRs calculated using the first PMI and the first RI, and a third CQI of a second CMR of the pair of CMRs calculated using the second PMI and the second RI.

An apparatus for wireless communication at a UE is described. The apparatus may include a processor, memory coupled with the processor, and instructions stored in the memory. The instructions may be executable by the processor to cause the apparatus to receive control signaling indicating a pair of CMRs and that a first PMI, a second PMI, a first RI, and a second RI of joint TRP CSI calculated for the pair of CMRs is to be shared for generating a respective CQI for each CMR of the pair of CMRs, monitor the pair of CMRs to generate the joint TRP CSI including the first PMI, the second PMI, the first RI, the second RI, and a first CQI, and transmit a CSI report including the joint TRP CSI, a second CQI of a first CMR of the pair of CMRs calculated using the first PMI and the first RI, and a third CQI of a second CMR of the pair of CMRs calculated using the second PMI and the second RI.

Another apparatus for wireless communication at a UE is described. The apparatus may include means for receiving control signaling indicating a pair of CMRs and that a first PMI, a second PMI, a first RI, and a second RI of joint TRP CSI calculated for the pair of CMRs is to be shared for generating a respective CQI for each CMR of the pair of CMRs, means for monitoring the pair of CMRs to generate the joint TRP CSI including the first PMI, the second PMI, the first RI, the second RI, and a first CQI, and means for transmitting a CSI report including the joint TRP CSI, a second CQI of a first CMR of the pair of CMRs calculated using the first PMI and the first RI, and a third CQI of a second CMR of the pair of CMRs calculated using the second PMI and the second RI.

A non-transitory computer-readable medium storing code for wireless communication at a UE is described. The code may include instructions executable by a processor to receive control signaling indicating a pair of CMRs and that a first PMI, a second PMI, a first RI, and a second RI of joint TRP CSI calculated for the pair of CMRs is to be shared for generating a respective CQI for each CMR of the pair of CMRs, monitor the pair of CMRs to generate the joint TRP CSI including the first PMI, the second PMI, the first RI, the second RI, and a first CQI, and transmit a CSI report including the joint TRP CSI, a second CQI of a first CMR of the pair of CMRs calculated using the first PMI and the first RI, and a third CQI of a second CMR of the pair of CMRs calculated using the second PMI and the second RI.

Some examples of the method, apparatuses, and non-transitory computer-readable medium described herein may further include operations, features, means, or instructions for receiving second control signaling indicating a configuration for calculating the second CQI and the third CQI, where transmitting the CSI report may be based on receiving the second control signaling.

Some examples of the method, apparatuses, and non-transitory computer-readable medium described herein may further include operations, features, means, or instructions for measuring the first CMR independently of the second CMR to generate the second CQI in accordance with the configuration and measuring the second CMR independently of the first CMR to generate the third CQI in accordance with the configuration.

Some examples of the method, apparatuses, and non-transitory computer-readable medium described herein may further include operations, features, means, or instructions for measuring the first CMR and a first interference signal received via the second CMR to generate the second CQI in accordance with the configuration and measuring the second CMR and a second interference signal received via the first CMR to generate the third CQI in accordance with the configuration.

Some examples of the method, apparatuses, and non-transitory computer-readable medium described herein may further include operations, features, means, or instructions for applying the second PMI and the second RI to a first signal received via the second CMR to measure an interference level caused by the first interference signal and applying the first PMI and the first RI to a second signal received via the first CMR to measure an interference level caused by the second interference signal.

Some examples of the method, apparatuses, and non-transitory computer-readable medium described herein may further include operations, features, means, or instructions for transmitting signaling indicating a defined number of CSI processing units (CPUs) supported by the UE, a defined number of active CSI-RS resources supported by the UE, and a defined number of active CSI-RS ports supported by the UE, where transmitting the CSI report uses a number of CPUs associated with the CSI report that may be less than or equal to the defined number of CPUs supported by the UE, uses a number of active CSI-RS resources associated with the CSI report that may be less than or equal to the defined number of active CSI-RS resources supported by the UE, and uses a number of active CSI-RS ports associated with the CSI report that may be than or equal to the defined number of active CSI-RS ports supported by the UE.

In some examples of the method, apparatuses, and non-transitory computer-readable medium described herein, the control signaling indicates a number of pairs of CMRs including at least the pair of CMRs, the number of CPUs associated with the CSI report may be based on the number of pairs of CMRs and a number of individual CMRs within the number of pairs of CMRs, the number of active CSI-RS resources associated with the CSI report may be based on the number of pairs of CMRs and the number of individual CMRs within the number of pairs of CMRs, and the number of active CSI-RS ports associated with the CSI report may be based on the number of pairs of CMRs, the number of individual CMRs within the number of pairs of CMRs, and a number of ports associated with each CMR.

In some examples of the method, apparatuses, and non-transitory computer-readable medium described herein, the control signaling indicates a number of pairs of CMRs including at least the pair of CMRs, the number of CPUs associated with the CSI report may be based on the number of pairs of CMRs and the pair of CMRs measured to generate the joint TRP CSI, the number of active CSI-RS resources associated with the CSI report may be based on the number of pairs of CMRs and the pair of CMRs measured to generate the joint TRP CSI, and the number of active CSI-RS ports associated with the CSI report may be based on the number of pairs of CMRs, the pair of CMRs measured to generate the joint TRP CSI, and a number of ports associated with each CMR.

In some examples of the method, apparatuses, and non-transitory computer-readable medium described herein, the control signaling indicates a number of pairs of CMRs including at least the pair of CMRs, the number of CPUs associated with the CSI report may be based on the number of pairs of CMRs and a first constant indicated in the signaling, the number of active CSI-RS resources associated with the CSI report may be based on the number of pairs of CMRs and a second constant indicated in the signaling, and the number of active CSI-RS ports associated with the CSI report may be based on the number of pairs of CMRs, the second constant indicated in the signaling, and a number of ports associated with each CMR.

Some examples of the method, apparatuses, and non-transitory computer-readable medium described herein may further include operations, features, means, or instructions for transmitting the signaling further includes transmitting signaling indicating a defined number of additional CQI calculations supported by the UE, a number of additional CQI calculations associated with the CSI report may be less than or equal to the defined number of additional CQI calculations supported by the UE, the control signaling indicates a number of pairs of CMRs including at least the pair of CMRs, the number of CPUs associated with the CSI report may be based on the number of pairs of CMRs, the number of active CSI-RS resources associated with the CSI report may be based on the number of pairs of CMRs, the number of active CSI-RS ports associated with the CSI report may be based on the number of pairs of CMRs and a number of ports associated with each CMR, and the number of additional CQI calculations associated with the CSI report may be based on the pair of CMRs measured to generate the joint TRP CSI.

Some examples of the method, apparatuses, and non-transitory computer-readable medium described herein may further include operations, features, means, or instructions for receiving second control signaling indicating for the CSI report to include the joint TRP CSI associated with the pair of CMRs, first single TRP CSI associated with the first CMR, and second single TRP CSI associated with the second CMR, where transmitting the CSI report further includes, transmitting, within a first portion of the CSI report associated with the joint TRP CSI, the first RI, the second RI, the first PMI, the second PMI, and the first CQI, transmitting, within a second portion of the CSI report associated with the first single TRP CSI, the second CQI and the first RI, and transmitting, within a third portion of the CSI report associated with the second single TRP CSI, the third CQI and the second RI.

Some examples of the method, apparatuses, and non-transitory computer-readable medium described herein may further include operations, features, means, or instructions for receiving second control signaling indicating for a second CSI report to include second joint TRP CSI associated with the pair of CMRs, first single TRP CSI associated with a first CMR distinct from the pair of CMRs, and second single TRP CSI associated with a second CMR distinct from the pair of CMRs, monitoring the pair of CMRs to generate the second joint TRP CSI including a third PMI, a fourth PMI, a third RI, and a fourth RI, monitoring the first CMR to generate the first single TRP CSI including a fifth PMI and a fifth RI, monitoring the second CMR to generate the second single TRP CSI including a sixth PMI and a sixth RI, and transmitting the second CSI report including the second joint TRP CSI, the first single TRP CSI, and the second single TRP CSI.

In some examples of the method, apparatuses, and non-transitory computer-readable medium described herein, the second CQI and the third CQI are included in a first part of the CSI report. Additionally, the second CQI and the third CQI may be jointly encoded with the first PMI, the second PMI, the first RI, the second RI, the first CQI, and a CRI associated with the pair of CMRs.

A method for wireless communications at a base station is described. The method may include transmitting, to a UE, control signaling indicating a first subset of CMRs in a first CMR group for single TRP channel measurement associated with a first TRP, a second subset of CMRs in a second CMR group for single TRP channel measurement associated with a second TRP, and one or more CMR pairs including CMRs from each of the first CMR group and the second CMR group for joint TRP channel measurement and receiving, from the UE, a CSI report including a number of bits indicating one or more CRIs, where the number of bits is based on a number of the CMR pairs.

An apparatus for wireless communications at a base station is described. The apparatus may include a processor, memory coupled with the processor, and instructions stored in the memory. The instructions may be executable by the processor to cause the apparatus to transmit, to a UE, control signaling indicating a first subset of CMRs in a first CMR group for single TRP channel measurement associated with a first TRP, a second subset of CMRs in a second CMR group for single TRP channel measurement associated with a second TRP, and one or more CMR pairs including CMRs from each of the first CMR group and the second CMR group for joint TRP channel measurement and receive, from the UE, a CSI report including a number of bits indicating one or more CRIs, where the number of bits is based on a number of the CMR pairs.

Another apparatus for wireless communications at a base station is described. The apparatus may include means for transmitting, to a UE, control signaling indicating a first subset of CMRs in a first CMR group for single TRP channel measurement associated with a first TRP, a second subset of CMRs in a second CMR group for single TRP channel measurement associated with a second TRP, and one or more CMR pairs including CMRs from each of the first CMR group and the second CMR group for joint TRP channel measurement and means for receiving, from the UE, a CSI report including a number of bits indicating one or more CRIs, where the number of bits is based on a number of the CMR pairs.

A non-transitory computer-readable medium storing code for wireless communications at a base station is described. The code may include instructions executable by a processor to transmit, to a UE, control signaling indicating a first subset of CMRs in a first CMR group for single TRP channel measurement associated with a first TRP, a second subset of CMRs in a second CMR group for single TRP channel measurement associated with a second TRP, and one or more CMR pairs including CMRs from each of the first CMR group and the second CMR group for joint TRP channel measurement and receive, from the UE, a CSI report including a number of bits indicating one or more CRIs, where the number of bits is based on a number of the CMR pairs.

A method for wireless communications at a base station is described. The method may include transmitting, to a UE, control signaling indicating a pair of CMRs and that a first PMI, a second PMI, a first RI, and a second RI of joint TRP CSI calculated for the pair of CMRs is to be shared for generating a respective CQI for each CMR of the pair of CMRs and receiving, from the UE, a CSI report including the joint TRP CSI, a second CQI of a first CMR of the pair of CMRs calculated using the first PMI and the first RI, and a third CQI of a second CMR of the pair of CMRs calculated using the second PMI and the second RI.

An apparatus for wireless communications at a base station is described. The apparatus may include a processor, memory coupled with the processor, and instructions stored in the memory. The instructions may be executable by the processor to cause the apparatus to transmit, to a UE, control signaling indicating a pair of CMRs and that a first PMI, a second PMI, a first RI, and a second RI of joint TRP CSI calculated for the pair of CMRs is to be shared for generating a respective CQI for each CMR of the pair of CMRs and receive, from the UE, a CSI report including the joint TRP CSI, a second CQI of a first CMR of the pair of CMRs calculated using the first PMI and the first RI, and a third CQI of a second CMR of the pair of CMRs calculated using the second PMI and the second RI.

Another apparatus for wireless communications at a base station is described. The apparatus may include means for transmitting, to a UE, control signaling indicating a pair of CMRs and that a first PMI, a second PMI, a first RI, and a second RI of joint TRP CSI calculated for the pair of CMRs is to be shared for generating a respective CQI for each CMR of the pair of CMRs and means for receiving, from the UE, a CSI report including the joint TRP CSI, a second CQI of a first CMR of the pair of CMRs calculated using the first PMI and the first RI, and a third CQI of a second CMR of the pair of CMRs calculated using the second PMI and the second RI.

A non-transitory computer-readable medium storing code for wireless communications at a base station is described. The code may include instructions executable by a processor to transmit, to a UE, control signaling indicating a pair of CMRs and that a first PMI, a second PMI, a first RI, and a second RI of joint TRP CSI calculated for the pair of CMRs is to be shared for generating a respective CQI for each CMR of the pair of CMRs and receive, from the UE, a CSI report including the joint TRP CSI, a second CQI of a first CMR of the pair of CMRs calculated using the first PMI and the first RI, and a third CQI of a second CMR of the pair of CMRs calculated using the second PMI and the second RI.

### BRIEF DESCRIPTION OF THE DRAWINGS

FIG. 1 illustrates an example of a wireless communications system that supports channel state information (CSI) reporting with single and joint transmission reception point (TRP) measurements in accordance with aspects of the present disclosure.

FIG. 2 illustrates an example of a wireless communications system that supports CSI reporting with single and joint TRP measurements in accordance with aspects of the present disclosure.

FIG. 3A illustrates an example of a channel measurement resource (CMR) configuration that supports CSI reporting with single and joint TRP measurements in accordance with aspects of the present disclosure.

FIG. 3B illustrates an example of a CSI report that supports CSI reporting with single and joint TRP measurements in accordance with aspects of the present disclosure.

FIG. 4 illustrates an example of a CMR configuration that supports CSI reporting with single and joint TRP measurements in accordance with aspects of the present disclosure.

FIG. 5 illustrates an example of a process flow that supports CSI reporting with single and joint TRP measurements in accordance with aspects of the present disclosure.

FIG. 6 illustrates an example of a wireless communications system that supports CSI reporting with single and joint TRP measurements in accordance with aspects of the present disclosure.

FIG. 7A illustrates an example of a CMR configuration that supports CSI reporting with single and joint TRP measurements in accordance with aspects of the present disclosure.

FIGS. 7B and 7C illustrate example CSI reports that support CSI reporting with single and joint TRP measurements in accordance with aspects of the present disclosure.

FIG. 8 illustrates an example of a process flow that supports CSI reporting with single and joint TRP measurements in accordance with aspects of the present disclosure.

FIG. 9 illustrates an example of a CSI scheme that supports CSI reporting with single and joint TRP measurements in accordance with aspects of the present disclosure.

FIGS. 10 and 11 show block diagrams of devices that support CSI reporting with single and joint TRP measurements in accordance with aspects of the present disclosure.

FIG. 12 shows a block diagram of a communications manager that supports CSI reporting with single and joint TRP measurements in accordance with aspects of the present disclosure.

FIG. 13 shows a diagram of a system including a device that supports CSI reporting with single and joint TRP measurements in accordance with aspects of the present disclosure.

FIGS. 14 and 15 show block diagrams of devices that support CSI reporting with single and joint TRP measurements in accordance with aspects of the present disclosure.

FIGS. 16 through 19 show flowcharts illustrating methods that support CSI reporting with single and joint TRP measurements in accordance with aspects of the present disclosure.

### DETAILED DESCRIPTION

In some wireless communications systems, a base station may transmit one or more channel state information-reference signals (CSI-RSs) to a user equipment (UE). The UE may measure one or more channel measurement resources (CMRs) (e.g., associated with the CSI-RSs) to generate a CSI report for transmission to the base station. For example, the UE may indicate, to the base station within the CSI report, one or more resources associated with a better measured quality (e.g., when compared to other resources associated with the CMRs) for future communications between the base station and UE. In some cases, the base station may be associated with more than one transmission reception point (TRP). That is, the base station may transmit signals using one or more than one of the associated TRPs. In one example, the base station may transmit one or more CSI-RSs using more than one TRP (e.g., two TRPs) and one or more CSI-RSs using a single TRP. Here, the UE may transmit CSI reports associated with both single and joint TRP measurements.

For example, the UE may receive control signaling (e.g., from the base station) indicating a first subset of CMRs from a set of CMRs for single TRP measurements associated with a first TRP, a second subset of CMRs from a second set of CMRs for single TRP measurements associated with a second TRP, and one or more CMR pairs for joint TRP measurements. Here, each CMR pair may include one CMR from the first subset (e.g., associated with the first TRP) and one CMR from the second subset (e.g., associated with the second TRP). The UE may then monitor the indicated CMRs (e.g., the first subset, the second subset, and the one or more CMR pairs) to generate a set of measurements for CSI. The UE may transmit a CSI report indicating one or more channel resource indicators associated with at least one of the set of measurements. In some cases, the UE may indicate the one or more channel resource indicators within a number of bits that are based on the number of CMR pairs indicated by the control signaling. That is, a codespace associated with the number of bits (e.g., a number of possible CMRs indicated by each channel resource indicator) may be based on the number of CMR pairs, and thus the number of bits indicating the channel resource indicators may also be based on the number of CMR pairs.

In another example, the described techniques provide for the UE to transmit CSI reports associated with both single and joint TRP measurements where the UE shares a precoding matrix indicator (PMI), a rank indicator (RI), between CSI measurements associated with both single and joint TRP measurements. For example, the UE may receive control signaling indicating a pair of CMRs and that a first and second PMI a first and second RI calculated for channel measurements associated with the CMR pair may be shared for generating channel measurements (e.g., channel quality indicators (CQIs)) for each CMR within the pair of CMRs individually. The UE may monitor the pair of CMRs to generate the joint TRP CSI (e.g., including the first and second PMIs and the first and second RIs). The UE may additionally generate a first single TRP CSI associated with a first TRP that includes the first PMI and the first RI and a second single TRP CSI associated with a second TRP that includes the second PMI and the second RI. The UE may then transmit a CSI report including CQIs associated with both joint and single TRPs that are generated using shared PMIs, shared RIs, or both.

Aspects of the disclosure are initially described in the context of wireless communications systems. Aspects of the disclosure are then described in the context of CMR configurations, CSI reports, process flows, and a CSI scheme. Aspects of the disclosure are further illustrated by and described with reference to apparatus diagrams, system diagrams, and flowcharts that relate to CSI reporting with single and joint TRP measurements.

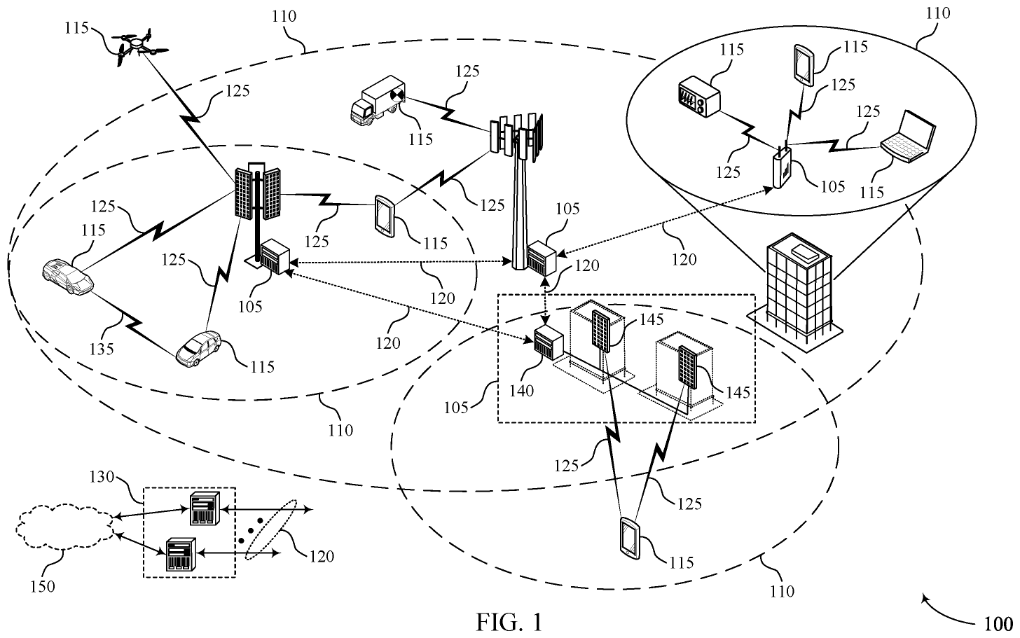

FIG. 1 illustrates an example of a wireless communications system 100 that supports CSI reporting with single and joint TRP measurements in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or TRPs. Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands.

The base station 105 may transmit a reference signal (e.g., a cell-specific reference signal (CRS), a CSI-RS), which may be precoded or unprecoded. The UE 115 may provide feedback for beam selection (e.g., via a CSI report), which may be a PMI or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

In the example of wireless communications system 100, a base station 105 may transmit one or more reference signals (e.g., CRSs, CSI-RSs) to a UE 115. The UE 115 may measure one or more CMRs (e.g., associated with the CSI-RSs) to generate a CSI report for transmission to the base station 105. For example, the UE 115 may indicate, to the base station 105 within the CSI report, one or more resources associated with a better measured quality (e.g., when compared to other resources associated with the CMRs) for future communications between the base station 105 and UE 115. In some cases, the base station 105 may be associated with more than one TRP 145. That is, the base station 105 may transmit signals using one or more than one of the associated TRPs 145. In one example, the base station 105 may transmit one or more CSI-RSs using more than one TRP 145 (e.g., two TRPs) and one or more CSI-RSs using a single TRP 145. Here, the UE 115 may transmit CSI reports associated with both single and joint TRP measurements.

In some cases, a fading emulator MIMO (FeMIMO) device may utilize multiple TRP (mTRP) CSI. For example, an mTRP CSI report (e.g., a non-coherent joint transmission (NCJT) CSI report) may correspond to a CSI report associated with two CMRs. That is, an mTRP CSI report may be configured with two corresponding transmission configuration indicator (TCI) states associated with two TRPs, respectively. Additionally, within a CSI-RS resource set in a given CSI report configuration, one or more pairs of CSI-RS resources may be configured for one or more NCJT CSI hypotheses. That is, the CMRs may be divided into two groups, and each CMR pair (e.g., corresponding to an NCJT CSI hypothesis) may include one CMR from the first group (e.g., associated with a first TRP) and one CMR from the second group (e.g., associated with a second TRP). Additionally, from all possible pairs of CMRs, a number (e.g., ‘N’) may be configured (e.g., for the UE 115 to measure). In some cases, the base station 105 may configure each CMR for both NCJT hypotheses (e.g., associated with mTRP CSI) and single-TRP hypotheses.

In some cases, for CSI measurements associated with a reporting setting (e.g., CSI-ReportConfig) for NCJT CSI hypotheses, the UE 115 may be configured with a first number of CSI-RS resources or CMRs (e.g., ‘Kₛ’ NZP CSI-RS resources, where Kₛ≥2) in a CSI-RS resource set for CMR (e.g., for single TRP CSI reporting) and a second number of CSI-RS resource pairs or CMR pairs (e.g., ‘N’ NZP CSI-RS resource pairs, where N≥1) used for NCJT measurement hypotheses. Here, the UE 115 may be configured with two CMR groups, where the first number of CMRs (e.g., Kₛ) is the sum of the quantity of CMRs in each of the two CMR groups (e.g., Kₛ=K₁+K₂) where K₁ is ≥2 and corresponds to the number of CMRs within a first CMR group associated with a first TRP and K₂ is ≥2 and corresponds to the number of CMRs within a second CMR group associated with a second TRP). In some cases, the UE 115 may be configured to measure a CMR for both single and multiple TRP CSI.

Based on configuring the UE 115 with the two CMR groups, the UE 115 may be configured with CMR pairs (e.g., the UE 115 may determine the CMR pairs). In one example, the UE 115 may be configured with the number of CMR pairs (e.g., the N CMR pairs) based on a higher-layer configuration that selects the number of CMR pairs from all possible pairs. For example, the UE 115 may receive a bitmap indicating the number of CMR pairs from all possible CMR pairs. Additionally or alternatively, the UE 115 may receive control signaling (e.g., radio resource control (RRC) signaling, a media access control-control element (MAC-CE)) indicating the number of CMR pairs from all possible CMR pairs. In some cases, the UE 115 may determine CSI processing units (CPUs), resource and port occupations associated with CSI reporting separately for NCJT hypotheses and single TRP hypotheses.

Based on being configured for both single and NCJT hypotheses, a UE 115 may report CSI (e.g., by transmitting a CSI report) associated with the single and joint TRPs. In one example, the UE 115 may report CSI for NCJT hypotheses separately from single TRP hypotheses. Here, the UE 115 may report one CSI for all configured NCJT hypotheses (e.g., corresponding to all ‘N’ CMR pairs) and a number of CSIs (e.g., ‘X’) for all configured single TRP hypotheses (e.g., corresponding to all single CMRs). The number of CSIs reported for the configured single TRP hypotheses may be indicated to the UE 115 (e.g., by control signaling) and may be equal to 0, 1, or 2. That is, ‘X’ may be equal to 0, 1, or 2. In another example, the UE 115 may report CSI associated with the best (e.g., corresponding to the CMR associated with a highest measured signal quality, a lowest measured noise) one among all hypotheses (e.g., from the single TRP hypotheses and the NCJT hypotheses).

In either option, the UE 115 may be configured to report one or more parameters within the CSI report associated with the single TRP hypotheses, the NCJT hypotheses, or both. For NCJT CSI, the UE 115 may include a single CSI-RS resource indicator (CRI) identifying a CMR pair corresponding to the CSI report, two rank indicators for each of the two CMRs within the CMR pair, and one CQI in a first portion of the CSI report (e.g., within CSI part 1). Additionally, the UE 115 may include two PMIs and two layer indicators (LIs) in a second portion of the CSI report (e.g., with CSI part 2). For each of the number (e.g., ‘X’) of single TRP CSIs that the UE 115 is configured to report, the UE 115 may include a CRI, an RI, and a CQI in a first portion of the CSI report (e.g., within CSI part 1) and a PMI and LI within a second portion of the CSI report (e.g., within CSI part 2).

A CSI report may occupy a certain number of CPUs at the UE 115, where the number of CPUs is based on the quantity of reports within the CSI report (e.g., based on the number ‘X’ of single TRP CSIs, based on the number ‘N’ of NCJT hypotheses). For example, the number of CPUs occupied by the UE 115 when the number of CSI reports is zero and with a CSI-RS-ResourceSet with a higher layer parameter trs-Info configured may be zero. Additionally, when the number of CSI reports configured corresponds to a cri-RSRP, ssb-Index-RSRP such as L1-RSRP report, or none such as receive beam sweep, the number of CPUs occupied by the UE 115 may be one. In another example, for wideband CSI with up to four ports within a CRI report, the UE 115 may occupy a number of CPUs that is equal to a defined number of occupied CPUs supported by the UE 115 (e.g., based on a capability of the UE 115). In other examples, the number of CPUs occupied by the UE 115 may correspond to a number of CSI-RS resources (e.g., a number of CMRs) within a CSI-RS resource set for channel measurement (e.g., a CMR group).

A UE 115 may be configured to refrain from updating remaining CSIs in cases that a total number of CPUs occupied by the UE 115 exceeds a defined number of occupied CPUs supported by the UE 115 (e.g., that is based on a capability of the UE 115). Additionally, a CSI report may be associated with active CRI-RS resources and active CSI-RS port occupation. Here, the UE 115 may be configured to refrain from updating remaining CSIs in cases that a total number of active CSI-RS resources exceeds a defined number of active CSI-RS resources supported by the UE 115 or a total number of active CSI-RS port occupation associated with the CSI report exceeds a defined number of active CSI-RS port occupation supported by the UE 115. In some cases, if a CSI-RS resource (e.g., a CMR) is referred ‘N’ times by one or more CSI reporting settings, the CSI-Rs resource and the CSI-RS ports within the CSI-RS resource may be counted ‘N’ times.

In the example of wireless communications system 100, the UE 115 may be configured for both single TRP hypotheses and NCJT hypotheses. For example, the UE 115 may receive control signaling indicating a first subset of CMRs from a set of CMRs for single TRP measurements (e.g., for single TRP hypotheses) associated with a first TRP 145, a second subset of CMRs from a second set of CMRs for single TRP measurements associated with a second TRP 145, and one or more CMR pairs for joint TRP measurements (e.g., for NCJT hypotheses). Here, each CMR pair may include one CMR from the first subset (e.g., associated with the first TRP) and one CMR from the second subset (e.g., associated with the second TRP). The UE 115 may then monitor the indicated CMRs (e.g., the first subset, the second subset, and the one or more CMR pairs) to generate a set of measurements for CSI. The UE 115 may transmit a CSI report indicating one or more channel resource indicators associated with at least one of the set of measurements. In some cases, the UE 115 may indicate the one or more channel resource indicators within a number of bits that are based on the number of CMR pairs indicated by the control signaling. That is, a codespace associated with the number of bits (e.g., a number of possible CMRs indicated by each channel resource indicator) may be based on the number of CMR pairs, and thus the number of bits indicating the channel resource indicators may also be based on the number of CMR pairs.

In another example, the described techniques provide for the UE 115 to transmit CSI reports associated with both single and joint TRP measurements where the UE 115 shares a PMI, an RI, or both, between CSI measurements associated with both single and joint TRP measurements. For example, the UE 115 may receive control signaling (e.g., from a base station 105, from a TRP 145) indicating a pair of CMRs and that a first and second PMI a first and second RI calculated for channel measurements associated with the CMR pair may be shared for generating channel measurements (e.g., CQIs) for each CMR within the pair of CMRs individually. The UE 115 may monitor the pair of CMRs to generate the joint TRP CSI (e.g., including the first and second PMIs and the first and second RIs). The UE 115 may additionally generate a first single TRP CSI associated with a first TRP 145 that includes the first PMI and the first RI and a second single TRP CSI associated with a second TRP 145 that includes the second PMI and the second RI. The UE 115 may then transmit a CSI report including CQIs associated with both joint and single TRPs that are generated using shared PMIs, shared RIs, or both.

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

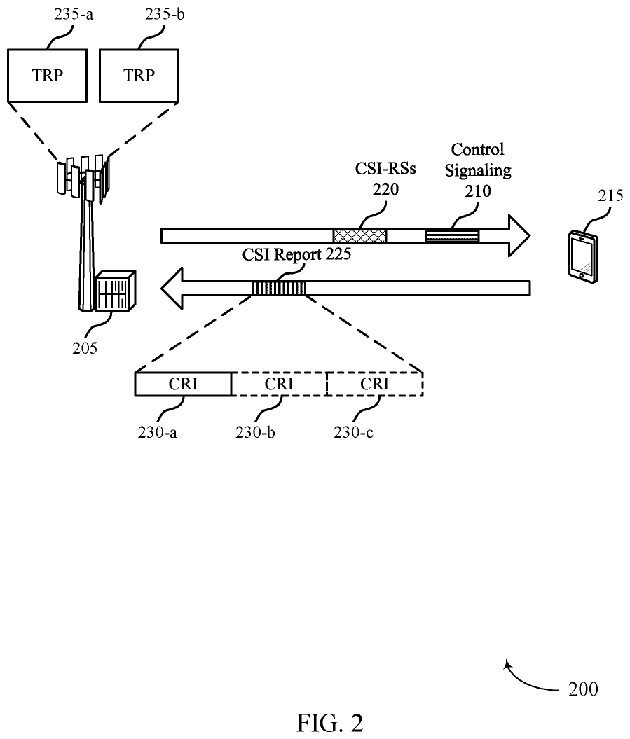

FIG. 2 illustrates an example of a wireless communications system 200 that supports CSI reporting with single and joint TRP measurements in accordance with aspects of the present disclosure. In some examples, the wireless communications system 200 may implement aspects of wireless communications system 100. For example, the wireless communications system 200 may include base station 205 and UE 215, which may be examples of a base station 105 and a UE 115, respectively, as described with reference to FIG. 1.

The UE 215 may be in communication with the base station 205. For example, the UE 215 and base station 205 may exchange messages (e.g., the CSI report 225, the CSI-RSs 220) and signaling (e.g., the control signaling 210). In some cases, the base station 205 may include or be associated with more than one TRP 235. For example, the base station 205 may rely on multiple TRPs 235 (e.g., two) for communications with the UE 215. The base station 205 may transmit the control signaling 210 to the UE 215, which may configure the UE 215 for subsequent communications with the base station 205. For example, the control signaling 210 may indicate, to the UE 215, a first CMR group (e.g., associated with a first TRP 235-a of the base station 205) and a second CMR group (e.g., associated with a second TRP 235-b of the base station 205).

The control signaling 210 may additionally indicate a first subset of CMRs in the first CMR group (e.g., associated with the first TRP 235-a that is associated with the base station 205). The first subset of CMRs may be associated with CMRs that the UE 215 is to monitor in order to generate a subsequent CSI report 225 (e.g., based on single TRP CSI associated with the first TRP 235-a). The control signaling 210 may additionally indicate a second subset of CMRs in the second CMR group (e.g., associated with the second TRP 235-b that is associated with the base station 205). The second subset of CMRs may be associated with CMRs that the UE 215 is to monitor in order to generate a subsequent CSI report 225 (e.g., based on single TRP CSI associated with the second TRP 235-b). The control signaling 210 may additionally indicate one or more CMR pairs including a CMR from the first CMR group (e.g., corresponding to the first TRP 235-a associated with the base station 205) and a CMR from the second CMR group (e.g., corresponding to the second TRP 235-b associated with the base station 205). The one or more pairs of CMRs may be associated with pairs of CMRs that the UE 215 is to monitor in order to generate a subsequent CSI report 225 (e.g., based on NCJT CSI associated with the first and second TRPs 235).

The control signaling 210 may additionally indicate a configuration for the CSI report 225. That is, the control signaling 210 may indicate a quantity of CRIs 230 to be included in the CSI report 225. In one option, the control signaling 210 may configure the UE 215 to indicate a single CRI 230 in the CSI report 225. Here, the single CRI 230 included in the CSI report 225 may indicate one of the CMRs from the first subset, the second subset, and the one or more CMR pairs. That is, the single CRI 230 may indicate the CMR associated with the highest measured signal quality (e.g., from the first subset, the second subset, and the one or more CMR pairs). In another option, the control signaling 210 may configure the UE 215 to indicate two CRIs 230 in the CSI report 225. Here, a first CRI 230-a may indicate the CMR pair (e.g., from the one or more CMR pairs) associated with the highest measured signal quality and the second CRI 230-b may indicate a CMR (e.g., from the first subset and the second subset) associated with the highest measured signal quality. In another option, the control signaling 210 may configure the UE 215 to indicate three CRIs 230 in the CSI report. Here, the first CRI 230-a may indicate the CMR pair (e.g., from the one or more CMR pairs) associated with the highest measured signal quality, the second CRI 230-b may indicate a CMR associated with the first TRP 235-a (e.g., from the first subset) associated with the highest measured signal quality, and the third CRI 230-b may indicate a CMR associated with the second TRP 235-b (e.g., from the second subset) associated with the highest measured signal quality.

Based on transmitting the control signaling 210, the base station 205 may transmit one or more CSI-RSs 220 to the UE 215. For example, the base station 205 may transmit a CSI-RS 220 via each of the CMRs indicated in the first subset, the second subset, and the one or more CMR pairs. That is, the base station 205 may use the first TRP 235-a associated with the base station 205 to transmit CSI-RSs 220 via each of the first subset of CMRs. Additionally, the base station 205 may use the second TRP 235-b associated with the base station 205 to transmit additional CSI-RSs 220 via each of the second subset of CMRs. Further, the base station 205 may use both the first and second TRPs 235 associated with the base station 205 to transmit CSI-RSs 220 via each of the one or more pairs of CMRs.

In accordance with the control signaling 210, the UE 215 may monitor the first subset of CMRs, the second subset of CMRs, and the one or more CMR pairs. The UE 215 may then generate a set of measurements (e.g., CQIs) based on monitoring the first subset, the second subset, and the one or more CMR pairs. For example, the UE 215 may identify (e.g., from the first subset, the second subset, and the one or more CMR pairs) one or more CMRs associated with a highest signal quality (e.g., a highest SNR, a lowest interference).

Based on performing the set of measurements (e.g., on the CSI-RSs 220), the UE 215 may transmit the CSI report 225 to the base station 205. The CSI report 225 may include one or more CRIs 230. That is, the UE 215 may transmit one or more CRIs 230 to the base station 205 each indicating a respective CMR (e.g., from the first subset, the second subset, or the one or more CMR pairs) having a highest measured signal quality (e.g., when compared to the measured signal quality of the remaining CMRs in the first subset, the second subset, and the one or more CMR pairs).

In some cases, the number of bits within each field of the CSI report 225 indicating the CRIs 230 is based on the number of possible CMRs indicated by the CRIs 230 (e.g., the number of CRI codepoints). For example, the number of bits, B, indicating a CRI 230 may be illustrated by Equation 1, shown below. In the example of Equation 1, C may correspond to the number of CRI codepoints (e.g., the number of possible CMRs indicated by the CRI 230).

$$B = ⌈ {log}_{2} C ⌉ \qquad ( 1 )$$

For example, in cases that the UE 215 is configured (e.g., by the control signaling 210) to transmit a single CRI 230-a to the base station 205, the single CRI 230-a may indicate one CMR from the first subset of CMRs, the second subset of CMRs, and the one or more CMR pairs. That is, the CRI 230-a may indicate a CMR among NCJT and single TRP measurement hypotheses. Thus, the bit size of the CRI 230-a may depend on the total number of CMR pairs for NCJT measurement hypotheses (e.g., the number of the one or more CMR pairs) and valid CMRs for single TRP measurement hypotheses (e.g., the number of CMRs within the first subset of CMRs and the second subset of CMRs).

In another example, the UE 215 may be configured (e.g., by the control signaling 210) to transmit two CRIs 230 (e.g., CRI 230-a and CRI 230-b). Here, the CRI 230-a may indicate one of the one or more pairs of CMRs and the CRI 230-b may indicate one of the CMRs from the first subset of CMRs and the second subset of CMRs. That is, the CRI 230-a may be for NCJT measurement hypotheses, where the number of bits for indicating the CRI 230-a may be based on a number of valid CMR pairs for NCJT measurement hypotheses (e.g., the number of the one or more CMR pairs). Additionally, the CRI 230-b may be for single TRP hypotheses and the number of bits for indicating the CRI 230-b may be based on the number of valid CMRs for single TRP measurement hypotheses (e.g., the number of CMRs within the first subset and the second subset).

In another example, the UE 215 may be configured (e.g., by the control signaling 210) to transmit three CRIs 230 (e.g., CRI 230-a, CRI 230-b, and CRI 230-c). Here, the CRI 230-a may indicate one of the one or more pairs of CMRs, the CRI 230-b may indicate a CMR from the first subset of CMRs, and the CRI 230-c may indicate a CMR from the second subset of CMRs. In this example, the CRI 230-a may be for NCJT measurement hypotheses and the number of bits for indicating the CRI 230-a may be based on a number of valid CMR pairs for NCJT measurement hypotheses (e.g., the number of the one or more CMR pairs). Additionally, the CRI 230-b may be for single TRP hypotheses associated with the first TRP 235-a and the number of bits for indicating the CRI 230-b may be based on the number of valid CMRs for single TRP measurement hypotheses associated with the first TRP 235-a (e.g., the number of CMRs within the first subset). Additionally, the CRI 230-c may be for single TRP hypotheses associated with the second TRP 235-b and the number of bits for indicating the CRI 230-c may be based on the number of valid CMRs for single TRP measurement hypotheses associated with the second TRP 235-b (e.g., the number of CMRs within the second subset).

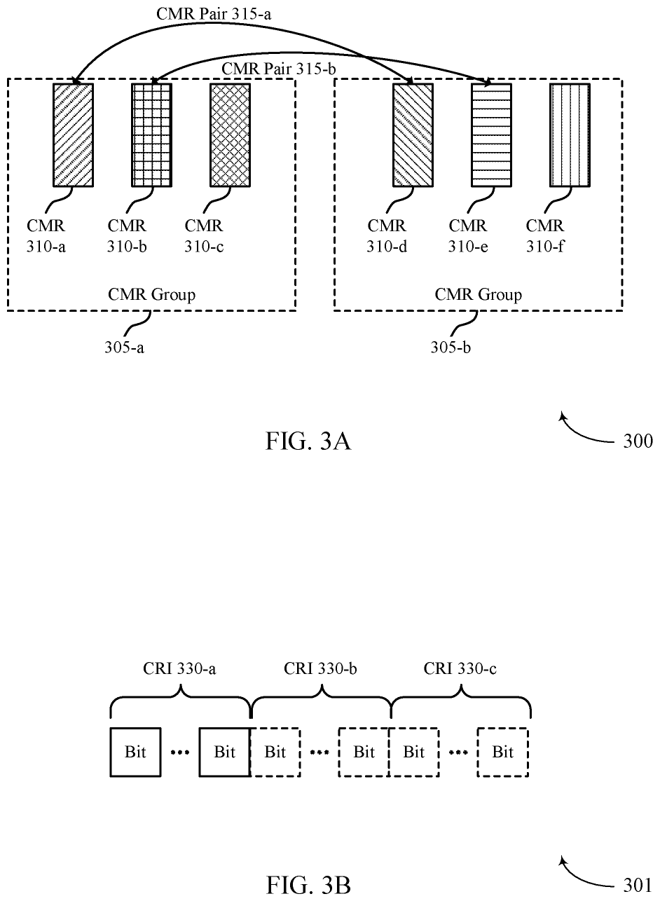

FIG. 3A illustrates an example of a CMR configuration 300 that supports CSI reporting with single and joint TRP measurements in accordance with aspects of the present disclosure. Additionally, FIG. 3B illustrates an example of a CSI report 301 that supports CSI reporting with single and joint TRP measurements in accordance with aspects of the present disclosure. In some cases, the CMR configuration 300 may be an example of a CMR configuration indicated to a UE by a base station (e.g., via control signaling) as described with reference to FIGS. 1 and 2. Additionally, the CSI report 301 may be an example of a CSI report transmitted by the UE to the base station as described with reference to FIGS. 1 and 2. In some cases, a UE may be configured with the CMR configuration 300, may monitor resources for CSI-RSs based on the CMR configuration 300, and may transmit the CSI report 301 (e.g., to a base station) based on monitoring resources associated with the CMR configuration 300.

FIG. 3A illustrates the CMR configuration 300, including the CMR group 305-a and the CMR group 305-b. In some cases, the CMR group 305-a may be a set of CMRs 310 associated with a first TRP (e.g., associated with the base station). That is, the base station may transmit reference signals (e.g., CSI-RSs, CRSs) via one of the CMRs 310 in the CMR group 305-a using a first TRP. Additionally, the CMR group 305-b may be a set of CMRs 310 associated with a second TRP (e.g., associated with the base station). Here, the base station may transmit reference signals via one of the CMRs 310 in the CMR group 305-b using a second TRP. In some cases, the base station may indicate the CMR groups 305 to the UE via control signaling (e.g., RRC signaling).

The base station may indicate (e.g., by control signaling) a subset of the CMRs 310 within the CMR group 305-a for the UE to monitor for single TRP CSI reporting associated with the first TRP, a subset of the CMRs 310 within the CMR group 305-b for the UE to monitor for single TRP CSI reporting associated with the second TRP, and one or more CMR pairs 315-a for the UE to monitor for joint TRP CSI reporting.

To configure the first subset of CMRs 310 from the CMR group 305-a, the second subset of CMRs 310 from the CMR group 305-b, and the CMR pairs 315, the base station may initially configure a number of CMRs 310 (e.g., Kₛ CMRs 310) within the CMR group 305-a and the CMR group 305-b. That is, the base station may indicate, to the UE (e.g., by transmitting control signaling to the UE), that the CMRs 310-a, 310-b, and 310-c are configured as part of the CMR group 305-a for CSI reporting associated with the first TRP. Additionally, the base station may indicate that the CMRs 310-d, 310-e, and 310-f are configured as part of the CMR group 305-b for CSI reporting associated with the second TRP. In some cases, the CMR group 305-a includes a first number of CMRs 310 (e.g., K₁ CMRs 310) and the CMR group 305-b includes a second number of CMRs 310 (e.g., K₂ CMRs 310). The total number of CMRs 310 (e.g., Kₛ CMRs 310) and the number of CMRs 310 in each CMR group (e.g., Kₛ CMRs 310 and Kₛ CMRs 310) may be related as illustrated below in Equation 2.

$${K}_{s} = {K}_{1} + {K}_{2} \qquad ( 2 )$$

Based on configuring the CMR group 305-a and the CMR group 305-b, the base station may indicate, to the UE, the CMR pairs 315 for joint TRP CSI reporting. In one example, the base station may indicate the CMR pairs 315 by indicating (e.g., via control signaling) a number of CMR pairs 315 (e.g., N CMR pairs 315) the UE is to monitor for joint TRP CSI reporting. In the example of the CMR configuration 300, the base station may indicate that the number of CMR pairs 315 the UE is to monitor is two (e.g., N=2). The UE may identify the CMR pairs 315-a and 315-b by selecting a CMR 310 from each CMR group 305 according to an order of the CMR 310 (e.g., corresponding to an index of the CMR 310). For example, the UE may identify the CMR pairs 315 by selecting the first CMR 310 from each CMR group 305 for the first CMR pair 315-a (e.g., including the CMR 310-a and the CMR 310-d) and selecting the second CMR 310 from each CMR group 305 for the second CMR pair 315-b.

Based on configuring the CMR groups 305-a and 305-b and configuring the CMR pairs 315, the base station may configure a first subset of CMRs 310 from the CMR group 305-a (e.g., for determining single TRP CSI measurements associated with the first TRP) and a second subset of CMRs 310 from the CMR group 305-b (e.g., for determining single TRP CSI measurements associated with the second TRP). The first subset of CMRs 310 from the first CMR group 305-a may include M₁ CMRs 310 and the second subset of CMRs 310 from the second CMR group 305-b may include M₂ CMRs 310. The subsets of CMRs 310 and CMR pairs 315 configured for the UE to monitor for single TRP CSI reporting may be based on whether or not sharing CMRs 310 between single and joint TRP CSI reporting is enabled (e.g., configured for the UE by the base station via control signaling). In some cases, whether a CMR 310 may appear in a CMR pair 315 in addition to in a subset of CMRs 310 (e.g., sharing CMRs 310 between single and joint TRP reporting) may be based on a capability of the UE (e.g., within a frequency range such as within a frequency range that includes millimeter wave frequencies between 24.25 GHz and 52.6 GHz).

In cases that sharing is enabled, the UE may be configured to monitor a same CMR 310 for both single and joint TRP CSI reporting. For example, the UE may be configured to monitor CMR 310-a for single TRP CSI reporting (e.g., the base station may indicate that the CMR 310-a is part of the first subset associated with the first TRP) and configured to monitor the CMR 310-a for joint TRP CSI reporting (e.g., as part of the CMR pair 315-a including the CMR 310-a from the CMR group 305-a and the CMR 310-d from the CMR group 305-b). In cases that sharing is disabled, the UE may be configured to monitor different CMRs 310 for single TRP CSI reporting that for joint TRP CSI reporting. That is, in cases that the CMR 310-b is configured as part of the CMR pair 315-b, the UE may be configured to refrain from monitoring the CMR 310-b for single TRP CSI reporting associated with the first TRP. That is, the first subset of CMRs 310 associated with the first TRP may not include the CMR 310-b (because the CMR 310-b is part of the CMR pair 315-b including the CMR 310-b and the CMR 310-e).

In one example, to configure each of the subsets of CMRs 310 (e.g., the first subset of the CMR group 305-a, the second subset of the CMR group 305-b), the base station may transmit additional control signaling (e.g., RRC signaling) to the UE indicating the CMRs 310 within the first subset of the CMR group 305-a and the CMRs 310 within the second subset of the CMR group 305-b. That is, the base station may indicate M₁ CMRs 310 from the K₁ CMRs 310 in the first CMR group 305-a for the first subset of CMRs 310. Additionally, the base station may indicate M₂ CMRs 310 from the K₂ CMRs 310 in the second CMR group 305-b for the second subset of CMRs 310. In one case of this example where sharing CMRs for joint and single TRP CSI reporting is enabled, the base station may transmit control signaling indicating that the first subset of CMRs 310 includes the CMR 310-a and the second subset of CMRs 310 includes the CMR 310-f. In another case of this example where sharing CMRs for joint and single TRP CSI reporting is not enabled, the base station may transmit control signaling indicating that the first subset of CMRs 310 includes the CMR 310-c and the second subset of CMRs 310 includes the CMR 310-f.

In another example, to configure each of the subsets of CMRs 310 (e.g., the first subset of the CMR group 305-a, the second subset of the CMR group 305-b), the base station may indicate whether sharing CMRs 310 between joint and single TRP CSI reporting is enabled (e.g., via RRC signaling). In cases that the base station indicates that sharing CMRs 310 between joint and single TRP CSI reporting is enabled, the UE may determine that each subset includes all of the CMRs 310 associated with that TRP. That is, the base station may transmit RRC signaling enabling CMR 310 sharing (e.g., between NCJT hypotheses and single TRP hypotheses) and the UE may determine that all of the CMRs 310 within the first CMR group 305-a and the second CMR group 305-b are valid. For example, the UE may determine that Kₛ CMRs 310 (e.g., K₁+K₂ CMRs as described in Equation 2) are valid single TRP hypotheses. That is, the UE may determine that the number of CMRs 310 in the first subset of the first CMR group 305-a is the same as the number of CMRs in the first CMR group 305-a (e.g., M₁=K₁) and the number of CMRs 310 in the second subset of the second CMR group 305-b is the same as the number of CMRs in the second CMR group 305-b (e.g., M₂=K₂). Here (e.g., for CMR configuration 300), the UE may determine that the first subset of CMRs 310 associated with the first TRP may include the CMR 310-a, the CMR 310-b, and the CMR 310-c (e.g., all of the CMRs 310 in the CMR group 305-a associated with the first TRP).

In cases of this example that the base station indicates that sharing CMRs 310 between joint and single TRP CSI reporting is disabled, the UE may determine that the subsets include CMRs 310 within each respective CMR group 305 that are distinct from CMRs 310 within a CMR pair 315. That is, the base station may transmit RRC signaling disabling CMR 310 sharing (e.g., between NCJT hypotheses and single TRP hypotheses). The UE may then determine that the number of CMRs 310 in the first CMR group 305-a that appear in any of the number of CMR pairs 315 (e.g., N₁ CMRs 310) and number of CMRs 310 in the second CMR group 305-b that appear in any of the number of CMR pairs 315 (e.g., N₂ CMRs 310). In cases that CMRs 310 are not shared between CMR pairs 315 (e.g., each CMR pair 315 includes distinct CMRs as illustrated in the example of CMR configuration 300), the number of CMRs 310 from each CMR group 305 that are in a CMR pair 315 (e.g., N₁ and N₂ for CMR groups 305-a and 305-b, respectively) may be the same as the number of CMR pairs 315 (e.g., N CMR pairs 315). In some other cases where CMRs 310 are shared between CMR pairs 315, the number of CMRs 310 from each CMR group 305 that are in a CMR pair 315 may be less than or equal to the number of CMR pairs 315. Based on determining the number of CMRs 310 that are in a CMR pair (e.g., N₁ and N₂ for CMR groups 305-a and 305-b, respectively), the UE may determine the number of CMRs 310 in each of the subsets. That is, the UE may determine that the number of CMRs 310 in the first subset of the first CMR group 305-a is the difference between the number of CMRs 310 in the first CMR group 305-a and the number of CMRs 310 from the first CMR group 305-a in a CMR pair 315 (e.g., M₁=K₁−N₁) and the number of CMRs 310 in the second subset of the second CMR group 305-b is the difference between the number of CMRs 310 in the second CMR group 305-b and the number of CMRs 310 from the first CMR group 305-b in a CMR pair 315 (e.g., M₂=K₂−N₂).

Here (e.g., for CMR configuration 300), the UE may determine that the first subset of CMRs 310 (e.g., associated with the first TRP and including CMRs 310 from the first CMR group 305-a) includes the CMR 310-c based on the CMR 310-c being distinct from the CMRs 310 in the CMR group 305-a associated with CMR pairs 315 (e.g., CMR 310-a and CMR 310-b). Additionally, the UE may determine that the second subset of CMRs 310 (e.g., associated with the second TRP and including CMRs 310 from the second CMR group 305-b) includes the CMR 310-f based on the CMR 310-f being distinct from the CMRs 310 in the CMR group 305-f associated with CMR pairs 315 (e.g., CMR 310-d and CMR 310-e).

In another example, to configure each of the subsets of CMRs 310 (e.g., the first subset of the CMR group 305-a, the second subset of the CMR group 305-b), the base station may transmit additional control signaling (e.g., RRC signaling) to the UE indicating a same value for an identifier of a CMR 310 that is configured for joint CSI reporting (e.g., a CMR pair 315) and a single CMR 310 (e.g., a single CMR 310 within a CMR group 305). For example, if the CMR configuration 300 supports sharing CMRs 310 between joint and single CSI reporting, the first subset may include CMR 310-a based on the base station assigning CMR 310-a a same identifier as the CMR pair 315-a. Here, the base station may update the subsets of CMRs 310 by reconfiguring the CMR configuration 300 (e.g., by reconfiguring the identifiers of the CMRs 310 within the CMR groups 305, by reconfiguring the identifiers of the CMR pairs 315). Here, the UE may determine the number of CMRs 310 in each of the subsets based on the number of CMR pairs 315 (e.g., N CMR pairs 315). That is, the UE may determine that the number of CMRs 310 in the first subset of the first CMR group 305-a is the difference between the number of CMRs 310 in the first CMR group 305-a and the number of CMR pairs 315 (e.g., M₁=K₁−N) and the number of CMRs 310 in the second subset of the second CMR group 305-b is the difference between the number of CMRs 310 in the second CMR group 305-b and the number of CMR pairs 315 (e.g., M₂=K₂−N). That is, because the first N CMRs 310 in each CMR group 305 may be used for CMR pairs 315, the CMRs 310 within each CMR group 305 may be used for single TRP CSI reporting (e.g., may be within the first subset or the second subset).

FIG. 3B illustrates an example CSI report 301. The UE may generate the CSI report 301 in response to monitoring the CMRs 310 in accordance with the CMR configuration 300 configured by the base station. The CSI report 301 may include one or more CRIs 330, where each CRI 330 indicates a CMR 310 associated with a higher measured signal quality than other CMRs 310 associated with the CRI 330.

The number of bits indicating each CRI 330 may be based on the number of possible CMRs 310 indicated by each CRI 330 (e.g., C possible CMRs 310) as described in Equation 1. Specifically, the number of bits indicating CRIs 330 (e.g., the CRI codepoints or bitwidth of CRIs in the CSI report 301) associated with a CSI report setting which contains two CMR groups 305 in one CMR resource set may depend on the number of CMRs 310 in both groups (e.g., Kₛ), the number of CMRs 310 in each group (e.g., K₁ and K₂), and the number of CMR pairs 315 (e.g., N). Additionally or alternatively, the number of bits indicating CRIs 330 may be based on the number of subsets of CMRs 310 configured for single TRP hypotheses as individual CMRs 310 in the first CMR group 305-a, and in the second CMR group 305-b, as well as across both CMR groups 305, which may be based on how the subsets of CMRs 310 are configured. Additionally, the number of bits indicating CRIs 330 may be based on whether the UE is configured to report one CSI 301 associated with the best one among NCJT and single TRP hypotheses (e.g., where one CRI 330 is reported) or to report X CSIs associated with single TRP hypotheses and one CSI associated with NCJT hypotheses, where the configured value of X may be 0, 1, or 2 and X+1 CRIs 330 are reported. Thus, the number of bits indicating each CRI 330 is based on the number of CRIs 330 within the CSI report 301, the number of CRMs 310 within each subset of CRM groups 315, and the number of CRM pairs 315.

For example, in cases that the UE is configured to include a single CRI 330-a within the CSI report 301 indicating any of the CMRs 310 within the first subset of the first CMR group 305-a, any of the CMRs 310 within the second subset from the second CMR group 305-b, and any of the CMR pairs 315. Here, the number of possible CMRs 310 (e.g., C possible CMRs 310) indicated by the CRI 330-a may be based on the number of CMRs 310 within the first subset (e.g., M₁ CMRs 310), the number of CMRs 310 within the second subset (e.g., M₂ CMRs 310), and the number of CMR pairs 315 (e.g., N CMR pairs 315), as described below in Equation 3.

$$C = {M}_{1} + {M}_{2} + N \qquad ( 3 )$$

In cases that the UE is configured to include a single CRI 330-a within the CSI report 301 indicating one of the CMR pairs 315, the number of possible CMRs 310 (e.g., C possible CMRs 310) indicated by the CRI 330-a may be based on the number of CMR pairs 315 (e.g., N CMR pairs 315), as described below in Equation 4.

$$C = N \qquad ( 4 )$$

In cases that the UE is configured to include two CRIs 330-a and 330-b within the CSI report 301, the CRI 330-a may indicate any of the CMR pairs 315 and the CRI 330-b may indicate any of the CMRs 310 within the first subset or the second subset. Here, the number of possible CMRs 310 indicated by the CRI 330-a may correspond to Equation 4. Additionally, the number of CMRs 310 indicated by the CRI 330-b may be described below in Equation 5.

$$C = {M}_{1} + {M}_{2} \qquad ( 5 )$$

In cases that the UE is configured to include three CRIs 330-a, 330-b, and 330-c, the CRI 330-a may indicate any of the CMR pairs 315, the CRI 330-b may indicate any of the CMRs 310 in the first subset, and the CRI 330-c may indicate any of the CMRs 310 in the third subset. Here, the CRI 330-a may indicate one CMR pair 315 from a possible number CMR pairs 315 as defined in Equation 4. Additionally, the CRI 330-b may indicate M₁ possible CMRs 310 as described in Equation 6.

$$C = {M}_{1} \qquad ( 6 )$$

Further, the CRI 330-c may indicate M₂ possible CMRs 310, as described in Equation 7.

$$C = {M}_{2} \qquad ( 7 )$$

In some cases, additional RRC signaling is used to configure the UE with M (M≤Kₛ) CMRs 310 from each CSI-RS resource set (e.g., from each CMR group 305) for single TRP measurement hypotheses. In a first option, a UE may be configured to report X CSIs associated with single-TRP hypotheses and one CSI associated with NCJT hypothesis, and the configured value of X may be, for example, 0, 1, or 2, resulting in a CSI report including X+1 CRIs. In a second option the UE may configured to report a single CSI associated among NCJT and single TRP hypotheses (e.g., a best or highest CSI).

If the additional RRC signaling selects M₁ CMRs 310 from the first CMR group 305-a (out of K₁ CMRs) and M₂ CMRs 310 from the second CMR group 305-b (out of K₂ CMRs 310) for single-TRP hypotheses, then, in the second option, the number of CRI codepoints is C=M₁+M₂+N (e.g., as described with reference to Equation 3). For example, if two NCJT hypotheses are configured (e.g., N=2) corresponding to CMR pair 315-a (e.g., including CMRs 310-a and 310-d) and CMR pair 315-b (e.g., including CMRs 310-b and 310-e), and the additional RRC signaling indicates the single TRP measurement hypotheses correspond to CMRs 310-a, 310-c, and 310-f, then the number of code points may be 5, and thus the CSI report 301 may include 3 bits (e.g., in the CRI 330-a) to cover the five codepoints (e.g., C=2+1+2).

In another example, if the additional RRC signaling selects M₁ CMRs 310 from the first CMR group 305-a (out of K₁ CMRs) and M₂ CMRs 310 from the second CMR group 305-b (out of K₂ CMRs 310) for single-TRP hypotheses, then, in the first option, the number of CRI codepoints may depend on the value of X (e.g., the UE is configured to report X CSIs associated with single-TRP hypotheses). If X=0 (one CRI 330 is reported), then C═N (e.g., as described with reference to Equation 4). If X=1 (two CRIs 330 are reported), then C₁=N and C₂=M₁+M₂ (e.g., as described with reference to Equation 5). If X=2 (three CRIs 330 are reported), then C₁=N, C₂=M₁, and C₃=M₂. In an example, if two NCJT hypotheses are configured (e.g., N=2) corresponding to CMR pairs 315-a and 315-b, and the additional RRC signaling indicates the single TRP measurement hypotheses correspond to CMRs 310-a, 310-c, and 310-f, if X=0 (one CRI 330): C=2, and thus the CSI report may include 1 bit to cover the two possible codepoints. If X=1 (two CRIs): C₁=2 (1 bit), C₂=2+1=3 (2 bits), and thus the CSI report may include two CRIs 330 (e.g., two CRI fields), with the first field including 1 bit, and the second field including 2 bits. If X=2 (three CRIs 330): C₁=2 (1 bit), C₂=2 (1 bit), C₃=1 (0 bits; not reported as described with reference to Equation 1), and thus the CSI report 301 may include three CRIs 330 (e.g., three CRI fields), with the first field including 1 bit, the second field including 2 bits, and the third field including 0 bits (e.g., the third field may be omitted from the CSI report 301). In other examples, the third field may include one or more bits and may be included in the CSI report 301. It is noted that other values of N, M1, and M2 may be configured, thus resulting in different numbers of codepoints in the examples above.

In some other cases, the base station may transmit additional RRC signaling to enable CMR sharing (e.g., between NCJT hypotheses and single TRP hypotheses). Specifically, for CMRs 310 configured in the CSI-RS resource set, the base station may transmit RRC signaling to enable or disable single TRP measurement hypotheses using CMRs 310 configured within CMR pairs 315 for NCJT measurement hypotheses. When sharing is enabled, one or more of the single TRP measurement hypotheses may use a CMR 310 included in a CMR pair 315 associated with an NCJT measurement hypotheses. In a first option, a UE may be configured to report X CSIs associated with single-TRP hypotheses and one CSI associated with NCJT hypothesis, and the configured value of X may be, for example, 0, 1, or 2, resulting in a CSI report including X+1 CRIs. In a second option, the UE may configured to report a single CSI associated among NCJT and single TRP hypotheses (e.g., a best or highest CSI).

If the additional RRC signaling enables sharing of CMRs 310 between NCJT hypotheses and single TRP hypotheses, then each of the CMRs 310 (e.g., K₁+K₂=Kₛ CMRs) correspond to valid single TRP hypotheses (e.g., including the CMRs 310 within the CMR pairs 315) and the UE is configured with M₁ CMRs 310 from the first CMR group 305-a (where M₁=K₁ CMRs 310) and M₂ CMRs 310 from the second CMR group 305-b (where M₂=K₂ CMRs 310) for single-TRP hypotheses. Additionally, if the additional RRC signaling disables sharing of CMRs 310 between NCJT hypotheses and single TRP hypotheses, the UE may determine that the number of CMRs 310 in the first CMR group 305-a that appear in any of the number of CMR pairs 315 (e.g., N₁ CMRs 310) and number of CMRs 310 in the second CMR group 305-b that appear in any of the number of CMR pairs 315 (e.g., N₂ CMRs 310). In cases that CMRs 310 are not shared (e.g., unshared with respect to the CMRs that appear in a CMR pair for NCJT CSI hypotheses) between CMR pairs 315 (e.g., each CMR pair 315 includes distinct CMRs as illustrated in the example of CMR configuration 300), the number of CMRs 310 from each CMR group 305 that are in a CMR pair 315 (e.g., N₁ and N₂ for CMR groups 305-a and 305-b, respectively) may be the same as the number of CMR pairs 315 (e.g., N CMR pairs 315). In some other cases where CMRs 310 are shared between CMR pairs 315, the number of CMRs 310 from each CMR group 305 that are in a CMR pair 315 may be less than or equal to the number of CMR pairs 315. Based on determining the number of CMRs 310 that are in a CMR pair (e.g., N₁ and N₂ for CMR groups 305-a and 305-b, respectively), the UE may determine the number of valid single TRP hypotheses (e.g., CMRs that are unshared with the CMR pairs). That is, the may be configured with M₁ CMRs 310 from the first CMR group 305-a (where M₁=K₁−N₁ CMRs 310, e.g., indicating the number of unshared CMRs in the first CMR group) and M₂ CMRs 310 from the second CMR group 305-b (where M₂=K₂−N₂ CMRs 310, e.g., indicating the number of unshared CMRs in the second CMR group) for single-TRP hypotheses.

In the second option, the number of CRI codepoints is C=M₁+M₂+N (e.g., as described with reference to Equation 3). For example, if two NCJT hypotheses are configured (e.g., N=2) corresponding to CMR pair 315-a (e.g., including CMRs 310-a and 310-d) and CMR pair 315-b (e.g., including CMRs 310-b and 310-e), and sharing is disabled indicating that the single TRP measurement hypotheses correspond to CMRs 310-c and 310-f, then the number of codepoints may be 4, and thus the CSI report 301 may include 2 bits (e.g., in the CRI 330-a) to cover the 4 codepoints (e.g., C=2+1+1).

In another example associated with the first option, the number of CRI codepoints may depend on the value of X (e.g., the UE is configured to report X CSIs associated with single-TRP hypotheses). If X=0 (one CRI 330 is reported), then C═N (e.g., as described with reference to Equation 4). If X=1 (two CRIs 330 are reported), then C₁=N and C₂=M₁+M₂ (e.g., as described with reference to Equation 5). If X=2 (three CRIs 330 are reported), then C₁=N, C₂=M₁, and C₃=M₂. In an example, if two NCJT hypotheses are configured (e.g., N=2) corresponding to CMR pair 315-a (e.g., including CMRs 310-a and 310-d) and CMR pair 315-b (e.g., including CMRs 310-b and 310-e) such that N₁=2 and N₂=2 (and M₁=K₁−N₁=3−2=1 and M₂=K₂−N₂=3−2=1, and sharing is disabled indicating that the single TRP measurement hypotheses correspond to CMRs 310-c and 310-f, if X=0 (one CRI 330): C=2, and thus the CSI report may include 1 bit to cover the two possible codepoints. If X=1 (two CRIs): C₁=2 (1 bit), C₂=1+1=2 (1 bit), and thus the CSI report may include two CRIs 330 (e.g., two CRI fields), with the first field including 1 bit, and the second field including 1 bits. If X=2 (three CRIs 330): C₁=2 (1 bit), C₂=1 (0 bits; not reported as described with reference to Equation 1), C₃=1 (0 bits; not reported as described with reference to Equation 1), and thus the CSI report 301 may include three CRIs 330 (e.g., three CRI fields), with the first field including 1 bit, the second field including 0 bits, and the third field including 0 bits (e.g., the second and third fields may be omitted from the CSI report 301). In other examples, the second field and the third field may include one or more bits and may be included in the CSI report 301. It is noted that other values of N, M1, and M2 may be configured, thus resulting in different numbers of codepoints in the examples above.

In another example associated with the first option, if two NCJT hypotheses are configured (e.g., N=2) corresponding to CMR pair 315-a (e.g., including CMRs 310-a and 310-d) and another CMR pair 315 (e.g., including CMRs 310-a and 310-e) such that N₁=1 and N₂=2 (and M₁=K₁−N₁=3−1=2 and M₂=K₂−N₂=3−2=1, and sharing is disabled indicating that the single TRP measurement hypotheses correspond to CMRs 310-b, 310-c and 310-f, if X=0 (one CRI 330): C=2, and thus the CSI report may include 1 bit to cover the two possible codepoints. If X=1 (two CRIs): C₁=2 (1 bit), C₂=2+1=3 (2 bits), and thus the CSI report may include two CRIs 330 (e.g., two CRI fields), with the first field including 1 bit, and the second field including 2 bits. If X=2 (three CRIs 330): C₁=2 (1 bit), C₂=2 (1 bit), C₃=1 (0 bits; not reported as described with reference to Equation 1), and thus the CSI report 301 may include three CRIs 330 (e.g., three CRI fields), with the first field including 1 bit, the second field including 2 bits, and the third field including 0 bits (e.g., the third field may be omitted from the CSI report 301). In other examples, the third field may include one or more bits and may be included in the CSI report 301. It is noted that other values of N, M1, and M2 may be configured, thus resulting in different numbers of codepoints in the examples above.

In some cases, the base station may indicate CMR 310 sharing between single TRP measurement hypotheses and NCJT measurement hypotheses by configuring a same value of a CMR ID for single TRP CMR and NCJT CMR pair. In this example, the UE may determine that the first N CMRs 310 in each CMR group 305 is used only for NCJT and the UE may select CMRs 310 for single TRP hypotheses starting at the N+1 CMR 310 of the CMR group 305. Thus, the UE may determine M based on the value of N, where M₁=K₁−N and M₂=K₂−N. In a first option, a UE may be configured to report X CSIs associated with single-TRP hypotheses and one CSI associated with NCJT hypothesis, and the configured value of X may be, for example, 0, 1, or 2, resulting in a CSI report including X+1 CRIs. In a second option, the UE may configured to report a single CSI associated among NCJT and single TRP hypotheses (e.g., a best or highest CSI).

If the UE is configured with M₁ CMRs 310 from the first CMR group 305-a (where M₁=K₁−N CMRs 310 corresponding to the number of valid sTRP hypotheses in the first CMR group, e.g., the number of CMRs in the first CMR group minus the number of pairs) and M₂ CMRs 310 from the second CMR group 305-b (where M₂=K₂−N CMRs 310 corresponding to the number of valid sTRP hypotheses in the second CMR group, e.g., the number of CMRs in the second CMR group minus the number of pairs) for single-TRP hypotheses, then, in the second option, the number of CRI codepoints is C=M₁+M₂+N (e.g., as described with reference to Equation 3). For example, if two NCJT hypotheses are configured (e.g., N=2) corresponding to CMR pair 315-a (e.g., including CMRs 310-a and 310-d) and CMR pair 315-b (e.g., including CMRs 310-b and 310-e), and the single TRP measurement hypotheses corresponds to CMRs 310-c, and 310-f, then the number of code points may be four, and thus the CSI report 301 may include 2 bits (e.g., in the CRI 330-a) to cover the four codepoints (e.g., C=2+1+1).

In another example, if the UE is configured with M₁ CMRs 310 from the first CMR group 305-a (out of K₁ CMRs) and M₂ CMRs 310 from the second CMR group 305-b (out of K₂ CMRs 310) for single-TRP hypotheses, then, in the first option, the number of CRI codepoints may depend on the value of X (e.g., the UE is configured to report X CSIs associated with single-TRP hypotheses). If X=0 (one CRI 330 is reported), then C═N (e.g., as described with reference to Equation 4). If X=1 (two CRIs 330 are reported), then C₁=N and C₂=M₁+M₂ (e.g., as described with reference to Equation 5). If X=2 (three CRIs 330 are reported), then C₁=N, C₂=M₁, and C₃=M₂. In an example, if two NCJT hypotheses are configured (e.g., N=2) corresponding to CMR pairs 315-a and 315-b, and the additional RRC signaling indicates the single TRP measurement hypotheses correspond to CMRs 310-c, and 310-f, if X=0 (one CRI 330): C=2, and thus the CSI report may include 1 bit to cover the two possible codepoints. If X=1 (two CRIs): C₁=2 (1 bit), C₂=1+1=2 (1 bits), and thus the CSI report may include two CRIs 330 (e.g., two CRI fields), with the first field including 1 bit, and the second field including 1 bits. If X=2 (three CRIs 330): C₁=2 (1 bit), C₂=1 (0 bits; not reported as described with reference to Equation 1), C₃=1 (0 bits; not reported as described with reference to Equation 1), and thus the CSI report 301 may include three CRIs 330 (e.g., three CRI fields), with the first field including 1 bit, the second field including 0 bits, and the third field including 0 bits (e.g., the second and third fields may be omitted from the CSI report 301). In other examples, the second and third fields may include one or more bits and may be included in the CSI report 301. It is noted that other values of N, M1, and M2 may be configured, thus resulting in different numbers of codepoints in the examples above.

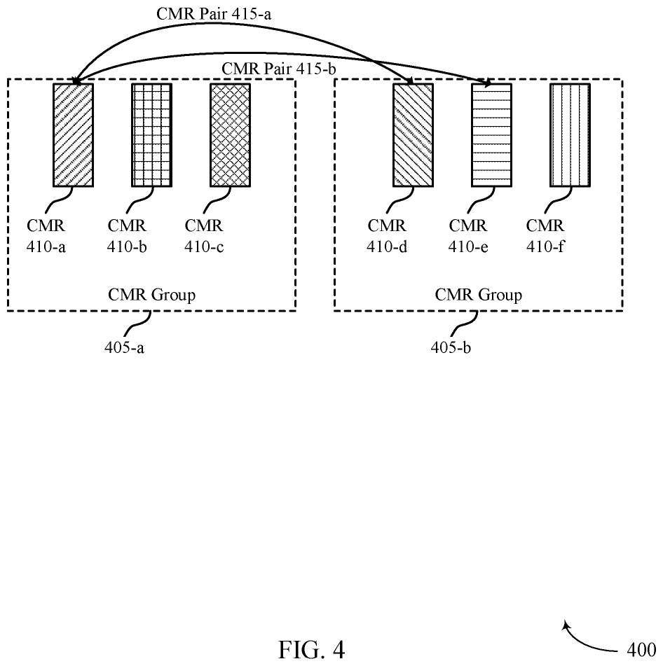

FIG. 4 illustrates an example of a CMR configuration 400 that supports CSI reporting with single and joint TRP measurements in accordance with aspects of the present disclosure. In some cases, the CMR configuration 400 may be an example of a CMR configuration indicated to a UE by a base station (e.g., via control signaling) as described with reference to FIGS. 1 through 3. The CMR configuration 400 may include the CMR group 405-a and the CMR group 405-b. In some cases, the CMR group 405-a may be a set of CMRs 410 associated with a first TRP (e.g., associated with the base station). That is, the base station may transmit reference signals (e.g., CSI-RSs, CRSs) via one of the CMRs 410 in the CMR group 405-a using a first TRP. Additionally, the CMR group 405-b may be a set of CMRs 410 associated with a second TRP (e.g., associated with the base station). Here, the base station may transmit reference signals via one of the CMRs 410 in the CMR group 405-b using a second TRP. In some cases, the base station may indicate the CMR groups 405 to the UE via control signaling (e.g., RRC signaling).

The base station may indicate (e.g., by control signaling) a subset of the CMRs 410 within the CMR group 405-a for the UE to monitor for single TRP CSI reporting associated with the first TRP, a subset of the CMRs 410 within the CMR group 405-b for the UE to monitor for single TRP CSI reporting associated with the second TRP, and one or more CMR pairs 415-a for the UE to monitor for joint TRP CSI reporting.

To configure the first subset of CMRs 410 from the CMR group 405-a, the second subset of CMRs 410 from the CMR group 405-b, and the CMR pairs 415, the base station may initially configure a number of CMRs 410 (e.g., Kₛ CMRs 410) within the CMR group 405-a and the CMR group 405-b. In some cases, the CMR group 405-a includes a first number of CMRs 410 (e.g., K₁ CMRs 410) and the CMR group 405-b includes a second number of CMRs 410 (e.g., K₂ CMRs 410). Based on configuring the CMR group 405-a and the CMR group 405-b, the base station may indicate, to the UE, the CMR pairs 415 for joint TRP CSI reporting. In one example, the base station may indicate the CMR pairs 415 by indicating (e.g., via control signaling) a number of CMR pairs 415 (e.g., N CMR pairs 415) the UE is to monitor for joint TRP CSI reporting.

Based on configuring the CMR groups 405-a and 405-b and configuring the CMR pairs 415, the base station may configure a first subset of CMRs 410 from the CMR group 405-a (e.g., for determining single TRP CSI measurements associated with the first TRP) and a second subset of CMRs 410 from the CMR group 405-b (e.g., for determining single TRP CSI measurements associated with the second TRP). The first subset of CMRs 410 from the first CMR group 405-a may include M₁ CMRs 410 and the second subset of CMRs 410 from the second CMR group 405-b may include M₂ CMRs 410.

In the example of CMR configuration 400, the base station may configure the subsets of CMRs 410 by indicating that sharing CMRs 410 between joint and single TRP CSI reporting is disabled. Here, the UE may determine that the subsets include CMRs 410 within each respective CMR group 405 that are distinct from CMRs 410 within a CMR pair 415. That is, the base station may transmit RRC signaling disabling CMR 410 sharing (e.g., between NCJT hypotheses and single TRP hypotheses). The UE may then determine that the number of CMRs 410 in the first CMR group 405-a that appear in any of the number of CMR pairs 415 (e.g., N₁ CMRs 410) and number of CMRs 410 in the second CMR group 405-b that appear in any of the number of CMR pairs 415 (e.g., N₂ CMRs 410). Here, the CMRs 410 are shared between CMR pairs 415, and thus the number of CMRs 410 from the first CMR group 405-a in a CMR pair 415 is less than the number of CMR pairs 415. That is, the UE may determine that the first subset of CMRs 410 (e.g., associated with the first TRP and including CMRs 410 from the first CMR group 405-a) includes the CMRs 410-b and 410-c based on the CMRs 410-b and 410-c being distinct from the CMR 410-a in the CMR pairs 415. Additionally, the UE may determine that the second subset of CMRs 410 (e.g., associated with the second TRP and including CMRs 410 from the second CMR group 405-b) includes the CMR 410-f based on the CMR 410-f being distinct from the CMRs 410 in the CMR group 405-f associated with CMR pairs 415 (e.g., CMR 410-d and CMR 410-e).

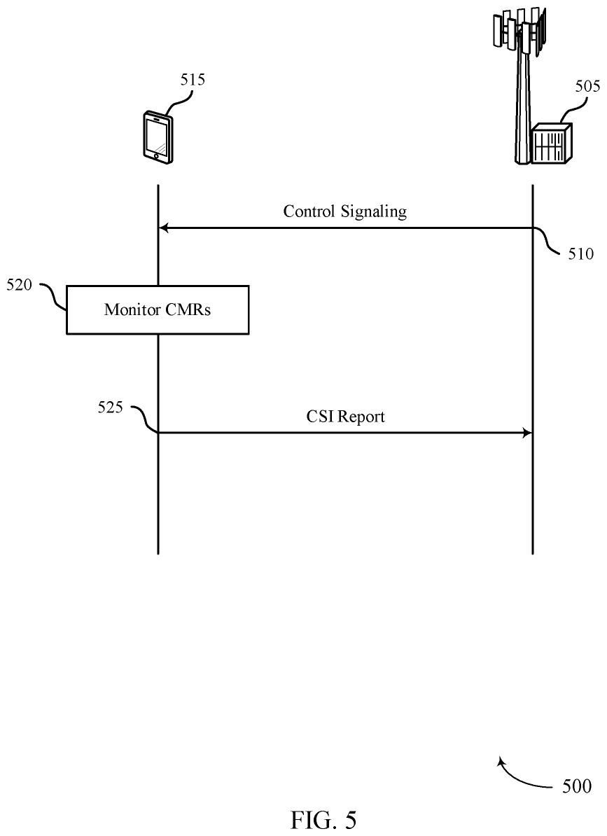

FIG. 5 illustrates an example of a process flow 500 that supports CSI reporting with single and joint TRP measurements in accordance with aspects of the present disclosure. In some examples, the process flow 500 may implement aspects of FIGS. 1 through 4. For example, the process flow 500 may include base station 505 (e.g., associated with a first TRP and a second TRP) and UE 515, which may be examples of a base station and a UE as described with reference to FIGS. 1 through 4.

At 510, the base station 505 may transmit control signaling to the UE 515. That is, the UE 515 may receive control signaling indicating a first subset of CMRs in a first CMR group for single TRP channel measurement associated with a first TRP, a second subset of CMRs in a second CMR group for single TRP channel measurement associated with a second TRP, and one or more CMR pairs including CMRs from each of the first CMR group and the second CMR group for joint TRP channel measurement.

At 520, the UE 515 may monitor CMRs based on the control signaling received from the base station 505 at 510. That is, the UE 515 may monitor the first subset of CMRs, the second subset of CMRs, and the one or more CMR pairs to generate a set of measurements.

At 525, the UE 515 may transmit a CSI report to the base station 505. That is, the UE 515 may transmit a CSI report including a number of bits indicating one or more CRIs associated with at least one of the set of measurements, where the number of bits is based on a number of the CMR pairs. In some examples, the number of bits may be based on a number of the one or more CRIs, a first number of CMRs in the first subset, a second number of CMRs in the second subset, and the number of the CMR pairs. Additionally, the number of CRIs within the CSI report associated with one of the first TRP or the second TRP may be zero, one, or two.

In some cases, the number of bits in the CSI report may indicate a single CRI, where the number of bits based on the number of the CMR pairs. In some other cases, the number of bits in the CSI report may indicate a set of CRIs, the number of bits corresponding to a first number of bits in a first CRI of the set of CRIs that is based on the number of the CMR pairs and a second number of bits in a second CRI of the set of CRIs that is based on a sum of a first number of CMRs in the first subset and a second number of CMRs in the second subset.

In some other cases, the number of bits in the CSI report may indicate a set of CRIs, the number of bits corresponding to a first number of bits in a first CRI of the set of CRIs that is based on the number of the CMR pairs, a second number of bits in a second CRI of the set of CRIs that is based on a first number of CMRs in the first subset, and a third number of bits in a third CRI of the set of CRIs that is based on a second number of CMRs in the second subset. In some other cases, the number of bits in the CSI report may indicate a single CRI, the number of bits based on a sum of a first number of CMRs in the first subset, a second number of CMRs in the second subset, and the number of the CMR pairs.

In some examples, the first subset may include a first number of unshared CMRs in the first CMR group and the second subset includes a second number of unshared CMRs in the second CMR group, where the unshared CMRs are CMRs distinct from CMRs within the one or more CMR pairs. Here, the number of bits in the CSI report may indicate a set of CRIs based on the control signaling indicating that CMR sharing is disabled between single TRP channel measurement and joint TRP channel measurement, where the number of bits corresponds to a first number of bits in a first CRI of the set of CRIs that is based on the number of the CMR pairs, and a second number of bits in a second CRI of the set of CRIs that is based on the first number of unshared CMRs in the first subset and the second number of unshared CMRs in the second subset.

In some examples, the first subset may include a first number of unshared CMRs in the first CMR group and the second subset includes a second number of unshared CMRs in the second CMR group, where the unshared CMRs are CMRs distinct from CMRs within the one or more CMR pairs. Here, the number of bits in the CSI report may indicate a set of CRIs based on the control signaling indicating that CMR sharing is disabled between single TRP channel measurement and joint TRP channel measurement, where the number of bits corresponds to a first number of bits in a first CRI of the set of CRIs that is based on the number of the CMR pairs, a second number of bits in a second CRI of the set of CRIs that is based on the first number of unshared CMRs in the first subset, and a third number of bits in a third CRI of the set of CRIs that is based on the second number of unshared CMRs in the second subset.

In some examples, the first subset may include a first number of unshared CMRs in the first CMR group and the second subset includes a second number of unshared CMRs in the second CMR group, where the unshared CMRs are CMRs distinct from CMRs within the one or more CMR pairs. Here, the number of bits in the CSI report may indicate a single CRI based on the control signaling indicating that CMR sharing is disabled between single TRP channel measurement and joint TRP channel measurement, where the number of bits is based on a sum of the first number of unshared CMRs in the first subset, the second number of unshared CMRs in the second subset, and the number of the CMR pairs.

In some cases, the number of bits in the CSI report may indicate a set of CRIs, where the number of bits corresponds to a first number of bits in a first CRI of the set of CRIs that is based on the number of the CMR pairs and a second number of bits in a second CRI of the set of CRIs that is based on a sum of a first number of CMRs in the first subset for single TRP channel measurement and a second number of CMRs in the second subset for single TRP channel measurement. Further, the first number of CMRs may be based on a difference between a third number of CMRs in the first CMR group and the number of the CMR pairs. Additionally, the second number of CMRs may be based on a difference between a fourth number of CMRs in the second CMR group and the number of the CMR pairs.

In some cases, the number of bits in the CSI report may indicate indicating a set of CRIs, where the number of bits corresponds to a first number of bits in a first CRI of the set of CRIs that is based on the number of the CMR pairs, a second number of bits in a second CRI of the set of CRIs that is based on a first number of CMRs in the first subset for single TRP channel measurement, and a third number of bits in a third CRI of the set of CRIs that is based on a second number of CMRs in the second subset for single TRP channel measurement, where the first number of CMRs is based on a difference between a third number of CMRs in the first CMR group and the number of the CMR pairs, and where the second number of CMRs is based on a difference between a fourth number of CMRs in the second CMR group and the number of the CMR pairs.

In some examples, the number of bits in the CSI report may indicate a single CRI, where the number of bits is based on a sum of a first number of CMRs in the first subset for single TRP channel measurement, a second number of CMRs in the second subset for single TRP channel measurement, and the number of the CMR pairs. Here, the first number of CMRs may be based on a difference between a third number of CMRs in the first CMR group and the number of the CMR pairs, and the second number of CMRs may be based on a difference between a fourth number of CMRs in the second CMR group and the number of the CMR pairs.

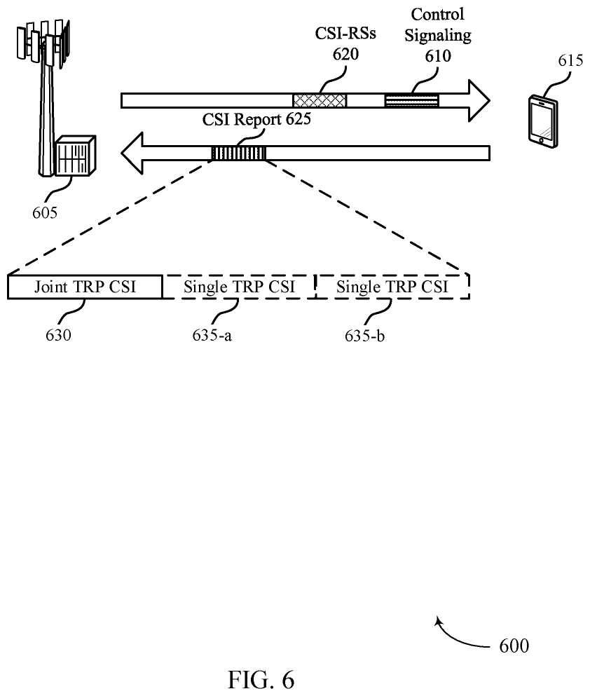

FIG. 6 illustrates an example of a wireless communications system 600 that supports CSI reporting with single and joint TRP measurements in accordance with aspects of the present disclosure. In some examples, the wireless communications system 600 may implement aspects of wireless communications system 100. For example, the wireless communications system 600 may include base station and UE 615, which may be examples of a base station 105 and a UE 115, respectively, as described with reference to FIG. 1.

The UE 615 may be in communication with the base station 605. For example, the UE 615 and base station 605 may exchange messages (e.g., the CSI report 625, the CSI-RSs 620) and signaling (e.g., the control signaling 610). In some cases, the base station 605 may include or be associated with more than one TRP. For example, the base station 605 may rely on multiple TRPs (e.g., two) for communications with the UE 615. The base station 605 may transmit the control signaling 610 to the UE 615, which may configure the UE 615 for subsequent communications with the base station 605. For example, the control signaling 610 may indicate, to the UE 615, CMRs associated with more than one of the TRPs for the UE 615 to monitor to generate the CSI report 625. That is, the base station 605 may transmit control signaling 610 indicating for the UE 615 to monitor a first subset of CMRs (e.g., associated with a first TRP of the base station 605), a second subset of CMRs (e.g., associated with a second TRP of the base station 605), and one or more pairs of CMRs (e.g., including a first CMR associated with the first TRP and a second CMR associated with the second TRP). That is, the base station 605 may indicate for the UE 615 to monitor N CMR pairs. Thus, the UE 615 may generate a CSI report 625 based on monitoring CMRs associated with single TRPs (e.g., CMRs within the first and second subsets) and based on monitoring CMRs associated with joint TRPs (e.g., the CMR pairs).

The control signaling 610 may additionally indicate a configuration for the CSI report 625. In one case, the control signaling 610 may indicate a quantity CSIs (e.g., joint TRP CSIs 630, single TRP CSIs 635). In one example, the control signaling 610 may indicate for the UE 615 to include a single CSI in the CSI report 625. Here, the UE 615 may transmit the CSI report 625 including the joint TRP CSI 630 (e.g., and not including the single TRP CSIs 635). In the case that the UE 615 transmits the single joint TRP CSI 630, the UE 615 may include CSI related to one of the pairs of CMRs (e.g., indicated for the UE 615 to monitor) having a higher measured signal quality than the remaining pairs of CMRs. In another case, the control signaling 610 may indicate for the UE 615 to include more than on CSI in the CSI report 625. For example, the control signaling 610 may indicate for the UE 615 to include the one joint TRP CSI 630 and two single TRP CSIs 635. Here, the joint TRP CSI 630 may correspond to the CMR pair having the highest measured signal quality of each of the CMR pairs monitored by the UE 615. Additionally, the single TRP CSIs 635 may include CSI associated with single CMRs from one of the CMR pairs the UE 615 monitors.

The control signaling 610 may additionally indicate for the UE 615 to share PMIs and RIs between the joint TRP CSI 630 and the single TRP CSIs 635. For example, the base station 605 may enable (or, in other cases, disable) the sharing of PMIs and RIs between the joint TRP CSI 630 and the single TRP CSIs 635 via a higher-layer configuration. Additionally or alternatively, the base station 605 may dynamically indicate that the sharing of PMIs and RIs is enabled (or, in other cases, disabled).

In a Case 1, the base station 605 may configure the UE to report a joint TRP CSI 630 (e.g., an NCJT CSI) and X single TRP CSIs 635 and may additionally set X to 0. In this case 1 (e.g., when the base station 605 has configured the UE 615 to include a single CSI in the CSI report 625, the joint TRP CSI 630) and when the sharing of PMIs and RIs between the joint TRP CSI 630 and the single TRP CSIs 635, the joint TRP CSI 630 may include two RIs (e.g., each corresponding to one of the CMRs in the CMR pair associated with the joint TRP CSI 630), two PMIs (e.g., each corresponding to one of the CMRs in the CMR pair associated with the joint TRP CSI 630, and a CQI associated with the CMR pair. The joint TRP CSI 630 may additionally include CQIs associated with each CMR in the CMR pair (e.g., and associated with single TRP CSI). That is, the UE 615 may calculate a first CQI associated with a first CMR of the CMR pair (e.g., associated with the first TRP) using a first of the two RIs in the joint TRP CSI 630 (e.g., corresponding to the first CMR) and using a first of the two PMIs in the joint TRP CSI 630 (e.g., corresponding to the first CMR) since the first PMI and RI of the joint TRP CSI 630 are shared with the first CMR (e.g., and not the second CMR of the CMR pair). Additionally, the UE 615 may calculate a second CQI associated with the second CMR of the CMR pair (e.g., associated with the second TRP) using a second of the two RIs in the joint TRP CSI 630 (e.g., corresponding to the second CMR) and using a second of the two PMIs in the joint TRP CSI 630 (e.g., corresponding to the second CMR).

In a Case 2, the base station 605 may configure the UE to report a joint TRP CSI 630 (e.g., an NCJT CSI) and X single TRP CSIs 635 and may additionally set X to 2. In this case 2 (e.g., when the base station 605 has configured the UE 615 to include a single CSI in the CSI report 625, the joint TRP CSI 630, and both single TRP CSIs 635) and when the base station 605 enables the sharing of PMIs and RIs between the joint TRP CSI 630 and the single TRP CSIs 635, the joint TRP CSI 630 may include two RIs (e.g., each corresponding to one of the CMRs in the CMR pair associated with the joint TRP CSI 630), two PMIs (e.g., each corresponding to one of the CMRs in the CMR pair associated with the joint TRP CSI 630, and a CQI associated with the CMR pair. In an example where each of the single TRP CSIs 635 are associated with one of the CMRs from the CMR pair (e.g., corresponding to the joint TRP CSI 630), the single TRP CSI 635-a associated with a first CMR of the CMR pair may include a first RI of the two RIs included in the joint TRP CSI 630 (e.g., corresponding to the first CMR) and a CQI associated with the first CMR. Additionally, the single TRP CSI 635-b associated with a second CMR of the CMR pair may include a second RI of the two RIs included in the joint TRP CSI 630 (e.g., corresponding to the second CMR) and a CQI associated with the second CMR. Here, the single TRP CSIs 635 may not include PMIs as each of the CQIs within the single TRP CSIs 635 are calculated assuming the PMI and RI as reported in the joint TRP CSI 630 (e.g., as reported in the NCJT CSI). In other examples where each of the single TRP CSIs 635 are associated with CMRs that are distinct from the CMR pair associated with the joint TRP CSI 630, the single TRP CSIs 635 may each include an RI, a PMI, and a CQI associated with the corresponding CMR.

The control signaling 610 may additionally indicate, to the UE 615, a configuration for calculating a CQI associated with one CMR (e.g., for single TRP CSI 635) of a CMR pair (e.g., associated with the joint TRP CSI 630) using a same PMI and RI as used for the joint TRP CSI 630. In one example, the base station 605 may transmit control signaling 610 indicating a configuration for the UE 615, when calculating the CQI associated with the one CMR of the pair, to ignore the other CMR (e.g., of the pair). That is, the UE 615 may ignore (e.g., not consider) the other CMR of the CMR pair when calculating the CQI associated with the one CMR of the pair. In another example, the base station 605 may transmit control signaling 610 indicating a configuration for the UE 615, when calculating the CQI associated with the one CMR of the pair, to use the other CMR as an interference measurement. That is, the UE 615 may use the other CMR as a non-zero-power interference management resource (NZP-IMR) for calculating the CQI associated with the one CMR. In one case, the configuration may indicate for the UE 615 to not assume the other PMI and RI for interference measurements (e.g., associated with the other CMR from the CMR pair) when calculating the CQI associated with the one CMR from the pair. Here, the UE 615 may assume each port of the other CMR to be one interference layer. In another case, the configuration may indicate for the UE 615 to apply the other PMI and RI (e.g., associated with the other CMR from the CMR pair) when calculating the CQI associated with the one CMR from the pair. Here, the UE 615 may apply the other PMI and RI to the second CMR for determining the interference. For example, the UE 615 may calculate a first CQI associated with a first CMR from the pair based on interference associated with a second CMR. Additionally, the UE 615 may calculate a second CQI associated with the second CMR from the pair based on interference associated with the first CMR (e.g., the role of the first and second CMR, PMI, and RI may be reversed).

Prior to generating the CSI report 625, the UE 615 may determine the number of occupied CPUs, active CSI-RS resources, and active occupied CSI-RS ports associated with the configured CSI report 625. That is, the UE 615 may support a threshold number of occupied CPUs, active CSI-RS resources, and active occupied CSI-RS ports for CSI (e.g., that is based on a capability of the UE 615). Additionally, the UE 615 may refrain from updating remaining CSIs in cases that a total number of active CSI-RS resources exceeds a defined number of active CSI-RS resources supported by the UE 615 or a total number of active CSI-RS port occupation associated with the CSI report exceeds a defined number of active CSI-RS port occupation supported by the UE 615. Thus, the UE 615 may determine the number of occupied CPUs, active CSI-RS resources, and active occupied CSI-RS ports associated with the configured CSI report 625 prior to generating the CSI report (e.g., to ensure the number of occupied CPUs, active CSI-RS resources, and active occupied CSI-RS ports associated with the CSI report 625 does not exceed the defined number associated with the capability of the UE 615).

When the UE 615 is configured with PMI and RI sharing between NCJT CSI (e.g., the joint TRP CSI 630) and single TRP CSIs 635 and the UE 615 is configured to include a single CSI within the CSI report 625 (e.g., the joint TRP CSI 630 associated with a CMR pair and including CQIs for each of the individual CMRs within the CMR pair), the UE 615 may determine the number of occupied CPUs, active CSI-RS resources, and active occupied CSI-RS ports associated with the configured CSI report 625 based on the number of CMR pairs that the UE 615 is configured to monitor (e.g., the N CMR pairs configured by the control signaling 610) and the number of ports each CMR has (e.g., P ports). In one example as illustrated in Equation 8, the UE 615 may determine the number of occupied CPUs (CPU_{occupied}), the active CSI-RS resources (R_{Active}), and the active occupied CSI-RS ports (P_{Active}) associated with the CSI report 625 based on counting each of the individual CMRs of the CMR pairs additionally. That is, the UE 615 may determine two additional CQIs and report the CSI for one of the hypotheses for each NCJT hypothesis.

$$C P {U}_{Occupied} = 2 N + 2 N ; {R}_{Active} = 2 N + 2 N ; {P}_{Active} = P * ( 2 N + 2 N ) \qquad ( 8 )$$

In another example as illustrated below in Equation 9, the UE 615 may determine the number of occupied CPUs (CPU occupied), the active CSI-RS resources (R_{Active}), and the active occupied CSI-RS ports (P_{Active}) associated with the CSI report 625 based on selecting one NCJT CSI hypotheses (e.g., from the N CMR pairs), and count the individual CMRs of the selected CMR pair (e.g., instead of additionally counting the individual CMRs of unselected CMR pairs).

$$C P {U}_{Occupied} = 2 N + 2 ; {R}_{Active} = 2 N + 2 ; {P}_{Active} = P * ( 2 N + 2 ) \qquad ( 9 )$$

In another example as illustrated below in Equation 10, the UE 615 may determine the number of occupied CPUs (CPU_{occupied}), the active CSI-RS resources (R_{Active}), and the active occupied CSI-RS ports (P_{Active}) associated with the CSI report 625 based on constants (e.g., indicated to the base station 605 by the UE 615 (e.g., Y₁ and Y₂) within UE capability signaling to the base station 605 prior to receiving the control signaling 610).

$$C P {U}_{Occupied} = 2 N + {Y}_{1} ; {R}_{Active} = 2 N + {Y}_{2} ; {P}_{Active} = P * ( 2 N + {Y}_{2} ) \qquad ( 10 )$$

In another example as illustrated below in Equation 11, the UE 615 may determine the number of occupied CPUs (CPU_{occupied}), the active CSI-RS resources (R_{Active}), and the active occupied CSI-RS ports (P_{Active}) associated with the CSI report 625 similarly to cases where PMI and RI sharing is not enabled. The UE 615 may additionally determine a computational complexity of the two additional CQIs (e.g., associated with the single TRP CQIs) based on a threshold for additional single-TRP CQI calculations.

$$C P {U}_{Occupied} = 2 N ; {R}_{Active} = 2 N ; {P}_{Active} = P * 2 N \qquad ( 11 )$$

In some cases, the UE 615 may determine that the number of occupied CPUs associated with CSI report 625 is the same as cases where no PMI or RIs are shared (e.g., as illustrated with respect to Equation 11). Here, the UE 615 may determine an increased number of active resources or ports (e.g., when compared to Equation 11). That is, CPUs may be related to a complexity of PMI calculation, but in some cases for calculating additional single TRP CQIs, the UE 615 may not calculate another PMI (e.g., due to PMI sharing).

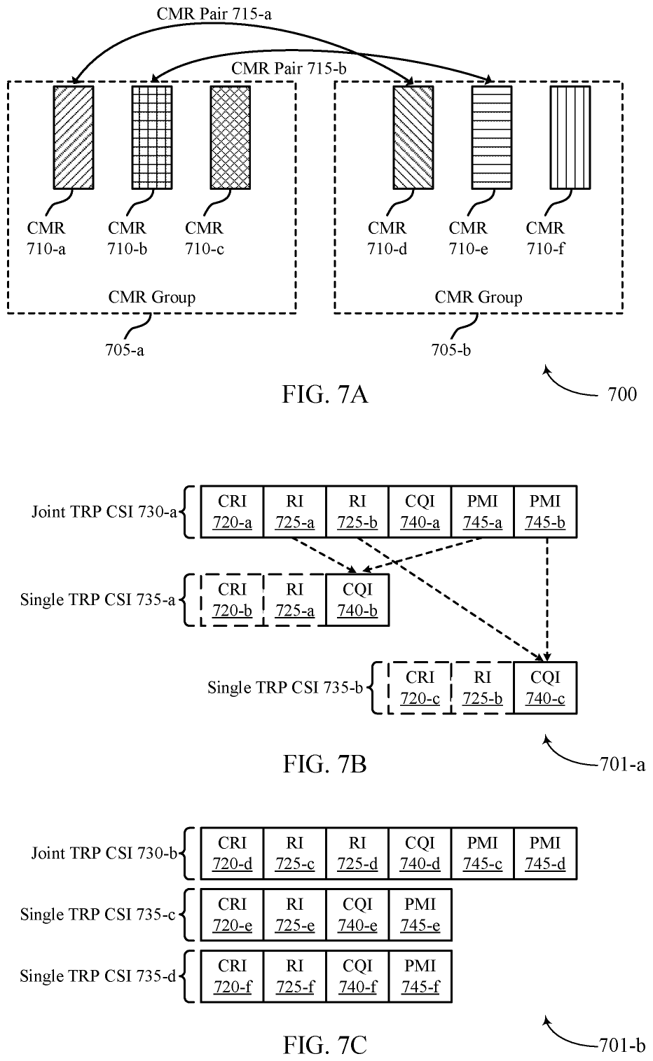

FIG. 7A illustrates an example of a CMR configuration 700 that supports CSI reporting with single and joint TRP measurements in accordance with aspects of the present disclosure. Additionally, FIGS. 7B and 7C illustrate example CSI reports 701 that support CSI reporting with single and joint TRP measurements in accordance with aspects of the present disclosure. In some cases, the CMR configuration 700 may be an example of a CMR configuration indicated to a UE by a base station (e.g., via control signaling) as described with reference to FIGS. 1, 2, and 6. Additionally, the CSI reports 701 may be examples of CSI reports transmitted by the UE to the base station as described with reference to FIGS. 1, 2, and 6. In some cases, a UE may be configured with the CMR configuration 700, may monitor resources for CSI-RSs based on the CMR configuration 700, and may transmit a CSI report 701 (e.g., to a base station) based on monitoring resources associated with the CMR configuration 700.

FIG. 7A illustrates the CMR configuration 700, including the CMR group 705-a and the CMR group 705-b. In some cases, the CMR group 705-a may be a set of CMRs 710 associated with a first TRP (e.g., associated with the base station). That is, the base station may transmit reference signals (e.g., CSI-RSs, CRSs) via one of the CMRs 710 in the CMR group 705-a using a first TRP. Additionally, the CMR group 705-b may be a set of CMRs 710 associated with a second TRP (e.g., associated with the base station). Here, the base station may transmit reference signals via one of the CMRs 710 in the CMR group 705-b using a second TRP. In some cases, the base station may indicate the CMR groups 705 to the UE via control signaling (e.g., RRC signaling).

The base station may indicate (e.g., by control signaling) a subset of the CMRs 710 within the CMR group 705-a for the UE to monitor for single TRP CSI reporting associated with the first TRP, a subset of the CMRs 710 within the CMR group 705-b for the UE to monitor for single TRP CSI reporting associated with the second TRP, and one or more CMR pairs 715-a for the UE to monitor for joint TRP CSI reporting. The base station may additionally indicate for the UE to share PMIs and RIs between CMR pairs 715 and each individual CMR 710 within the CMR pair 715. For example, the UE may calculate a first PMI and RI associated with the CMR 710-a and a second PMI and RI associated with the CMR 710-d to calculate CSI for the CMR pair 715-a. Here, the UE may determine CQI associated with the CMR 710-a using the first PMI and RI (e.g., calculated for CSI associated with the CMR pair 715-a) and CQI associated with the CMR 710-d using the second PMI and RI.

FIG. 7B illustrates an example CSI report 701-a. The UE may generate the CSI report 701-a in response to monitoring the CMRs 710 in accordance with the CMR configuration 700 configured by the base station.

In the Case 1, where the base station configures the UE to report a single NCJT CSI (e.g., the joint TRP CSI 730-a) and X single TRP CSIs 735 and sets X to 0 (e.g., the UE is configured to report a single joint TRP CSI 730-a), the UE may include the joint TRP CSI 730-a, the CQI 740-b, and the CQI 740-c in the CSI report 701-a. Here, the UE may determine the RI 725-a and PMI 745-a (e.g., associated with a first TRP) and the RI 725-b and PMI 745-b (e.g., associated with the second TRP) for the NCJT CSI (e.g., the joint TRP CSI 730-a). The UE may then determine the CQI 740-a that is associated with the NCJT CSI using the RI 725-a and the PMI 745-a. Additionally the UE may determine the CQI 740-b (e.g., associated with the second TRP) using the RI 725-b and the PMI 745-b.

In one example of Case 1, the joint TRP CSI 730-a may be associated with the CMR pair 715-b (e.g., including the CMR 710-b associated with the first TRP and the CMR 710-e associated with the second TRP). Here, the UE may determine RI 725-a and the PMI 745-a based on the CMR 710-b and the RI 725-b and PMI 745-b based on the CMR 710-e. Additionally the UE may determine the CQI 740-a associated with the CMR pair 715-b using the RIs 725-a and 725-b and the PMIs 745-a and 745-b. The UE may additionally determine the CQI 740-b associated with the CMR 710-b using the RI 725-a and the PMI 745-a (e.g., based on sharing being enabled) and the CQI 740-c associated with the CMR 710-e using the RI 725-b and the PMI 745-b. Here, the UE may include the CRI 720-a (e.g., indicating the CMR pair 715-b), the RIs 725, and the CQI 740-a in part 1 of the CSI report 701-a, and the UE may include the PMIs 745 in CSI part 2 of the CSI report 701-a. Additionally, the UE may include the CQI 740-b and the CQI 740-c in the CSI report 701-a (e.g., either as part of CSI part 1 or CSI part 2). In some examples, PMI may be reported in CSI part 2 (whether it belongs to NCJT or sTRP CSI). CSI part 1 may include the fields that are used to decode CSI part 2 by the base station. CRI, RI, and CQI are in CSI part 1 while PMI and LI (layer indicator) are in CSI part 2, and CSI part 1 and CSI part 2 may separately encoded (e.g., not jointly encoded).” If CQI 740-b and the CQI 740-c are in the CSI part 1, they are jointly encoded with the CRI 720-a, the RIs 725, and the CQI 740-a. If CQI 740-b and the CQI 740-c are in the CSI part 1, they are jointly encoded with the PMIs 745.

In the Case 2, where the base station configures the UE to report a single NCJT CSI (e.g., the joint TRP CSI 730-a) and X single TRP CSIs 735 and sets X to 2 and the base station is configured with PMI 745 and RI 725 sharing (e.g., between NCJT CSI and single TRP CSI 735), the UE may include the joint TRP CSI 730-a, the single TRP CSI 735-a, and the single TRP CSI 735-b in the CSI report 701-a. The CSI report 701-a may correspond to a CSI report 701-a where the CMR pair 715 associated with the joint TRP CSI 730-a includes a first CMR 710 associated with the first single TRP CSI 735-a and a second CMR 710 associated with the second single TRP CSI 735-b. That is, in the example of the CSI report 701-a, the selected CMR 710 of the first sTRP CSI (e.g., as indicated by the CRI 720-b in the single TRP CSI 735-a) and the selected CMR 710 of the second sTRP CSI (e.g., as indicated by the CRI 720-c in the single TRP CSI 735-b) are the same as the selected CMR pair 715 (e.g., as indicated by the CRI 720-a in the joint TRP CSI 730-a). In this example, the UE may omit the CSI part 2 (e.g., at least the portion of the CSI part 2 including PMI) from the single TRP CSIs 735. Here, the UE may include the same RI 725-a for the first single TRP CSI 735-a as the first RI 725-a of the joint TRP CSI 730-a. In some cases, the UE may not include LIs within the single TRP CSIs 735 (and may include them in the joint TRP CSI 730-a). Additionally or alternatively, the UE may include a same value for the LI in each of the single TRP CSIs 735 as reported in the joint TRP CSI 730-a. Additionally, the UE may include the same RI 725-b for the second single TRP CSI 735-b as the second RI 725-b of the joint TRP CSI 730-a. In some cases, the UE may report the RIs 725 in the single TRP CSIs 735 (e.g., instead of omitting the RIs 725 from the single TRP CSIs 735) as the CSI part 1 of the CSI report 701-a may be constant and not dependent on the value of the CRI 720.

FIG. 7C illustrates an example CSI report 701-b. The UE may generate the CSI report 701-a in response to monitoring the CMRs 710 in accordance with the CMR configuration 700 configured by the base station. CSI report 701-b may be an example CSI report 701-b associated with the Case 2, where the base station configures the UE to report a single NCJT CSI (e.g., the joint TRP CSI 730-b) and X single TRP CSIs 735 and sets X to 2 and the base station is configured with PMI 745 and RI 725 sharing (e.g., between NCJT CSI and single TRP CSI 735). Thus, the CSI report 701-b may include the joint TRP CSI 730-b, the single TRP CSI 735-c, and the single TRP CSI 735-d in the CSI report 701-b.

The CSI report 701-b may correspond to a CSI report 701-a where the CMR pair 715 associated with the joint TRP CSI 730-a includes a first CMR 710 distinct from the CMR 710 associated with the first single TRP CSI 735-c and a second CMR 710 distinct from the CMR 710 associated with the second single TRP CSI 735-d. For example, the joint TRP CSI 730-b may correspond to the CMR pair 715-a and the single TRP CSI 735-c may be associated with the CMR 710-c and the single TRP CSI 735-d may correspond to the CMR 710-f. Here, the PMIs 745 and the RIs 725 may not be shared between the NCJT CSI (e.g., the joint TRP CSI 730-b) and the single TRP CSIs 735. Thus, each of the single TRP CSIs 735 include PMIs 745 (as they are distinct from the PMIs 745- and 745-d within the joint TRP CSI 730-b).

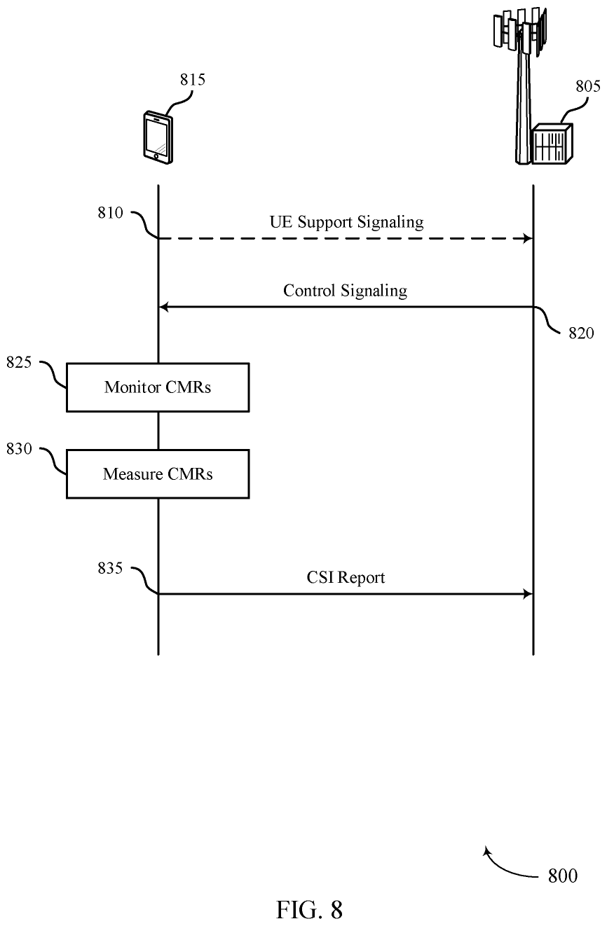

FIG. 8 illustrates an example of a process flow 800 that supports CSI reporting with single and joint TRP measurements in accordance with aspects of the present disclosure. For example, the process flow 800 may include base station 805 (e.g., associated with a first TRP and a second TRP) and UE 815, which may be examples of a base station and a UE as described with reference to FIGS. 1 through 7.

At 810, the UE 815 may optionally transmit signaling to the base station 805 indicating a defined (e.g., threshold) number of CPUs supported by the UE 815, a defined number of active CSI-RS resources supported by the UE 815, and a defined number of active CSI-RS ports supported by the UE 815.

At 815, the base station 805 may transmit control signaling to the UE 815. That is, the UE 815 may receive control signaling indicating a pair of CMRs and that a first PMI, a second PMI, a first RI, and a second RI of joint TRP CSI calculated for the pair of CMRs is to be shared for generating a respective CQI for each CMR of the pair of CMRs. Additionally, the base station 805 may transmit second control signaling indicating a configuration for calculating the second CQI and the third CQI.

At 820, the UE 815 may monitor the CMRs to generate the joint TRP CSI including the first PMI, the second PMI, the first RI, the second RI, and a first CQI.

At 830, the UE 815 may measure the first CMR independently of the second CMR to generate the second CQI in accordance with the configuration (e.g., indicated by the second control signaling) and measure the second CMR independently of the first CMR to generate the third CQI in accordance with the configuration. Additionally or alternatively, the UE 815 may measure the first CMR and a first interference signal received via the second CMR to generate the second CQI in accordance with the configuration and measure the second CMR and a second interference signal received via the first CMR to generate the third CQI in accordance with the configuration. Here, the UE 815 may apply the second PMI and the second RI to a first signal received via the second CMR to measure an interference level caused by the first interference signal. Additionally, the UE 815 may apply the first PMI and the first RI to a second signal received via the first CMR to measure an interference level caused by the second interference signal.

At 835, the UE 815 may transmit a CSI report to the base station 805 including the joint TRP CSI, a second CQI of a first CMR of the pair of CMRs calculated using the first PMI and the first RI, and a third CQI of a second CMR of the pair of CMRs calculated using the second PMI and the second RI. In some cases, the UE 815 may transmit the CSI report to the base station 805 based on a number of CPUs associated with the CSI report being less than or equal to the defined number of CPUs supported by the UE 815, using a number of active CSI-RS resources associated with the CSI report that is less than or equal to the defined number of active CSI-RS resources supported by the UE, and using a number of active CSI-RS ports associated with the CSI report that is than or equal to the defined number of active CSI-RS ports supported by the UE 815. The UE 815 may determine the number of CPUs, active CSI-RS resources, and active CSI-RS ports associated with the CSI report based on one of Equations 8 through 11.

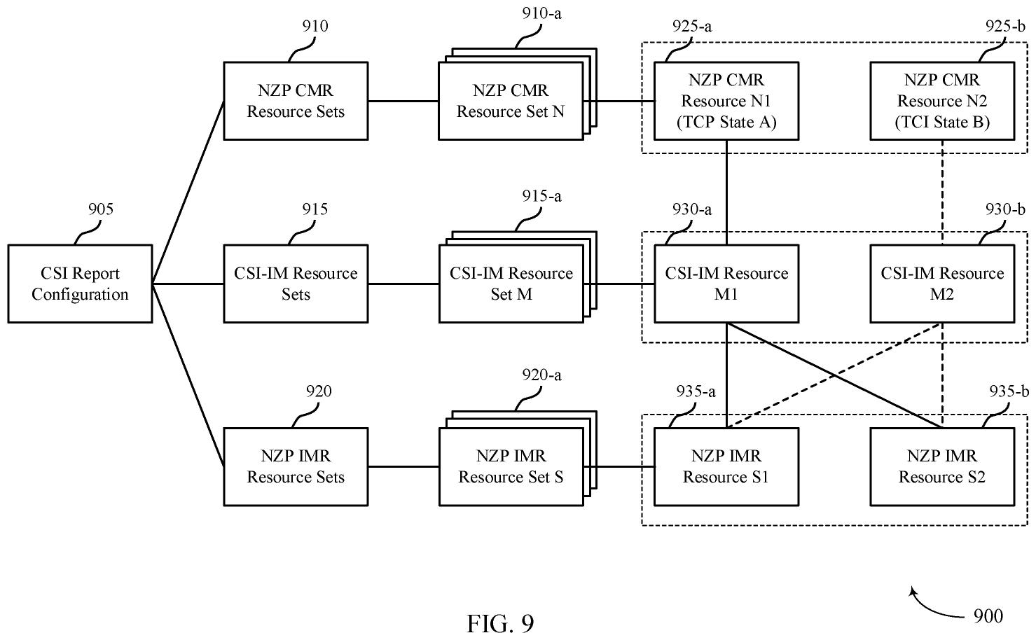

FIG. 9 illustrates an example of a CSI scheme 900 that supports CSI reporting with single and joint TRP measurements in accordance with aspects of the present disclosure. In some cases, the UEs and base stations described herein may utilize one or more aspects of the CSI scheme 900.

The CSI scheme may include CSI report configuration 905, which a base station may indicate to a UE via control signaling. The CSI report configuration 905 may indicate NZP CMR resource sets 910, CSI-IM resource sets 915, and NZP IMR resource sets 920. In some cases, the framework for the CSI report configuration 905 may include a link to one resource setting (e.g., a CMR), a link to two resource settings (e.g., a CMR and CSI-IM or NZP-IMR), or a link to three resource settings (e.g., a CMR, a CSI-IM, and an NZP-IMR). Here, each resource set (e.g., the NZP CMR resource sets 910, the CSI-IM resource sets 915, the NZP IMR resource sets 920) may have one active resource set. For example, the NZP CMR resource sets 910 may include the active NZP CMR resource set N 910-a. Additionally, the CSI-IM resource set 915 may include the active CSI-IM resource set M 915-a. Additionally, the NZP IMR resource sets 920 may include the active NZP IMR resource set S 920-a.

The UE may evaluate CSI corresponding to the NZP CMR resource set N 910-a. The UE may then select one CMR resource from the NZP CMR resource set N 910-a (e.g., NZP CMR resource N1 925-a, NZP CMR resource N2 925-b). In some cases, the UE may additionally select CSI-IM resources 930 (e.g., CSI-IM resource M1 930-a, CSI-IM resource M2 930-b). Additionally or alternatively, the UE may select NZP IMR resources 935 (e.g., NZP IMR resource S1 935-a, NZP IMR resource S2 935-b). In some cases, each CMR resource may be associated with all NZP IMR resources 935 collectively. The UE may report CRI as part of CSI feedback. That is, the base station may rely on the CRI to determine the NZP CMR resource 925 associated with the CSI report.

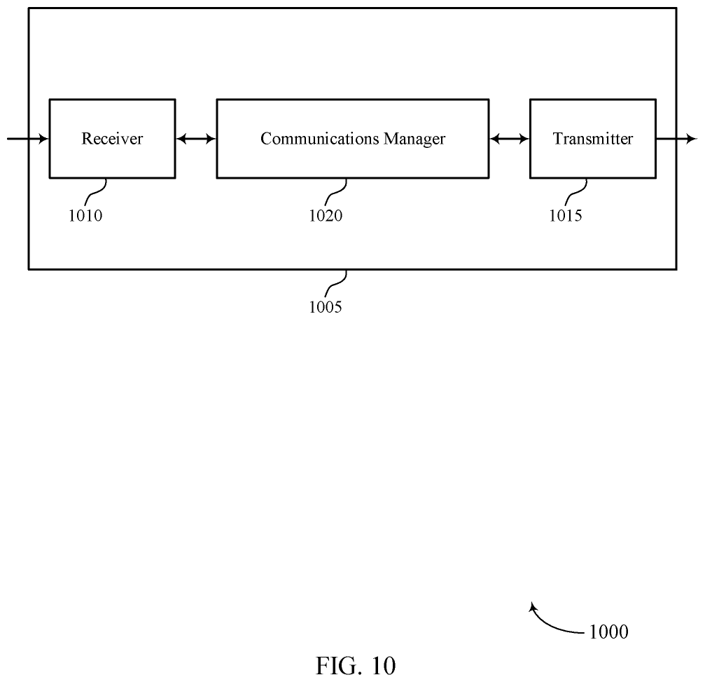

FIG. 10 shows a block diagram 1000 of a device 1005 that supports CSI reporting with single and joint TRP measurements in accordance with aspects of the present disclosure. The device 1005 may be an example of aspects of a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to CSI reporting with single and joint TRP measurements). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to CSI reporting with single and joint TRP measurements). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of CSI reporting with single and joint TRP measurements as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a central processing unit, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a UE in accordance with examples as disclosed herein. For example, the communications manager 1020 may be configured as or otherwise support a means for receiving control signaling indicating a first subset of CMRs in a first CMR group for single TRP channel measurement associated with a first TRP, a second subset of CMRs in a second CMR group for single TRP channel measurement associated with a second TRP, and one or more CMR pairs including CMRs from each of the first CMR group and the second CMR group for joint TRP channel measurement. The communications manager 1020 may be configured as or otherwise support a means for monitoring the first subset of CMRs, the second subset of CMRs, and the one or more CMR pairs to generate a set of multiple measurements. The communications manager 1020 may be configured as or otherwise support a means for transmitting a CSI report including a number of bits indicating one or more channel resource indicators associated with at least one of the set of multiple measurements, where the number of bits is based on a number of the CMR pairs.

Additionally or alternatively, the communications manager 1020 may support wireless communication at a UE in accordance with examples as disclosed herein. For example, the communications manager 1020 may be configured as or otherwise support a means for receiving control signaling indicating a pair of CMRs and that a first PMI, a second PMI, a first RI, and a second RI of joint TRP CSI calculated for the pair of CMRs is to be shared for generating a respective CQI for each CMR of the pair of CMRs. The communications manager 1020 may be configured as or otherwise support a means for monitoring the pair of CMRs to generate the joint TRP CSI including the first PMI, the second PMI, the first RI, the second RI, and a first CQI. The communications manager 1020 may be configured as or otherwise support a means for transmitting a CSI report including the joint TRP CSI, a second CQI of a first CMR of the pair of CMRs calculated using the first PMI and the first RI, and a third CQI of a second CMR of the pair of CMRs calculated using the second PMI and the second RI.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for reduced processing and more efficient utilization of communication resources.

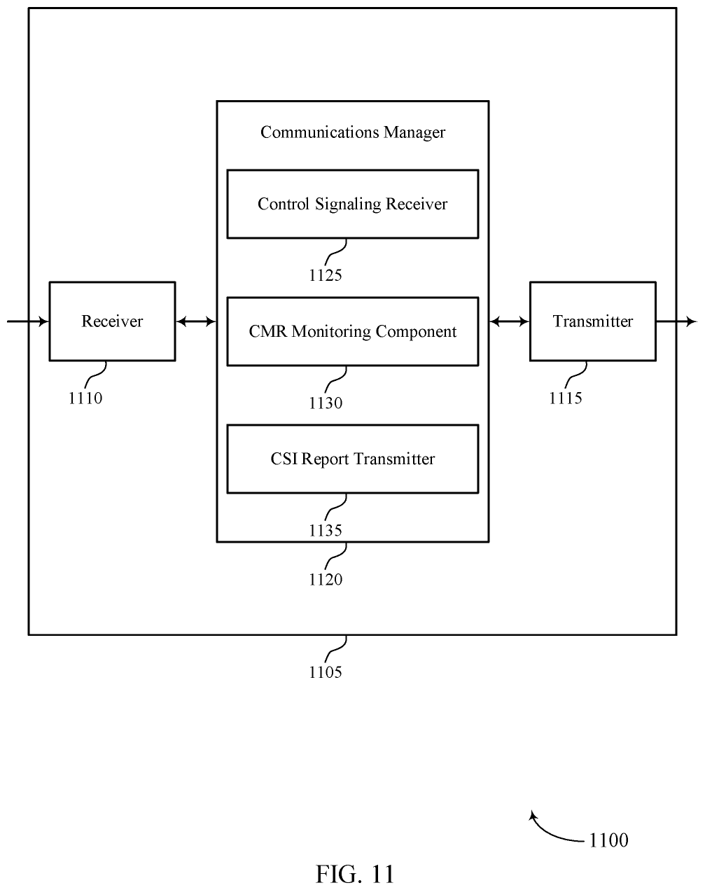

FIG. 11 shows a block diagram 1100 of a device 1105 that supports CSI reporting with single and joint TRP measurements in accordance with aspects of the present disclosure. The device 1105 may be an example of aspects of a device 1005 or a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to CSI reporting with single and joint TRP measurements). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to CSI reporting with single and joint TRP measurements). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of CSI reporting with single and joint TRP measurements as described herein. For example, the communications manager 1120 may include a control signaling receiver 1125, an CMR monitoring component 1130, a CSI report transmitter 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a UE in accordance with examples as disclosed herein. The control signaling receiver 1125 may be configured as or otherwise support a means for receiving control signaling indicating a first subset of CMRs in a first CMR group for single TRP channel measurement associated with a first TRP, a second subset of CMRs in a second CMR group for single TRP channel measurement associated with a second TRP, and one or more CMR pairs including CMRs from each of the first CMR group and the second CMR group for joint TRP channel measurement. The CMR monitoring component 1130 may be configured as or otherwise support a means for monitoring the first subset of CMRs, the second subset of CMRs, and the one or more CMR pairs to generate a set of multiple measurements. The CSI report transmitter 1135 may be configured as or otherwise support a means for transmitting a CSI report including a number of bits indicating one or more channel resource indicators associated with at least one of the set of multiple measurements, where the number of bits is based on a number of the CMR pairs.

Additionally or alternatively, the communications manager 1120 may support wireless communication at a UE in accordance with examples as disclosed herein. The control signaling receiver 1125 may be configured as or otherwise support a means for receiving control signaling indicating a pair of CMRs and that a first PMI, a second PMI, a first RI, and a second RI of joint TRP CSI calculated for the pair of CMRs is to be shared for generating a respective CQI for each CMR of the pair of CMRs. The CMR monitoring component 1130 may be configured as or otherwise support a means for monitoring the pair of CMRs to generate the joint TRP CSI including the first PMI, the second PMI, the first RI, the second RI, and a first CQI. The CSI report transmitter 1135 may be configured as or otherwise support a means for transmitting a CSI report including the joint TRP CSI, a second CQI of a first CMR of the pair of CMRs calculated using the first PMI and the first RI, and a third CQI of a second CMR of the pair of CMRs calculated using the second PMI and the second RI.

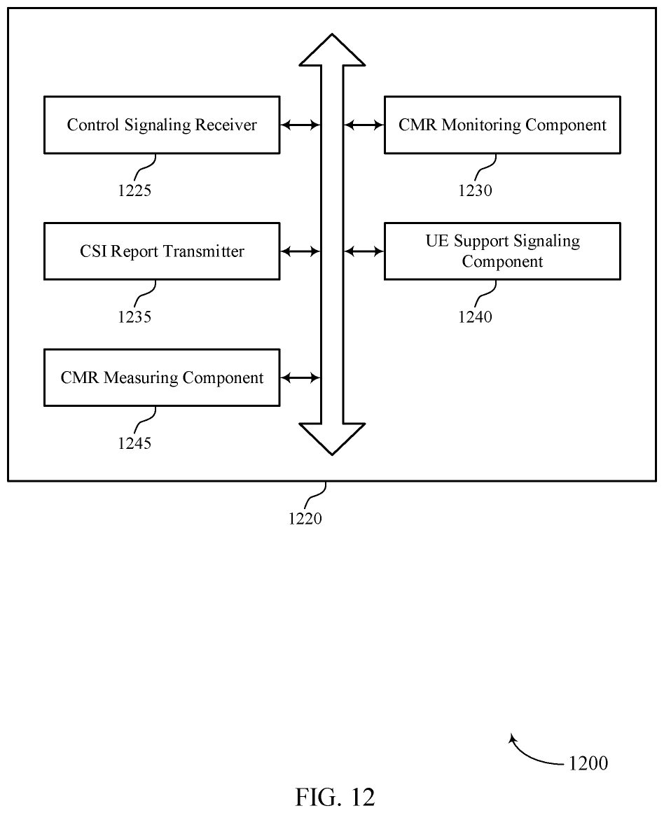

FIG. 12 shows a block diagram 1200 of a communications manager 1220 that supports CSI reporting with single and joint TRP measurements in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of CSI reporting with single and joint TRP measurements as described herein. For example, the communications manager 1220 may include a control signaling receiver 1225, an CMR monitoring component 1230, a CSI report transmitter 1235, a UE support signaling component 1240, an CMR measuring component 1245, or any combination thereof. Each of these components may communicate, directly or indirectly, with one another (e.g., via one or more buses).

The communications manager 1220 may support wireless communication at a UE in accordance with examples as disclosed herein. The control signaling receiver 1225 may be configured as or otherwise support a means for receiving control signaling indicating a first subset of CMRs in a first CMR group for single TRP channel measurement associated with a first TRP, a second subset of CMRs in a second CMR group for single TRP channel measurement associated with a second TRP, and one or more CMR pairs including CMRs from each of the first CMR group and the second CMR group for joint TRP channel measurement. The CMR monitoring component 1230 may be configured as or otherwise support a means for monitoring the first subset of CMRs, the second subset of CMRs, and the one or more CMR pairs to generate a set of multiple measurements. The CSI report transmitter 1235 may be configured as or otherwise support a means for transmitting a CSI report including a number of bits indicating one or more channel resource indicators associated with at least one of the set of multiple measurements, where the number of bits is based on a number of the CMR pairs.

In some examples, to support transmitting the CSI report, the CSI report transmitter 1235 may be configured as or otherwise support a means for transmitting the CSI report including the number of bits indicating a single channel resource indicator, where the number of bits based on the number of the CMR pairs.

In some examples, to support transmitting the CSI report, the CSI report transmitter 1235 may be configured as or otherwise support a means for transmitting the CSI report including the number of bits indicating a set of multiple channel resource indicators, the number of bits corresponding to a first number of bits in a first channel resource indicator of the set of multiple channel resource indicators that is based on the number of the CMR pairs and a second number of bits in a second channel resource indicator of the set of multiple channel resource indicators that is based on a sum of a first number of CMRs in the first subset and a second number of CMRs in the second subset.

In some examples, to support transmitting the CSI report, the CSI report transmitter 1235 may be configured as or otherwise support a means for transmitting the CSI report including the number of bits indicating a set of multiple channel resource indicators, the number of bits corresponding to a first number of bits in a first channel resource indicator of the set of multiple channel resource indicators that is based on the number of the CMR pairs, a second number of bits in a second channel resource indicator of the set of multiple channel resource indicators that is based on a first number of CMRs in the first subset, and a third number of bits in a third channel resource indicator of the set of multiple channel resource indicators that is based on a second number of CMRs in the second subset.

In some examples, to support transmitting the CSI report, the CSI report transmitter 1235 may be configured as or otherwise support a means for transmitting the CSI report including the number of bits indicating a single channel resource indicator, the number of bits based on a sum of a first number of CMRs in the first subset, a second number of CMRs in the second subset, and the number of the CMR pairs.

In some examples, the first subset includes a first number of unshared CMRs in the first CMR group and the second subset includes a second number of unshared CMRs in the second CMR group, where the unshared CMRs are CMRs distinct from CMRs within the one or more CMR pairs. In some examples, transmitting the CSI report further includes transmitting the CSI report including the number of bits indicating a set of multiple channel resource indicators based on the control signaling indicating that CMR sharing is disabled between single TRP channel measurement and joint TRP channel measurement, where the number of bits corresponds to a first number of bits in a first channel resource indicator of the set of multiple channel resource indicators that is based on the number of the CMR pairs, and a second number of bits in a second channel resource indicator of the set of multiple channel resource indicators that is based on the first number of unshared CMRs in the first subset and the second number of unshared CMRs in the second subset.

In some examples, the first subset includes a first number of unshared CMRs in the first CMR group and the second subset includes a second number of unshared CMRs in the second CMR group, where the unshared CMRs are CMRs distinct from CMRs within the one or more CMR pairs. In some examples, transmitting the CSI report further includes transmitting the CSI report including the number of bits indicating a set of multiple channel resource indicators based on the control signaling indicating that CMR sharing is disabled between single TRP channel measurement and joint TRP channel measurement, where the number of bits corresponds to a first number of bits in a first channel resource indicator of the set of multiple channel resource indicators that is based on the number of the CMR pairs, a second number of bits in a second channel resource indicator of the set of multiple channel resource indicators that is based on the first number of unshared CMRs in the first subset, and a third number of bits in a third channel resource indicator of the set of multiple channel resource indicators that is based on the second number of unshared CMRs in the second subset.

In some examples, the first subset includes a first number of unshared CMRs in the first CMR group and the second subset includes a second number of unshared CMRs in the second CMR group, where the unshared CMRs are CMRs distinct from CMRs within the one or more CMR pairs. In some examples, transmitting the CSI report further includes transmitting the CSI report including the number of bits indicating a single channel resource indicator based on the control signaling indicating that CMR sharing is disabled between single TRP channel measurement and joint TRP channel measurement, where the number of bits is based on a sum of the first number of unshared CMRs in the first subset, the second number of unshared CMRs in the second subset, and the number of the CMR pairs.

In some examples, to support transmitting the CSI report, the CSI report transmitter 1235 may be configured as or otherwise support a means for transmitting the CSI report including the number of bits indicating a set of multiple channel resource indicators, where the number of bits corresponds to a first number of bits in a first channel resource indicator of the set of multiple channel resource indicators that is based on the number of the CMR pairs and a second number of bits in a second channel resource indicator of the set of multiple channel resource indicators that is based on a sum of a first number of CMRs in the first subset for single TRP channel measurement and a second number of CMRs in the second subset for single TRP channel measurement, where the first number of CMRs is based on a difference between a third number of CMRs in the first CMR group and the number of the CMR pairs, and where the second number of CMRs is based on a difference between a fourth number of CMRs in the second CMR group and the number of the CMR pairs.

In some examples, to support transmitting the CSI report, the CSI report transmitter 1235 may be configured as or otherwise support a means for transmitting the CSI report including the number of bits indicating a set of multiple channel resource indicators, where the number of bits corresponds to a first number of bits in a first channel resource indicator of the set of multiple channel resource indicators that is based on the number of the CMR pairs, a second number of bits in a second channel resource indicator of the set of multiple channel resource indicators that is based on a first number of CMRs in the first subset for single TRP channel measurement, and a third number of bits in a third channel resource indicator of the set of multiple channel resource indicators that is based on a second number of CMRs in the second subset for single TRP channel measurement, where the first number of CMRs is based on a difference between a third number of CMRs in the first CMR group and the number of the CMR pairs, and where the second number of CMRs is based on a difference between a fourth number of CMRs in the second CMR group and the number of the CMR pairs.

In some examples, to support transmitting the CSI report, the CSI report transmitter 1235 may be configured as or otherwise support a means for transmitting the CSI report including the number of bits indicating a single channel resource indicator, where the number of bits is based on a sum of a first number of CMRs in the first subset for single TRP channel measurement, a second number of CMRs in the second subset for single TRP channel measurement, and the number of the CMR pairs, where the first number of CMRs is based on a difference between a third number of CMRs in the first CMR group and the number of the CMR pairs, and where the second number of CMRs is based on a difference between a fourth number of CMRs in the second CMR group and the number of the CMR pairs.

In some examples, the number of bits is based on a number of the one or more channel resource indicators, a first number of CMRs in the first subset, a second number of CMRs in the second subset, and the number of the CMR pairs.

In some examples, a number of channel resource indicators within the CSI report associated with one of the first TRP or the second TRP is zero, one, or two.

Additionally or alternatively, the communications manager 1220 may support wireless communication at a UE in accordance with examples as disclosed herein. In some examples, the control signaling receiver 1225 may be configured as or otherwise support a means for receiving control signaling indicating a pair of CMRs and that a first PMI, a second PMI, a first RI, and a second RI of joint TRP CSI calculated for the pair of CMRs is to be shared for generating a respective CQI for each CMR of the pair of CMRs. In some examples, the CMR monitoring component 1230 may be configured as or otherwise support a means for monitoring the pair of CMRs to generate the joint TRP CSI including the first PMI, the second PMI, the first RI, the second RI, and a first CQI. In some examples, the CSI report transmitter 1235 may be configured as or otherwise support a means for transmitting a CSI report including the joint TRP CSI, a second CQI of a first CMR of the pair of CMRs calculated using the first PMI and the first RI, and a third CQI of a second CMR of the pair of CMRs calculated using the second PMI and the second RI.

In some examples, the control signaling receiver 1225 may be configured as or otherwise support a means for receiving second control signaling indicating a configuration for calculating the second CQI and the third CQI, where transmitting the CSI report is based on receiving the second control signaling.

In some examples, the CMR measuring component 1245 may be configured as or otherwise support a means for measuring the first CMR independently of the second CMR to generate the second CQI in accordance with the configuration. In some examples, the CMR measuring component 1245 may be configured as or otherwise support a means for measuring the second CMR independently of the first CMR to generate the third CQI in accordance with the configuration.

In some examples, the CMR measuring component 1245 may be configured as or otherwise support a means for measuring the first CMR and a first interference signal received via the second CMR to generate the second CQI in accordance with the configuration. In some examples, the CMR measuring component 1245 may be configured as or otherwise support a means for measuring the second CMR and a second interference signal received via the first CMR to generate the third CQI in accordance with the configuration.

In some examples, the CMR measuring component 1245 may be configured as or otherwise support a means for applying the second PMI and the second RI to a first signal received via the second CMR to measure an interference level caused by the first interference signal. In some examples, the CMR measuring component 1245 may be configured as or otherwise support a means for applying the first PMI and the first RI to a second signal received via the first CMR to measure an interference level caused by the second interference signal.

In some examples, the UE support signaling component 1240 may be configured as or otherwise support a means for transmitting signaling indicating a defined number of CPUs supported by the UE, a defined number of active CSI-RS resources supported by the UE, and a defined number of active CSI-RS ports supported by the UE, where transmitting the CSI report uses a number of CPUs associated with the CSI report that is less than or equal to the defined number of CPUs supported by the UE, uses a number of active CSI-RS resources associated with the CSI report that is less than or equal to the defined number of active CSI-RS resources supported by the UE, and uses a number of active CSI-RS ports associated with the CSI report that is than or equal to the defined number of active CSI-RS ports supported by the UE.

In some examples, the control signaling indicates a number of pairs of CMRs including at least the pair of CMRs. In some examples, the number of CPUs associated with the CSI report is based on the number of pairs of CMRs and a number of individual CMRs within the number of pairs of CMRs. In some examples, the number of active CSI-RS resources associated with the CSI report is based on the number of pairs of CMRs and the number of individual CMRs within the number of pairs of CMRs. In some examples, the number of active CSI-RS ports associated with the CSI report is based on the number of pairs of CMRs, the number of individual CMRs within the number of pairs of CMRs, and a number of ports associated with each CMR.

In some examples, the control signaling indicates a number of pairs of CMRs including at least the pair of CMRs. In some examples, the number of CPUs associated with the CSI report is based on the number of pairs of CMRs and the pair of CMRs measured to generate the joint TRP CSI. In some examples, the number of active CSI-RS resources associated with the CSI report is based on the number of pairs of CMRs and the pair of CMRs measured to generate the joint TRP CSI. In some examples, the number of active CSI-RS ports associated with the CSI report is based on the number of pairs of CMRs, the pair of CMRs measured to generate the joint TRP CSI, and a number of ports associated with each CMR.

In some examples, the control signaling indicates a number of pairs of CMRs including at least the pair of CMRs. In some examples, the number of CPUs associated with the CSI report is based on the number of pairs of CMRs and a first constant indicated in the signaling. In some examples, the number of active CSI-RS resources associated with the CSI report is based on the number of pairs of CMRs and a second constant indicated in the signaling. In some examples, the number of active CSI-RS ports associated with the CSI report is based on the number of pairs of CMRs, the second constant indicated in the signaling, and a number of ports associated with each CMR.

In some examples, transmitting the signaling further includes transmitting signaling indicating a defined number of additional CQI calculations supported by the UE. In some examples, a number of additional CQI calculations associated with the CSI report is less than or equal to the defined number of additional CQI calculations supported by the UE. In some examples, the control signaling indicates a number of pairs of CMRs including at least the pair of CMRs. In some examples, the number of CPUs associated with the CSI report is based on the number of pairs of CMRs. In some examples, the number of active CSI-RS resources associated with the CSI report is based on the number of pairs of CMRs. In some examples, the number of active CSI-RS ports associated with the CSI report is based on the number of pairs of CMRs and a number of ports associated with each CMR. In some examples, the number of additional CQI calculations associated with the CSI report is based on the pair of CMRs measured to generate the joint TRP CSI.

In some examples, the control signaling receiver 1225 may be configured as or otherwise support a means for receiving second control signaling indicating for the CSI report to include the joint TRP CSI associated with the pair of CMRs, first single TRP CSI associated with the first CMR, and second single TRP CSI associated with the second CMR, where transmitting the CSI report further includes. In some examples, the CSI report transmitter 1235 may be configured as or otherwise support a means for transmitting, within a first portion of the CSI report associated with the joint TRP CSI, the first RI, the second RI, the first PMI, the second PMI, and the first CQI. In some examples, the CSI report transmitter 1235 may be configured as or otherwise support a means for transmitting, within a second portion of the CSI report associated with the first single TRP CSI, the second CQI and the first RI. In some examples, the CSI report transmitter 1235 may be configured as or otherwise support a means for transmitting, within a third portion of the CSI report associated with the second single TRP CSI, the third CQI and the second RI.

In some examples, the control signaling receiver 1225 may be configured as or otherwise support a means for receiving second control signaling indicating for a second CSI report to include second joint TRP CSI associated with the pair of CMRs, first single TRP CSI associated with a first CMR distinct from the pair of CMRs, and second single TRP CSI associated with a second CMR distinct from the pair of CMRs. In some examples, the CMR monitoring component 1230 may be configured as or otherwise support a means for monitoring the pair of CMRs to generate the second joint TRP CSI including a third PMI, a fourth PMI, a third RI, and a fourth RI. In some examples, the CMR monitoring component 1230 may be configured as or otherwise support a means for monitoring the first CMR to generate the first single TRP CSI including a fifth PMI and a fifth RI. In some examples, the CMR monitoring component 1230 may be configured as or otherwise support a means for monitoring the second CMR to generate the second single TRP CSI including a sixth PMI and a sixth RI. In some examples, the CSI report transmitter 1235 may be configured as or otherwise support a means for transmitting the second CSI report including the second joint TRP CSI, the first single TRP CSI, and the second single TRP CSI.

In some examples, the second CQI and the third CQI are included in a first part of the CSI report. Additionally, the second CQI and the third CQI may be jointly encoded with the first PMI, the second PMI, the first RI, the second RI, the first CQI, and a CRI associated with the pair of CMRs.

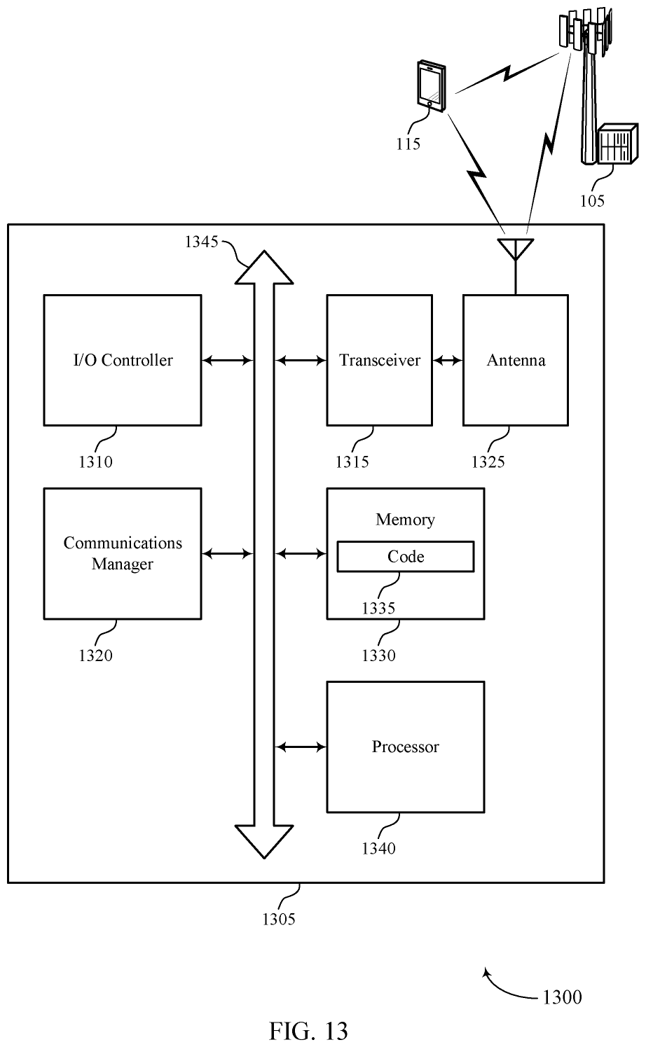

FIG. 13 shows a diagram of a system 1300 including a device 1305 that supports CSI reporting with single and joint TRP measurements in accordance with aspects of the present disclosure. The device 1305 may be an example of or include the components of a device 1005, a device 1105, or a UE 115 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include random access memory (RAM) and read-only memory (ROM). The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a basic I/O system (BIOS) which may control basic hardware or software operation such as the interaction with peripheral components or devices.

The processor 1340 may include an intelligent hardware device (e.g., a general-purpose processor, a DSP, a central processing unit, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting CSI reporting with single and joint TRP measurements). For example, the device 1305 or a component of the device 1305 may include a processor 1340 and memory 1330 coupled to the processor 1340, the processor 1340 and memory 1330 configured to perform various functions described herein.

The communications manager 1320 may support wireless communication at a UE in accordance with examples as disclosed herein. For example, the communications manager 1320 may be configured as or otherwise support a means for receiving control signaling indicating a first subset of CMRs in a first CMR group for single TRP channel measurement associated with a first TRP, a second subset of CMRs in a second CMR group for single TRP channel measurement associated with a second TRP, and one or more CMR pairs including CMRs from each of the first CMR group and the second CMR group for joint TRP channel measurement. The communications manager 1320 may be configured as or otherwise support a means for monitoring the first subset of CMRs, the second subset of CMRs, and the one or more CMR pairs to generate a set of multiple measurements. The communications manager 1320 may be configured as or otherwise support a means for transmitting a CSI report including a number of bits indicating one or more channel resource indicators associated with at least one of the set of multiple measurements, where the number of bits is based on a number of the CMR pairs.

Additionally or alternatively, the communications manager 1320 may support wireless communication at a UE in accordance with examples as disclosed herein. For example, the communications manager 1320 may be configured as or otherwise support a means for receiving control signaling indicating a pair of CMRs and that a first PMI, a second PMI, a first RI, and a second RI of joint TRP CSI calculated for the pair of CMRs is to be shared for generating a respective CQI for each CMR of the pair of CMRs. The communications manager 1320 may be configured as or otherwise support a means for monitoring the pair of CMRs to generate the joint TRP CSI including the first PMI, the second PMI, the first RI, the second RI, and a first CQI. The communications manager 1320 may be configured as or otherwise support a means for transmitting a CSI report including the joint TRP CSI, a second CQI of a first CMR of the pair of CMRs calculated using the first PMI and the first RI, and a third CQI of a second CMR of the pair of CMRs calculated using the second PMI and the second RI.

By including or configuring the communications manager 1320 in accordance with examples as described herein, the device 1305 may support techniques for more efficient utilization of communication resources.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of CSI reporting with single and joint TRP measurements as described herein, or the processor 1340 and the memory 1330 may be otherwise configured to perform or support such operations.

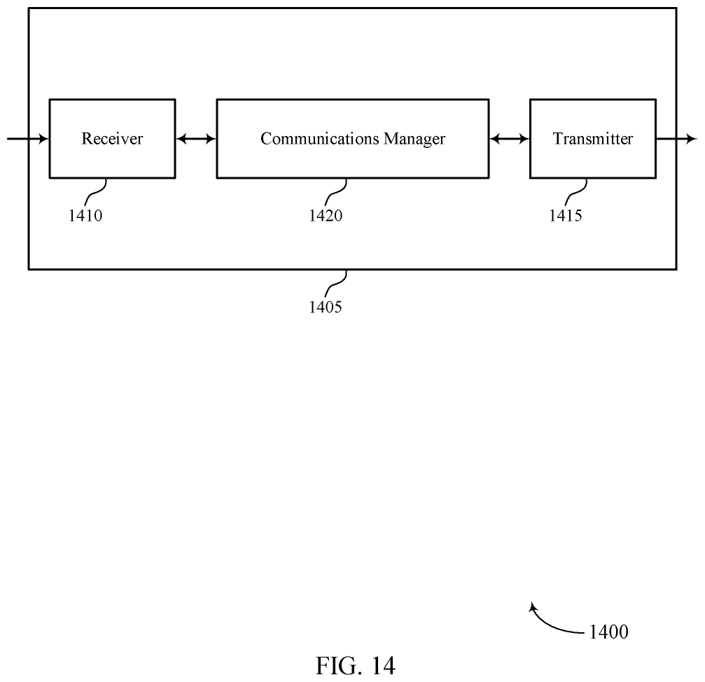

FIG. 14 shows a block diagram 1400 of a device 1405 that supports CSI reporting with single and joint TRP measurements in accordance with aspects of the present disclosure. The device 1405 may be an example of aspects of a base station 105 (e.g., including one or more TRPs) as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for receiving information such as packets, user data, control information, or any combination thereof associated with various information channels (e.g., control channels, data channels, information channels related to CSI reporting with single and joint TRP measurements). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to CSI reporting with single and joint TRP measurements). In some examples, the transmitter 1415 may be co-located with a receiver 1410 in a transceiver module. The transmitter 1415 may utilize a single antenna or a set of multiple antennas.

The communications manager 1420, the receiver 1410, the transmitter 1415, or various combinations thereof or various components thereof may be examples of means for performing various aspects of CSI reporting with single and joint TRP measurements as described herein. For example, the communications manager 1420, the receiver 1410, the transmitter 1415, or various combinations or components thereof may support a method for performing one or more of the functions described herein.

In some examples, the communications manager 1420, the receiver 1410, the transmitter 1415, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1420, the receiver 1410, the transmitter 1415, or various combinations or components thereof may be implemented in code (e.g., as communications management software or firmware) executed by a processor. If implemented in code executed by a processor, the functions of the communications manager 1420, the receiver 1410, the transmitter 1415, or various combinations or components thereof may be performed by a general-purpose processor, a DSP, a central processing unit, an ASIC, an FPGA, or any combination of these or other programmable logic devices (e.g., configured as or otherwise supporting a means for performing the functions described in the present disclosure).

In some examples, the communications manager 1420 may be configured to perform various operations (e.g., receiving, monitoring, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to receive information, transmit information, or perform various other operations as described herein.

The communications manager 1420 may support wireless communications at a base station in accordance with examples as disclosed herein. For example, the communications manager 1420 may be configured as or otherwise support a means for transmitting, to a UE, control signaling indicating a first subset of CMRs in a first CMR group for single TRP channel measurement associated with a first TRP, a second subset of CMRs in a second CMR group for single TRP channel measurement associated with a second TRP, and one or more CMR pairs including CMRs from each of the first CMR group and the second CMR group for joint TRP channel measurement. The communications manager 1420 may be configured as or otherwise support a means for receiving, from the UE, a CSI report including a number of bits indicating one or more channel resource indicators, where the number of bits is based on a number of the CMR pairs.

Additionally or alternatively, the communications manager 1420 may support wireless communications at a base station in accordance with examples as disclosed herein. For example, the communications manager 1420 may be configured as or otherwise support a means for transmitting, to a UE, control signaling indicating a pair of CMRs and that a first PMI, a second PMI, a first RI, and a second RI of joint TRP CSI calculated for the pair of CMRs is to be shared for generating a respective CQI for each CMR of the pair of CMRs. The communications manager 1420 may be configured as or otherwise support a means for receiving, from the UE, a CSI report including the joint TRP CSI, a second CQI of a first CMR of the pair of CMRs calculated using the first PMI and the first RI, and a third CQI of a second CMR of the pair of CMRs calculated using the second PMI and the second RI.

By including or configuring the communications manager 1420 in accordance with examples as described herein, the device 1405 (e.g., a processor controlling or otherwise coupled to the receiver 1410, the transmitter 1415, the communications manager 1420, or a combination thereof) may support techniques for more efficient utilization of communication resources.

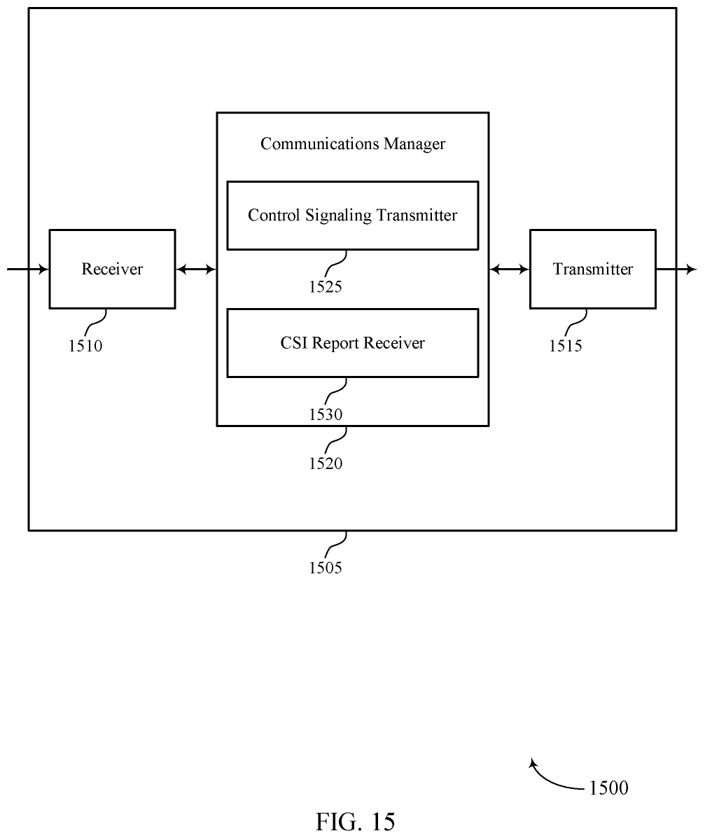

FIG. 15 shows a block diagram 1500 of a device 1505 that supports CSI reporting with single and joint TRP measurements in accordance with aspects of the present disclosure. The device 1505 may be an example of aspects of a device 1405 or a base station 105 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for receiving information such as packets, user data, control information, or any combination thereof associated with various information channels (e.g., control channels, data channels, information channels related to CSI reporting with single and joint TRP measurements). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to CSI reporting with single and joint TRP measurements). In some examples, the transmitter 1515 may be co-located with a receiver 1510 in a transceiver module. The transmitter 1515 may utilize a single antenna or a set of multiple antennas.

The device 1505, or various components thereof, may be an example of means for performing various aspects of CSI reporting with single and joint TRP measurements as described herein. For example, the communications manager 1520 may include a control signaling transmitter 1525 a CSI report receiver 1530, or any combination thereof. The communications manager 1520 may be an example of aspects of a communications manager 1420 as described herein. In some examples, the communications manager 1520, or various components thereof, may be configured to perform various operations (e.g., receiving, monitoring, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to receive information, transmit information, or perform various other operations as described herein.

The communications manager 1520 may support wireless communications at a base station in accordance with examples as disclosed herein. The control signaling transmitter 1525 may be configured as or otherwise support a means for transmitting, to a UE, control signaling indicating a first subset of CMRs in a first CMR group for single TRP channel measurement associated with a first TRP, a second subset of CMRs in a second CMR group for single TRP channel measurement associated with a second TRP, and one or more CMR pairs including CMRs from each of the first CMR group and the second CMR group for joint TRP channel measurement. The CSI report receiver 1530 may be configured as or otherwise support a means for receiving, from the UE, a CSI report including a number of bits indicating one or more channel resource indicators, where the number of bits is based on a number of the CMR pairs.

Additionally or alternatively, the communications manager 1520 may support wireless communications at a base station in accordance with examples as disclosed herein. The control signaling transmitter 1525 may be configured as or otherwise support a means for transmitting, to a UE, control signaling indicating a pair of CMRs and that a first PMI, a second PMI, a first RI, and a second RI of joint TRP CSI calculated for the pair of CMRs is to be shared for generating a respective CQI for each CMR of the pair of CMRs. The CSI report receiver 1530 may be configured as or otherwise support a means for receiving, from the UE, a CSI report including the joint TRP CSI, a second CQI of a first CMR of the pair of CMRs calculated using the first PMI and the first RI, and a third CQI of a second CMR of the pair of CMRs calculated using the second PMI and the second RI.

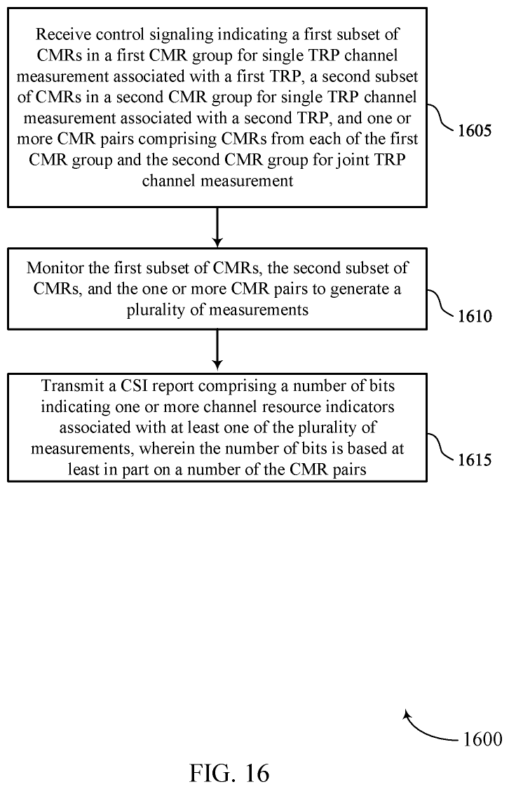

FIG. 16 shows a flowchart illustrating a method 1600 that supports CSI reporting with single and joint TRP measurements in accordance with aspects of the present disclosure. The operations of the method 1600 may be implemented by a UE or its components as described herein. For example, the operations of the method 1600 may be performed by a UE 115 as described with reference to FIGS. 1 through 13. In some examples, a UE may execute a set of instructions to control the functional elements of the UE to perform the described functions. Additionally or alternatively, the UE may perform aspects of the described functions using special-purpose hardware.

At 1605, the method may include receiving control signaling indicating a first subset of CMRs in a first CMR group for single TRP channel measurement associated with a first TRP, a second subset of CMRs in a second CMR group for single TRP channel measurement associated with a second TRP, and one or more CMR pairs including CMRs from each of the first CMR group and the second CMR group for joint TRP channel measurement. The operations of 1605 may be performed in accordance with examples as disclosed herein. In some examples, aspects of the operations of 1605 may be performed by a control signaling receiver 1225 as described with reference to FIG. 12.

At 1610, the method may include monitoring the first subset of CMRs, the second subset of CMRs, and the one or more CMR pairs to generate a set of multiple measurements. The operations of 1610 may be performed in accordance with examples as disclosed herein. In some examples, aspects of the operations of 1610 may be performed by an CMR monitoring component 1230 as described with reference to FIG. 12.

At 1615, the method may include transmitting a CSI report including a number of bits indicating one or more channel resource indicators associated with at least one of the set of multiple measurements, where the number of bits is based on a number of the CMR pairs. The operations of 1615 may be performed in accordance with examples as disclosed herein. In some examples, aspects of the operations of 1615 may be performed by a CSI report transmitter 1235 as described with reference to FIG. 12.

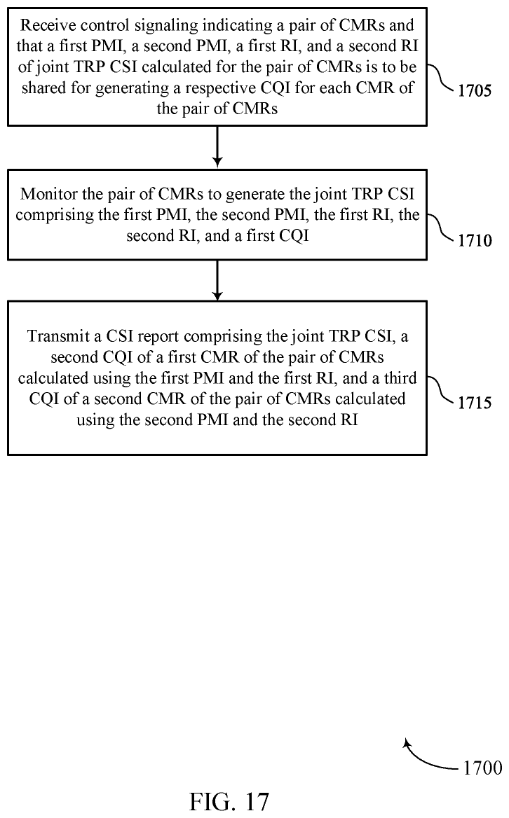

FIG. 17 shows a flowchart illustrating a method 1700 that supports CSI reporting with single and joint TRP measurements in accordance with aspects of the present disclosure. The operations of the method 1700 may be implemented by a UE or its components as described herein. For example, the operations of the method 1700 may be performed by a UE 115 as described with reference to FIGS. 1 through 13. In some examples, a UE may execute a set of instructions to control the functional elements of the UE to perform the described functions. Additionally or alternatively, the UE may perform aspects of the described functions using special-purpose hardware.

At 1705, the method may include receiving control signaling indicating a pair of CMRs and that a first PMI, a second PMI, a first RI, and a second RI of joint TRP CSI calculated for the pair of CMRs is to be shared for generating a respective CQI for each CMR of the pair of CMRs. The operations of 1705 may be performed in accordance with examples as disclosed herein. In some examples, aspects of the operations of 1705 may be performed by a control signaling receiver 1225 as described with reference to FIG. 12.

At 1710, the method may include monitoring the pair of CMRs to generate the joint TRP CSI including the first PMI, the second PMI, the first RI, the second RI, and a first CQI. The operations of 1710 may be performed in accordance with examples as disclosed herein. In some examples, aspects of the operations of 1710 may be performed by an CMR monitoring component 1230 as described with reference to FIG. 12.

At 1715, the method may include transmitting a CSI report including the joint TRP CSI, a second CQI of a first CMR of the pair of CMRs calculated using the first PMI and the first RI, and a third CQI of a second CMR of the pair of CMRs calculated using the second PMI and the second RI. The operations of 1715 may be performed in accordance with examples as disclosed herein. In some examples, aspects of the operations of 1715 may be performed by a CSI report transmitter 1235 as described with reference to FIG. 12.

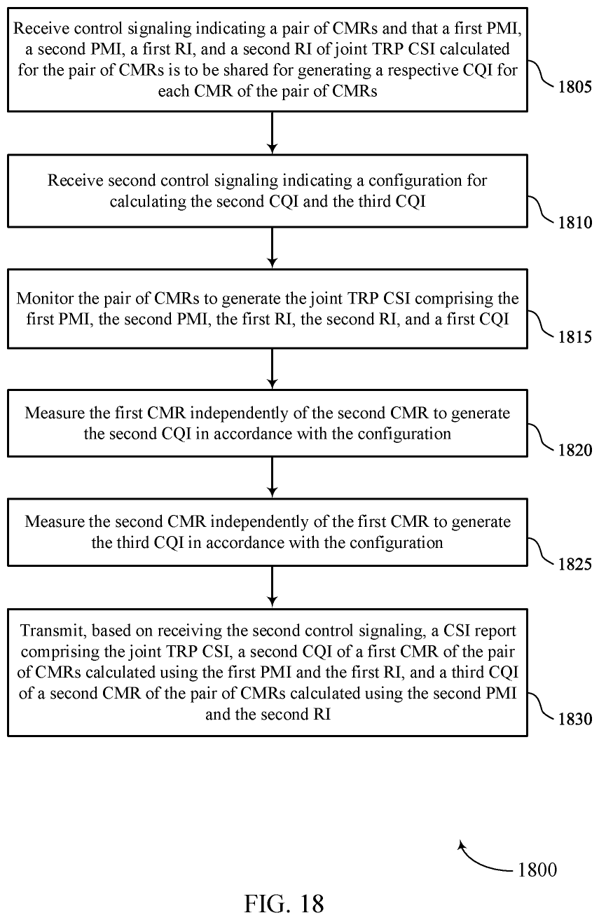

FIG. 18 shows a flowchart illustrating a method 1800 that supports CSI reporting with single and joint TRP measurements in accordance with aspects of the present disclosure. The operations of the method 1800 may be implemented by a UE or its components as described herein. For example, the operations of the method 1800 may be performed by a UE 115 as described with reference to FIGS. 1 through 13. In some examples, a UE may execute a set of instructions to control the functional elements of the UE to perform the described functions. Additionally or alternatively, the UE may perform aspects of the described functions using special-purpose hardware.

At 1805, the method may include receiving control signaling indicating a pair of CMRs and that a first PMI, a second PMI, a first RI, and a second RI of joint TRP CSI calculated for the pair of CMRs is to be shared for generating a respective CQI for each CMR of the pair of CMRs. The operations of 1805 may be performed in accordance with examples as disclosed herein. In some examples, aspects of the operations of 1805 may be performed by a control signaling receiver 1225 as described with reference to FIG. 12.

At 1810, the method may include receiving second control signaling indicating a configuration for calculating the second CQI and the third CQI. The operations of 1810 may be performed in accordance with examples as disclosed herein. In some examples, aspects of the operations of 1810 may be performed by a control signaling receiver 1225 as described with reference to FIG. 12.

At 1815, the method may include monitoring the pair of CMRs to generate the joint TRP CSI including the first PMI, the second PMI, the first RI, the second RI, and a first CQI. The operations of 1815 may be performed in accordance with examples as disclosed herein. In some examples, aspects of the operations of 1815 may be performed by an CMR monitoring component 1230 as described with reference to FIG. 12.

At 1820, the method may include measuring the first CMR independently of the second CMR to generate the second CQI in accordance with the configuration. The operations of 1820 may be performed in accordance with examples as disclosed herein. In some examples, aspects of the operations of 1820 may be performed by an CMR measuring component 1245 as described with reference to FIG. 12.

At 1825, the method may include measuring the second CMR independently of the first CMR to generate the third CQI in accordance with the configuration. The operations of 1825 may be performed in accordance with examples as disclosed herein. In some examples, aspects of the operations of 1825 may be performed by an CMR measuring component 1245 as described with reference to FIG. 12.

At 1830, the method may include transmitting, based on receiving the second control signaling, a CSI report including the joint TRP CSI, a second CQI of a first CMR of the pair of CMRs calculated using the first PMI and the first RI, and a third CQI of a second CMR of the pair of CMRs calculated using the second PMI and the second RI. The operations of 1830 may be performed in accordance with examples as disclosed herein. In some examples, aspects of the operations of 1830 may be performed by a CSI report transmitter 1235 as described with reference to FIG. 12.

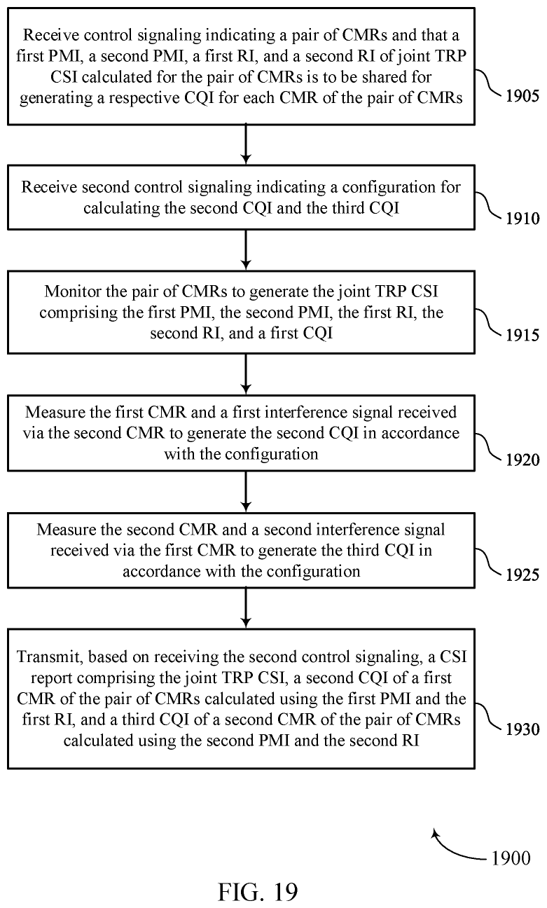

FIG. 19 shows a flowchart illustrating a method 1900 that supports CSI reporting with single and joint TRP measurements in accordance with aspects of the present disclosure. The operations of the method 1900 may be implemented by a UE or its components as described herein. For example, the operations of the method 1900 may be performed by a UE 115 as described with reference to FIGS. 1 through 13. In some examples, a UE may execute a set of instructions to control the functional elements of the UE to perform the described functions. Additionally or alternatively, the UE may perform aspects of the described functions using special-purpose hardware.

At 1905, the method may include receiving control signaling indicating a pair of CMRs and that a first PMI, a second PMI, a first RI, and a second RI of joint TRP CSI calculated for the pair of CMRs is to be shared for generating a respective CQI for each CMR of the pair of CMRs. The operations of 1905 may be performed in accordance with examples as disclosed herein. In some examples, aspects of the operations of 1905 may be performed by a control signaling receiver 1225 as described with reference to FIG. 12.

At 1910, the method may include receiving second control signaling indicating a configuration for calculating the second CQI and the third CQI. The operations of 1910 may be performed in accordance with examples as disclosed herein. In some examples, aspects of the operations of 1910 may be performed by a control signaling receiver 1225 as described with reference to FIG. 12.

At 1915, the method may include monitoring the pair of CMRs to generate the joint TRP CSI including the first PMI, the second PMI, the first RI, the second RI, and a first CQI. The operations of 1915 may be performed in accordance with examples as disclosed herein. In some examples, aspects of the operations of 1915 may be performed by an CMR monitoring component 1230 as described with reference to FIG. 12.

At 1920, the method may include measuring the first CMR and a first interference signal received via the second CMR to generate the second CQI in accordance with the configuration. The operations of 1920 may be performed in accordance with examples as disclosed herein. In some examples, aspects of the operations of 1920 may be performed by an CMR measuring component 1245 as described with reference to FIG. 12.

At 1925, the method may include measuring the second CMR and a second interference signal received via the first CMR to generate the third CQI in accordance with the configuration. The operations of 1925 may be performed in accordance with examples as disclosed herein. In some examples, aspects of the operations of 1925 may be performed by an CMR measuring component 1245 as described with reference to FIG. 12.

At 1930, the method may include transmitting, based on receiving the second control signaling, a CSI report including the joint TRP CSI, a second CQI of a first CMR of the pair of CMRs calculated using the first PMI and the first RI, and a third CQI of a second CMR of the pair of CMRs calculated using the second PMI and the second RI. The operations of 1930 may be performed in accordance with examples as disclosed herein. In some examples, aspects of the operations of 1930 may be performed by a CSI report transmitter 1235 as described with reference to FIG. 12.

The following provides an overview of aspects of the present disclosure:

Aspect 1: A method for wireless communication at a UE, comprising: receiving control signaling indicating a first subset of CMRs in a first CMR group for single TRP channel measurement associated with a first TRP, a second subset of CMRs in a second CMR group for single TRP channel measurement associated with a second TRP, and one or more CMR pairs comprising CMRs from each of the first CMR group and the second CMR group for joint TRP channel measurement; monitoring the first subset of CMRs, the second subset of CMRs, and the one or more CMR pairs to generate a plurality of measurements; and transmitting a CSI report comprising a number of bits indicating one or more CRIs associated with at least one of the plurality of measurements, wherein the number of bits is based at least in part on a number of the CMR pairs.

Aspect 2: The method of aspect 1, wherein transmitting the CSI report further comprises: transmitting the CSI report comprising the number of bits indicating a single CRI, wherein the number of bits based at least in part on the number of the CMR pairs.

Aspect 3: The method of aspect 1, wherein transmitting the CSI report further comprises: transmitting the CSI report comprising the number of bits indicating a plurality of CRIs, the number of bits corresponding to a first number of bits in a first CRI of the plurality of CRIs that is based at least in part on the number of the CMR pairs and a second number of bits in a second CRI of the plurality of CRIs that is based at least in part on a sum of a first number of CMRs in the first subset and a second number of CMRs in the second subset.

Aspect 4: The method of aspect 1, wherein transmitting the CSI report further comprises: transmitting the CSI report comprising the number of bits indicating a plurality of CRIs, the number of bits corresponding to a first number of bits in a first CRI of the plurality of CRIs that is based at least in part on the number of the CMR pairs, a second number of bits in a second CRI of the plurality of CRIs that is based at least in part on a first number of CMRs in the first subset, and a third number of bits in a third CRI of the plurality of CRIs that is based at least in part on a second number of CMRs in the second subset.

Aspect 5: The method of aspect 1, wherein transmitting the CSI report further comprises: transmitting the CSI report comprising the number of bits indicating a single CRI, the number of bits based at least in part on a sum of a first number of CMRs in the first subset, a second number of CMRs in the second subset, and the number of the CMR pairs.

Aspect 6: The method of aspect 1, wherein the first subset comprises a first number of unshared CMRs in the first CMR group and the second subset comprises a second number of unshared CMRs in the second CMR group, wherein the unshared CMRs are CMRs distinct from CMRs within the one or more CMR pairs; and transmitting the CSI report further comprises transmitting the CSI report comprising the number of bits indicating a plurality of CRIs based at least in part on the control signaling indicating that CMR sharing is disabled between single TRP channel measurement and joint TRP channel measurement, wherein the number of bits corresponds to a first number of bits in a first CRI of the plurality of CRIs that is based at least in part on the number of the CMR pairs, and a second number of bits in a second CRI of the plurality of CRIs that is based at least in part on the first number of unshared CMRs in the first subset and the second number of unshared CMRs in the second subset.

Aspect 7: The method of aspect 1, wherein the first subset comprises a first number of unshared CMRs in the first CMR group and the second subset comprises a second number of unshared CMRs in the second CMR group, wherein the unshared CMRs are CMRs distinct from CMRs within the one or more CMR pairs; and transmitting the CSI report further comprises transmitting the CSI report comprising the number of bits indicating a plurality of CRIs based at least in part on the control signaling indicating that CMR sharing is disabled between single TRP channel measurement and joint TRP channel measurement, wherein the number of bits corresponds to a first number of bits in a first CRI of the plurality of CRIs that is based at least in part on the number of the CMR pairs, a second number of bits in a second CRI of the plurality of CRIs that is based at least in part on the first number of unshared CMRs in the first subset, and a third number of bits in a third CRI of the plurality of CRIs that is based at least in part on the second number of unshared CMRs in the second subset.

Aspect 8: The method of aspect 1, wherein the first subset comprises a first number of unshared CMRs in the first CMR group and the second subset comprises a second number of unshared CMRs in the second CMR group, wherein the unshared CMRs are CMRs distinct from CMRs within the one or more CMR pairs; and transmitting the CSI report further comprises transmitting the CSI report comprising the number of bits indicating a single CRI based at least in part on the control signaling indicating that CMR sharing is disabled between single TRP channel measurement and joint TRP channel measurement, wherein the number of bits is based at least in part on a sum of the first number of unshared CMRs in the first subset, the second number of unshared CMRs in the second subset, and the number of the CMR pairs.

Aspect 9: The method of aspect 1, wherein transmitting the CSI report further comprises: transmitting the CSI report comprising the number of bits indicating a plurality of CRIs, wherein the number of bits corresponds to a first number of bits in a first CRI of the plurality of CRIs that is based at least in part on the number of the CMR pairs and a second number of bits in a second CRI of the plurality of CRIs that is based at least in part on a sum of a first number of CMRs in the first subset for single TRP channel measurement and a second number of CMRs in the second subset for single TRP channel measurement, wherein the first number of CMRs is based at least in part on a difference between a third number of CMRs in the first CMR group and the number of the CMR pairs, and wherein the second number of CMRs is based at least in part on a difference between a fourth number of CMRs in the second CMR group and the number of the CMR pairs.

Aspect 10: The method of aspect 1, wherein transmitting the CSI report further comprises: transmitting the CSI report comprising the number of bits indicating a plurality of CRIs, wherein the number of bits corresponds to a first number of bits in a first CRI of the plurality of CRIs that is based at least in part on the number of the CMR pairs, a second number of bits in a second CRI of the plurality of CRIs that is based at least in part on a first number of CMRs in the first subset for single TRP channel measurement, and a third number of bits in a third CRI of the plurality of CRIs that is based at least in part on a second number of CMRs in the second subset for single TRP channel measurement, wherein the first number of CMRs is based at least in part on a difference between a third number of CMRs in the first CMR group and the number of the CMR pairs, and wherein the second number of CMRs is based at least in part on a difference between a fourth number of CMRs in the second CMR group and the number of the CMR pairs.

Aspect 11: The method of aspect 1, wherein transmitting the CSI report further comprises: transmitting the CSI report comprising the number of bits indicating a single CRI, wherein the number of bits is based at least in part on a sum of a first number of CMRs in the first subset for single TRP channel measurement, a second number of CMRs in the second subset for single TRP channel measurement, and the number of the CMR pairs, wherein the first number of CMRs is based at least in part on a difference between a third number of CMRs in the first CMR group and the number of the CMR pairs, and wherein the second number of CMRs is based at least in part on a difference between a fourth number of CMRs in the second CMR group and the number of the CMR pairs.

Aspect 12: The method of any of aspects 1 through 11, wherein the number of bits is based at least in part on a number of the one or more CRIs, a first number of CMRs in the first subset, a second number of CMRs in the second subset, and the number of the CMR pairs.

Aspect 13: The method of any of aspects 1 through 12, wherein a number of CRIs within the CSI report associated with one of the first TRP or the second TRP is zero, one, or two.

Aspect 14: A method for wireless communication at a UE, comprising: receiving control signaling indicating a pair of CMRs and that a first PMI, a second PMI, a first RI, and a second RI of joint TRP CSI calculated for the pair of CMRs is to be shared for generating a respective CQI for each CMR of the pair of CMRs; monitoring the pair of CMRs to generate the joint TRP CSI comprising the first PMI, the second PMI, the first RI, the second RI, and a first CQI; and transmitting a CSI report comprising the joint TRP CSI, a second CQI of a first CMR of the pair of CMRs calculated using the first PMI and the first RI, and a third CQI of a second CMR of the pair of CMRs calculated using the second PMI and the second RI.

Aspect 15: The method of aspect 14, further comprising: receiving second control signaling indicating a configuration for calculating the second CQI and the third CQI, wherein transmitting the CSI report is based at least in part on receiving the second control signaling.

Aspect 16: The method of aspect 15, further comprising: measuring the first CMR independently of the second CMR to generate the second CQI in accordance with the configuration; and measuring the second CMR independently of the first CMR to generate the third CQI in accordance with the configuration.

Aspect 17: The method of aspect 15, further comprising: measuring the first CMR and a first interference signal received via the second CMR to generate the second CQI in accordance with the configuration; and measuring the second CMR and a second interference signal received via the first CMR to generate the third CQI in accordance with the configuration.

Aspect 18: The method of aspect 17, further comprising: applying the second PMI and the second RI to a first signal received via the second CMR to measure an interference level caused by the first interference signal; and applying the first PMI and the first RI to a second signal received via the first CMR to measure an interference level caused by the second interference signal.

Aspect 19: The method of any of aspects 14 through 18, further comprising: transmitting signaling indicating a defined number of CPUs supported by the UE, a defined number of active CSI-RS resources supported by the UE, and a defined number of active CSI-RS ports supported by the UE, wherein transmitting the CSI report uses a number of CPUs associated with the CSI report that is less than or equal to the defined number of CPUs supported by the UE, uses a number of active CSI-RS resources associated with the CSI report that is less than or equal to the defined number of active CSI-RS resources supported by the UE, and uses a number of active CSI-RS ports associated with the CSI report that is than or equal to the defined number of active CSI-RS ports supported by the UE.

Aspect 20: The method of aspect 19, wherein the control signaling indicates a number of pairs of CMRs comprising at least the pair of CMRs; the number of CPUs associated with the CSI report is based at least in part on the number of pairs of CMRs and a number of individual CMRs within the number of pairs of CMRs; the number of active CSI-RS resources associated with the CSI report is based at least in part on the number of pairs of CMRs and the number of individual CMRs within the number of pairs of CMRs; and the number of active CSI-RS ports associated with the CSI report is based at least in part on the number of pairs of CMRs, the number of individual CMRs within the number of pairs of CMRs, and a number of ports associated with each CMR.

Aspect 21: The method of aspect 19, wherein the control signaling indicates a number of pairs of CMRs comprising at least the pair of CMRs; the number of CPUs associated with the CSI report is based at least in part on the number of pairs of CMRs and the pair of CMRs measured to generate the joint TRP CSI; the number of active CSI-RS resources associated with the CSI report is based at least in part on the number of pairs of CMRs and the pair of CMRs measured to generate the joint TRP CSI; and the number of active CSI-RS ports associated with the CSI report is based at least in part on the number of pairs of CMRs, the pair of CMRs measured to generate the joint TRP CSI, and a number of ports associated with each CMR.

Aspect 22: The method of aspect 19, wherein the control signaling indicates a number of pairs of CMRs comprising at least the pair of CMRs; the number of CPUs associated with the CSI report is based at least in part on the number of pairs of CMRs and a first constant indicated in the signaling; the number of active CSI-RS resources associated with the CSI report is based at least in part on the number of pairs of CMRs and a second constant indicated in the signaling; and the number of active CSI-RS ports associated with the CSI report is based at least in part on the number of pairs of CMRs, the second constant indicated in the signaling, and a number of ports associated with each CMR.

Aspect 23: The method of aspect 19, wherein transmitting the signaling further comprises transmitting signaling indicating a defined number of additional CQI calculations supported by the UE; a number of additional CQI calculations associated with the CSI report is less than or equal to the defined number of additional CQI calculations supported by the UE; the control signaling indicates a number of pairs of CMRs comprising at least the pair of CMRs; the number of CPUs associated with the CSI report is based at least in part on the number of pairs of CMRs; the number of active CSI-RS resources associated with the CSI report is based at least in part on the number of pairs of CMRs; the number of active CSI-RS ports associated with the CSI report is based at least in part on the number of pairs of CMRs and a number of ports associated with each CMR; and the number of additional CQI calculations associated with the CSI report is based at least in part on the pair of CMRs measured to generate the joint TRP CSI.

Aspect 24: The method of any of aspects 14 through 23, further comprising: receiving second control signaling indicating for the CSI report to comprise the joint TRP CSI associated with the pair of CMRs, first single TRP CSI associated with the first CMR, and second single TRP CSI associated with the second CMR, wherein transmitting the CSI report further comprises: transmitting, within a first portion of the CSI report associated with the joint TRP CSI, the first RI, the second RI, the first PMI, the second PMI, and the first CQI; transmitting, within a second portion of the CSI report associated with the first single TRP CSI, the second CQI and the first RI; and transmitting, within a third portion of the CSI report associated with the second single TRP CSI, the third CQI and the second RI.

Aspect 25: The method of any of aspects 14 through 24, further comprising: receiving second control signaling indicating for a second CSI report to comprise second joint TRP CSI associated with the pair of CMRs, first single TRP CSI associated with a first CMR distinct from the pair of CMRs, and second single TRP CSI associated with a second CMR distinct from the pair of CMRs; monitoring the pair of CMRs to generate the second joint TRP CSI comprising a third PMI, a fourth PMI, a third RI, and a fourth RI; monitoring the first CMR to generate the first single TRP CSI comprising a fifth PMI and a fifth RI; monitoring the second CMR to generate the second single TRP CSI comprising a sixth PMI and a sixth RI; and transmitting the second CSI report comprising the second joint TRP CSI, the first single TRP CSI, and the second single TRP CSI.

Aspect 26: The method of any of aspects 14 through 24, wherein the second CQI and the third CQI are included in a first part of the CSI report; and the second CQI and the third CQI are jointly encoded with the first PMI, the second PMI, the first RI, the second RI, the first CQI, and a CRI associated with the pair of CMRs.

Aspect 27: A method for wireless communications at a base station, comprising: transmitting, to a UE, control signaling indicating a first subset of CMRs in a first CMR group for single TRP channel measurement associated with a first TRP, a second subset of CMRs in a second CMR group for single TRP channel measurement associated with a second TRP, and one or more CMR pairs comprising CMRs from each of the first CMR group and the second CMR group for joint TRP channel measurement; and receiving, from the UE, a CSI report comprising a number of bits indicating one or more CRIs, wherein the number of bits is based at least in part on a number of the CMR pairs.

Aspect 28: A method for wireless communications at a base station, comprising: transmitting, to a UE, control signaling indicating a pair of CMRs and that a first PMI, a second PMI, a first RI, and a second RI of joint TRP CSI calculated for the pair of CMRs is to be shared for generating a respective CQI for each CMR of the pair of CMRs; and receiving, from the UE, a CSI report comprising the joint TRP CSI, a second CQI of a first CMR of the pair of CMRs calculated using the first PMI and the first RI, and a third CQI of a second CMR of the pair of CMRs calculated using the second PMI and the second RI.

Aspect 29: An apparatus for wireless communication at a UE, comprising a processor; memory coupled with the processor; and instructions stored in the memory and executable by the processor to cause the apparatus to perform a method of any of aspects 1 through 13.

Aspect 30: An apparatus for wireless communication at a UE, comprising at least one means for performing a method of any of aspects 1 through 13.

Aspect 31: A non-transitory computer-readable medium storing code for wireless communication at a UE, the code comprising instructions executable by a processor to perform a method of any of aspects 1 through 13.

Aspect 32: An apparatus for wireless communication at a UE, comprising a processor; memory coupled with the processor; and instructions stored in the memory and executable by the processor to cause the apparatus to perform a method of any of aspects 14 through 25.

Aspect 33: An apparatus for wireless communication at a UE, comprising at least one means for performing a method of any of aspects 14 through 25.

Aspect 34: A non-transitory computer-readable medium storing code for wireless communication at a UE, the code comprising instructions executable by a processor to perform a method of any of aspects 14 through 25.

Aspect 35: An apparatus for wireless communications at a base station, comprising a processor; memory coupled with the processor; and instructions stored in the memory and executable by the processor to cause the apparatus to perform a method of any of aspects 27.

Aspect 36: An apparatus for wireless communications at a base station, comprising at least one means for performing a method of any of aspects 27.

Aspect 37: A non-transitory computer-readable medium storing code for wireless communications at a base station, the code comprising instructions executable by a processor to perform a method of any of aspects 27.

Aspect 38: An apparatus for wireless communications at a base station, comprising a processor; memory coupled with the processor; and instructions stored in the memory and executable by the processor to cause the apparatus to perform a method of any of aspects 28.

Aspect 39: An apparatus for wireless communications at a base station, comprising at least one means for performing a method of any of aspects 28.

Aspect 40: A non-transitory computer-readable medium storing code for wireless communications at a base station, the code comprising instructions executable by a processor to perform a method of any of aspects 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a central processing unit, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1-26. (canceled)

27. A user equipment (UE), comprising:
one or more processors;
one or more memories coupled with the one or more processors; and
instructions stored in the one or more memories and executable by the one or more processors to cause the UE to:
receive control signaling indicating a first subset of channel measurement resources in a first channel measurement resource group for single transmission reception point channel measurement associated with a first transmission reception point, a second subset of channel measurement resources in a second channel measurement resource group for single transmission reception point channel measurement associated with a second transmission reception point, and one or more channel measurement resource pairs comprising channel measurement resources from each of the first channel measurement resource group and the second channel measurement resource group for joint transmission reception point channel measurement;
monitor the first subset of channel measurement resources, the second subset of channel measurement resources, and the one or more channel measurement resource pairs to generate a plurality of measurements; and
transmit a channel state information report comprising a number of bits indicating one or more channel resource indicators associated with at least one of the plurality of measurements, wherein the number of bits is based at least in part on a number of the one or more channel measurement resource pairs.

28. The UE of claim 27, wherein the instructions to transmit the channel state information report are further executable by the one or more processors to cause the UE to:
transmit the channel state information report comprising the number of bits indicating a single channel resource indicator, wherein the number of bits based at least in part on the number of the one or more channel measurement resource pairs.

29. The UE of claim 27, wherein the instructions to transmit the channel state information report are further executable by the one or more processors to cause the UE to:
transmit the channel state information report comprising the number of bits indicating a plurality of channel resource indicators, the number of bits corresponding to a first number of bits in a first channel resource indicator of the plurality of channel resource indicators that is based at least in part on the number of the one or more channel measurement resource pairs and a second number of bits in a second channel resource indicator of the plurality of channel resource indicators that is based at least in part on a sum of a first number of channel measurement resources in the first subset and a second number of channel measurement resources in the second subset.

30. The UE of claim 27, wherein the instructions to transmit the channel state information report are further executable by the one or more processors to cause the UE to:
transmit the channel state information report comprising the number of bits indicating a plurality of channel resource indicators, the number of bits corresponding to a first number of bits in a first channel resource indicator of the plurality of channel resource indicators that is based at least in part on the number of the one or more channel measurement resource pairs, a second number of bits in a second channel resource indicator of the plurality of channel resource indicators that is based at least in part on a first number of channel measurement resources in the first subset, and a third number of bits in a third channel resource indicator of the plurality of channel resource indicators that is based at least in part on a second number of channel measurement resources in the second subset.

31. The UE of claim 27, wherein the instructions to transmit the channel state information report are further executable by the one or more processors to cause the UE to:
transmit the channel state information report comprising the number of bits indicating a single channel resource indicator, the number of bits based at least in part on a sum of a first number of channel measurement resources in the first subset, a second number of channel measurement resources in the second subset, and the number of the one or more channel measurement resource pairs.

32. The UE of claim 27, wherein:
the first subset comprises a first number of unshared channel measurement resources in the first channel measurement resource group and the second subset comprises a second number of unshared channel measurement resources in the second channel measurement resource group, wherein the unshared channel measurement resources are second channel measurement resources distinct from the channel measurement resources within the one or more channel measurement resource pairs; and
the instructions to transmit the channel state information report are further executable by the one or more processors to cause the UE to:
transmit the channel state information report comprising the number of bits indicating a plurality of channel resource indicators based at least in part on the control signaling indicating that channel measurement resource sharing is disabled between single transmission reception point channel measurement and joint transmission reception point channel measurement, wherein the number of bits corresponds to a first number of bits in a first channel resource indicator of the plurality of channel resource indicators that is based at least in part on the number of the one or more channel measurement resource pairs, and a second number of bits in a second channel resource indicator of the plurality of channel resource indicators that is based at least in part on the first number of unshared channel measurement resources in the first subset and the second number of unshared channel measurement resources in the second subset.

33. The UE of claim 27, wherein:
the first subset comprises a first number of unshared channel measurement resources in the first channel measurement resource group and the second subset comprises a second number of unshared channel measurement resources in the second channel measurement resource group, wherein the unshared channel measurement resources are second channel measurement resources distinct from the channel measurement resources within the one or more channel measurement resource pairs; and
the instructions to transmit the channel state information report are further executable by the one or more processors to cause the UE to:
transmit the channel state information report comprising the number of bits indicating a plurality of channel resource indicators based at least in part on the control signaling indicating that channel measurement resource sharing is disabled between single transmission reception point channel measurement and joint transmission reception point channel measurement, wherein the number of bits corresponds to a first number of bits in a first channel resource indicator of the plurality of channel resource indicators that is based at least in part on the number of the one or more channel measurement resource pairs, a second number of bits in a second channel resource indicator of the plurality of channel resource indicators that is based at least in part on the first number of unshared channel measurement resources in the first subset, and a third number of bits in a third channel resource indicator of the plurality of channel resource indicators that is based at least in part on the second number of unshared channel measurement resources in the second subset.

34. The UE of claim 27, wherein:
the first subset comprises a first number of unshared channel measurement resources in the first channel measurement resource group and the second subset comprises a second number of unshared channel measurement resources in the second channel measurement resource group, wherein the unshared channel measurement resources are second channel measurement resources distinct from the channel measurement resources within the one or more channel measurement resource pairs; and
the instructions to transmit the channel state information report are further executable by the one or more processors to cause the UE to:
transmit the channel state information report comprising the number of bits indicating a single channel resource indicator based at least in part on the control signaling indicating that channel measurement resource sharing is disabled between single transmission reception point channel measurement and joint transmission reception point channel measurement, wherein the number of bits is based at least in part on a sum of the first number of unshared channel measurement resources in the first subset, the second number of unshared channel measurement resources in the second subset, and the number of the one or more channel measurement resource pairs.

35. The UE of claim 27, wherein the instructions to transmit the channel state information report are further executable by the one or more processors to cause the UE to:
transmit the channel state information report comprising the number of bits indicating a plurality of channel resource indicators, wherein the number of bits corresponds to a first number of bits in a first channel resource indicator of the plurality of channel resource indicators that is based at least in part on the number of the one or more channel measurement resource pairs and a second number of bits in a second channel resource indicator of the plurality of channel resource indicators that is based at least in part on a sum of a first number of channel measurement resources in the first subset for single transmission reception point channel measurement and a second number of channel measurement resources in the second subset for single transmission reception point channel measurement, wherein the first number of channel measurement resources is based at least in part on a difference between a third number of channel measurement resources in the first channel measurement resource group and the number of the one or more channel measurement resource pairs, and wherein the second number of channel measurement resources is based at least in part on a second difference between a fourth number of channel measurement resources in the second channel measurement resource group and the number of the one or more channel measurement resource pairs.

36. The UE of claim 27, wherein the instructions to transmit the channel state information report are further executable by the one or more processors to cause the UE to:
transmit the channel state information report comprising the number of bits indicating a plurality of channel resource indicators, wherein the number of bits corresponds to a first number of bits in a first channel resource indicator of the plurality of channel resource indicators that is based at least in part on the number of the one or more channel measurement resource pairs, a second number of bits in a second channel resource indicator of the plurality of channel resource indicators that is based at least in part on a first number of channel measurement resources in the first subset for single transmission reception point channel measurement, and a third number of bits in a third channel resource indicator of the plurality of channel resource indicators that is based at least in part on a second number of channel measurement resources in the second subset for single transmission reception point channel measurement, wherein the first number of channel measurement resources is based at least in part on a difference between a third number of channel measurement resources in the first channel measurement resource group and the number of the one or more channel measurement resource pairs, and wherein the second number of channel measurement resources is based at least in part on a second difference between a fourth number of channel measurement resources in the second channel measurement resource group and the number of the one or more channel measurement resource pairs.

37. The UE of claim 27, wherein the instructions to transmit the channel state information report are further executable by the one or more processors to cause the UE to:
transmit the channel state information report comprising the number of bits indicating a single channel resource indicator, wherein the number of bits is based at least in part on a sum of a first number of channel measurement resources in the first subset for single transmission reception point channel measurement, a second number of channel measurement resources in the second subset for single transmission reception point channel measurement, and the number of the one or more channel measurement resource pairs, wherein the first number of channel measurement resources is based at least in part on a difference between a third number of channel measurement resources in the first channel measurement resource group and the number of the one or more channel measurement resource pairs, and wherein the second number of channel measurement resources is based at least in part on a second difference between a fourth number of channel measurement resources in the second channel measurement resource group and the number of the one or more channel measurement resource pairs.

38. The UE of claim 27, wherein the number of bits is based at least in part on a number of the one or more channel resource indicators, a first number of channel measurement resources in the first subset, a second number of channel measurement resources in the second subset, and the number of the one or more channel measurement resource pairs.

39. The UE of claim 27, wherein a number of channel resource indicators within the channel state information report associated with one of the first transmission reception point or the second transmission reception point is zero, one, or two.

40. A user equipment (UE), comprising:
one or more processors;
one or more memories coupled with the one or more processors; and
instructions stored in the one or more memories and executable by the one or more processors to cause the UE to:
receive control signaling indicating a pair of channel measurement resources and that a first precoder matrix indicator, a second precoder matrix indicator, a first rank indicator, and a second rank indicator of joint transmission reception point channel state information calculated for the pair of channel measurement resources is to be shared for generating a respective channel quality indicator for each channel measurement resource of the pair of channel measurement resources;
monitor the pair of channel measurement resources to generate the joint transmission reception point channel state information comprising the first precoder matrix indicator, the second precoder matrix indicator, the first rank indicator, the second rank indicator, and a first channel quality indicator; and
transmit a channel state information report comprising the joint transmission reception point channel state information, a second channel quality indicator of a first channel measurement resource of the pair of channel measurement resources calculated using the first precoder matrix indicator and the first rank indicator, and a third channel quality indicator of a second channel measurement resource of the pair of channel measurement resources calculated using the second precoder matrix indicator and the second rank indicator.

41. The UE of claim 40, wherein the instructions are further executable by the one or more processors to cause the UE to:
receive second control signaling indicating a configuration for calculating the second channel quality indicator and the third channel quality indicator, wherein transmitting the channel state information report is based at least in part on receiving the second control signaling.

42. The UE of claim 41, wherein the instructions are further executable by the one or more processors to cause the UE to:
measure the first channel measurement resource independently of the second channel measurement resource to generate the second channel quality indicator in accordance with the configuration; and
measure the second channel measurement resource independently of the first channel measurement resource to generate the third channel quality indicator in accordance with the configuration.

43. The UE of claim 41, wherein the instructions are further executable by the one or more processors to cause the UE to:
measure the first channel measurement resource and a first interference signal received via the second channel measurement resource to generate the second channel quality indicator in accordance with the configuration; and
measure the second channel measurement resource and a second interference signal received via the first channel measurement resource to generate the third channel quality indicator in accordance with the configuration.

44. The UE of claim 43, wherein the instructions are further executable by the one or more processors to cause the UE to:
apply the second precoder matrix indicator and the second rank indicator to a first signal received via the second channel measurement resource to measure an interference level caused by the first interference signal; and
apply the first precoder matrix indicator and the first rank indicator to a second signal received via the first channel measurement resource to measure a second interference level caused by the second interference signal.

45. The UE of claim 40, wherein the instructions are further executable by the one or more processors to cause the UE to:
transmit signaling indicating a defined number of channel state information processing units supported by the UE, a defined number of active channel state information-reference signal resources supported by the UE, and a defined number of active channel state information-reference signal ports supported by the UE, wherein transmitting the channel state information report uses a number of channel state information processing units associated with the channel state information report that is less than or equal to the defined number of channel state information processing units supported by the UE, uses a number of active channel state information-reference signal resources associated with the channel state information report that is less than or equal to the defined number of active channel state information-reference signal resources supported by the UE, and uses a number of active channel state information-reference signal ports associated with the channel state information report that is than or equal to the defined number of active channel state information-reference signal ports supported by the UE.

46. The UE of claim 45, wherein:
the control signaling indicates a number of pairs of channel measurement resources comprising at least the pair of channel measurement resources;
the number of channel state information processing units associated with the channel state information report is based at least in part on the number of pairs of channel measurement resources and a number of individual channel measurement resources within the number of pairs of channel measurement resources;
the number of active channel state information-reference signal resources associated with the channel state information report is based at least in part on the number of pairs of channel measurement resources and the number of individual channel measurement resources within the number of pairs of channel measurement resources; and
the number of active channel state information-reference signal ports associated with the channel state information report is based at least in part on the number of pairs of channel measurement resources, the number of individual channel measurement resources within the number of pairs of channel measurement resources, and a number of ports associated with each channel measurement resource.

47. The UE of claim 45, wherein:
the control signaling indicates a number of pairs of channel measurement resources comprising at least the pair of channel measurement resources;
the number of channel state information processing units associated with the channel state information report is based at least in part on the number of pairs of channel measurement resources and the pair of channel measurement resources measured to generate the joint transmission reception point channel state information;
the number of active channel state information-reference signal resources associated with the channel state information report is based at least in part on the number of pairs of channel measurement resources and the pair of channel measurement resources measured to generate the joint transmission reception point channel state information; and
the number of active channel state information-reference signal ports associated with the channel state information report is based at least in part on the number of pairs of channel measurement resources, the pair of channel measurement resources measured to generate the joint transmission reception point channel state information, and a number of ports associated with each channel measurement resource.

48. The UE of claim 45, wherein:
the control signaling indicates a number of pairs of channel measurement resources comprising at least the pair of channel measurement resources;
the number of channel state information processing units associated with the channel state information report is based at least in part on the number of pairs of channel measurement resources and a first constant indicated in the signaling;
the number of active channel state information-reference signal resources associated with the channel state information report is based at least in part on the number of pairs of channel measurement resources and a second constant indicated in the signaling; and
the number of active channel state information-reference signal ports associated with the channel state information report is based at least in part on the number of pairs of channel measurement resources, the second constant indicated in the signaling, and a number of ports associated with each channel measurement resource.

49. The UE of claim 45, wherein the instructions to transmit the signaling are further executable by the one or more processors to cause the UE to:
transmit the signaling indicating a defined number of additional channel quality indicator calculations supported by the UE; and wherein:
a number of additional channel quality indicator calculations associated with the channel state information report is less than or equal to the defined number of additional channel quality indicator calculations supported by the UE;
the control signaling indicates a number of pairs of channel measurement resources comprising at least the pair of channel measurement resources;
the number of channel state information processing units associated with the channel state information report is based at least in part on the number of pairs of channel measurement resources;
the number of active channel state information-reference signal resources associated with the channel state information report is based at least in part on the number of pairs of channel measurement resources;
the number of active channel state information-reference signal ports associated with the channel state information report is based at least in part on the number of pairs of channel measurement resources and a number of ports associated with each channel measurement resource; and
the number of additional channel quality indicator calculations associated with the channel state information report is based at least in part on the pair of channel measurement resources measured to generate the joint transmission reception point channel state information.

50. The UE of claim 40, wherein the instructions are further executable by the one or more processors to cause the UE to:
receive second control signaling indicating for the channel state information report to comprise the joint transmission reception point channel state information associated with the pair of channel measurement resources, first single transmission reception point channel state information associated with the first channel measurement resource, and second single transmission reception point channel state information associated with the second channel measurement resource, wherein the instructions to transmit the channel state information report are further executable by the one or more processors to cause the UE to:
transmit, within a first portion of the channel state information report associated with the joint transmission reception point channel state information, the first rank indicator, the second rank indicator, the first precoder matrix indicator, the second precoder matrix indicator, and the first channel quality indicator;
transmit, within a second portion of the channel state information report associated with the first single transmission reception point channel state information, the second channel quality indicator and the first rank indicator; and
transmit, within a third portion of the channel state information report associated with the second single transmission reception point channel state information, the third channel quality indicator and the second rank indicator.

51. The UE of claim 40, wherein the instructions are further executable by the one or more processors to cause the UE to:
receive second control signaling indicating for a second channel state information report to comprise second joint transmission reception point channel state information associated with the pair of channel measurement resources, first single transmission reception point channel state information associated with a third channel measurement resource distinct from the pair of channel measurement resources, and second single transmission reception point channel state information associated with a fourth channel measurement resource distinct from the pair of channel measurement resources;
monitor the pair of channel measurement resources to generate the second joint transmission reception point channel state information comprising a third precoder matrix indicator, a fourth precoder matrix indicator, a third rank indicator, and a fourth rank indicator;
monitor the first channel measurement resource to generate the first single transmission reception point channel state information comprising a fifth precoder matrix indicator and a fifth rank indicator;
monitor the second channel measurement resource to generate the second single transmission reception point channel state information comprising a sixth precoder matrix indicator and a sixth rank indicator; and
transmit the second channel state information report comprising the second joint transmission reception point channel state information, the first single transmission reception point channel state information, and the second single transmission reception point channel state information.

52. The UE of claim 40, wherein:
the second channel quality indicator and the third channel quality indicator are included in a first part of the channel state information report; and
the second channel quality indicator and the third channel quality indicator are jointly encoded with the first precoder matrix indicator, the second precoder matrix indicator, the first rank indicator, the second rank indicator, the first channel quality indicator, and a channel resource indicator associated with the pair of channel measurement resources.

53-156. (canceled)

157. A method for wireless communication by a user equipment (UE), comprising:
receiving control signaling indicating a first subset of channel measurement resources in a first channel measurement resource group for single transmission reception point channel measurement associated with a first transmission reception point, a second subset of channel measurement resources in a second channel measurement resource group for single transmission reception point channel measurement associated with a second transmission reception point, and one or more channel measurement resource pairs comprising channel measurement resources from each of the first channel measurement resource group and the second channel measurement resource group for joint transmission reception point channel measurement;
monitoring the first subset of channel measurement resources, the second subset of channel measurement resources, and the one or more channel measurement resource pairs to generate a plurality of measurements; and
transmitting a channel state information report comprising a number of bits indicating one or more channel resource indicators associated with at least one of the plurality of measurements, wherein the number of bits is based at least in part on a number of the one or more channel measurement resource pairs.

158. The method of claim 157, wherein transmitting the channel state information report further comprises:
transmitting the channel state information report comprising the number of bits indicating a single channel resource indicator, wherein the number of bits based at least in part on the number of the one or more channel measurement resource pairs.

159. A method for wireless communication by a user equipment (UE), comprising:
receiving control signaling indicating a pair of channel measurement resources and that a first precoder matrix indicator, a second precoder matrix indicator, a first rank indicator, and a second rank indicator of joint transmission reception point channel state information calculated for the pair of channel measurement resources is to be shared for generating a respective channel quality indicator for each channel measurement resource of the pair of channel measurement resources;
monitoring the pair of channel measurement resources to generate the joint transmission reception point channel state information comprising the first precoder matrix indicator, the second precoder matrix indicator, the first rank indicator, the second rank indicator, and a first channel quality indicator; and
transmitting a channel state information report comprising the joint transmission reception point channel state information, a second channel quality indicator of a first channel measurement resource of the pair of channel measurement resources calculated using the first precoder matrix indicator and the first rank indicator, and a third channel quality indicator of a second channel measurement resource of the pair of channel measurement resources calculated using the second precoder matrix indicator and the second rank indicator.

160. The method of claim 159, further comprising:
receiving second control signaling indicating a configuration for calculating the second channel quality indicator and the third channel quality indicator, wherein transmitting the channel state information report is based at least in part on receiving the second control signaling.
